(19) United States
(12) Patent Application Publication
(10) Pub. No.: US 2026/0087067 A1
(43) Pub. Date: Mar. 26, 2026

(54) System and Method for Automated Integration of Contextual Information with a Series of Digital Images Displayed in a Display Space

(71) Applicant: TectoniQ Inc., New York, NY (US)

(72) Inventors: Laura Lehmann, New York, NY (US); Sorat Tungkasiri, Skillman, NJ (US)

(21) Appl. No.: 19/405,234

(22) Filed: Dec. 1, 2025

Related U.S. Application Data
(63) Continuation-in-part of application No. 19/370,490, filed on Oct. 27, 2025.
Application No. 19/370,490 is a continuation of application No. 18/510,556, filed on Nov. 15, 2023, now Pat. No. 12,455,919.
(60) Provisional application No. 63/425,659, filed on Nov. 15, 2022.

(51) Int. Cl. G06F 16/48; G06F 3/04842; G06F 3/14

(52) U.S. Cl. CPC G06F 16/48; G06F 3/04842; G06F 3/14

(57) ABSTRACT

A user interface application displays, in the user interface application, an image, or the portion thereof, in a display space. While the user interface application continues to display the image, or portion thereof, a messaging platform application searches in one or more digital data sources for, and retrieves, contextual information based on the displayed image, or portion thereof, without receiving user input to request searching in the one or more digital data sources for contextual information based on the displayed image, or portion thereof. The messaging platform application detects, one or more user interactions with one or more of the user interface application, the display space, or the image or the portion thereof, and displays a portion of the retrieved contextual information as related digital data content in a location within a field of view of the display space, based in part on the detected one or more user interactions.

### CROSS REFERENCE TO RELATED DOCUMENTS

This U.S. Continuation-In-Part patent application claims priority to U.S. patent application Ser. No. 19/370,490, filed Oct. 27, 2025, entitled “SYSTEM AND METHOD FOR AUTOMATED INTEGRATION OF CONTEXTUAL INFORMATION WITH A SERIES OF DIGIAL IMAGES DISPLAYED IN A DISPLAY SPACE”, the disclosure of which is incorporated by reference herein in its entirety, which claims priority to U.S. patent application Ser. No. 18/510,556, filed Nov. 15, 2023, entitled “SYSTEM AND METHOD FOR AUTOMATED INTEGRATION OF CONTEXTUAL INFORMATION WITH A SERIES OF DIGIAL IMAGES DISPLAYED IN A DISPLAY SPACE”, the disclosure of which is incorporated by reference herein in its entirety, which claims the benefit of U.S. Provisional Patent Application No. 63/425,659, filed Nov. 15, 2022, entitled “METHOD AND APPARATUS FOR COLLECTING AND TRANSFERRING ELECTRONIC IMAGES VIEWED IN A BROWSER TO A TRAY, CHATBOT OR SHOPPING CART”, the disclosure of which is incorporated by reference herein in its entirety. This application is related to U.S. patent application Ser. No. 17/666,788, filed Feb. 8, 2022, entitled “BLOCKCHAIN BRIDGE SYSTEMS, METHODS, AND STORAGE MEDIA FOR TRADING NON-FUNGIBLE TOKEN”, the disclosure of which is incorporated by reference herein in its entirety. This application is related to U.S. Patent Application No. 63/293,407, filed Dec. 23, 2021, entitled “BLOCKCHAIN BRIDGE SYSTEMS, METHODS, AND STORAGE MEDIA FOR TRADING NON-FUNGIBLE TOKEN” the disclosure of which is incorporated by reference herein in its entirety. This application is related to U.S. patent application Ser. No. 18/208,683, filed Jun. 12, 2023, entitled “SYSTEM AND METHOD FOR AUTOMATED INTEGRATION OF CONTEXTUAL INFORMATION WITH CONTENT DISPLAYED IN A DISPLAY SPACE”, the disclosure of which is incorporated by reference herein in its entirety.

### TECHNICAL FIELD

Embodiments of the invention relate to digital display systems, and in particular, systems for searching for and adding contextual information to, or within, a view of a series of digital images displayed in the digital display system in response to user interaction and without receiving user input to perform the searching. More particularly, embodiments relate to passive continuous contextual intelligence gathering systems that operate across multiple interface types including but not limited to web browsers, native applications, operating system interfaces, augmented reality/virtual reality/mixed reality environments, wearable displays, holographic displays, spatial computing environments, and ambient displays, wherein contextual information is automatically assembled and presented for user viewing without requiring discrete user-initiated capture events such as screenshots or photographs.

### BACKGROUND

Users typically open many tabs or windows in their web browser application, with spillovers from searches and external hyperlinks. Users interact with digital interfaces across multiple contexts including web browsers, mobile applications, desktop applications, spatial computing environments, and ambient displays. This model lacks a simple interactive interface that enables automatically searching for and retrieving, obtaining or extracting contextual information, for example, from hyperlinks and searches, without leaving the digital interface, for example, a webpage, and without requiring user input to perform such functions. Moreover, the user's interaction with a webpage or any digital interface—scrolling, stopping, watching—may additionally or alternatively dictate what, and the speed at which, contextual, or relevant, information surfaces, that is, what, and the speed at which, relevant information is displayed in the digital interface's display device. Ideally, relevant information extraction (search and retrieval) ought to happen in real time, even ahead of (e.g., predicting) or in reaction to a user's behavior or interactions, at the point, or at least in the general location, of the user's eye-gaze or scrolling, or current cursor location, or the current user's touch location. The user shouldn't have to initiate the search for contextual information, for example, by clicking on a hyperlink, selecting a word, phrase, object, or portion thereof, or opening a new tab or window in a browser to conduct a search for further information—and critically, the user should not be required to click hyperlinks, open new tabs, enter search queries, speak commands, or take any affirmative action to initiate contextual information retrieval—it should happen automatically based on the user's interaction with the webpage or digital interface, without the user providing any instruction or command to do so. This anticipatory contextual surfacing occurs before the user articulates a need, based on behavioral pattern recognition and contextual analysis. What is needed is an interface to capture, triage (filter), and display information, for example, incoming real-time information, related to content of a displayed page that potentially could have hundreds of links, and thousands if not millions of pieces of relevant contextual information.

The human brain processes images many thousands of times faster than text, and most information transmitted to the brain is in visual form. Most human reflexes are governed by what humans see, especially online. Most people often want to save the content of an image, because it reminds them of something that is contextually important to them, such as an article or a piece of clothing. It is often easier to save an image and recall or remember why it was saved, than visualizing text or a product in the absence of such.

There are many prior-art tools online that help with “saving” or “collecting” images. One is the ubiquitous “bookmark” button implemented in iOS and other software. Another tool is Pinterest, a website and app that allows a user to save and collect a series of images that are often serialized by topics, colors, products, etc. Pinterest and Shoppable, an online universal checkout tool available from 72Lux, Inc., also allow a user to purchase the products in many images they collect via a product catalog and shopping cart. Sometimes those same products and brands are then retargeted as advertising. However, these prior art systems require users to navigate away from their current context to a different application or webpage to collect images, thereby introducing significant friction in the user journey. Moreover, these systems fail to automatically extract and embed contextual information within or alongside the collected media without explicit user action.

One problem with these tools is that they send the user from a website to an app or a different web page to “collect” those images. The origin or historical analog of collecting images goes back to when a reader used to tear out pages from a magazine and place those tear-outs next to him/her or in a file folder in a desk drawer. The reader did not have to walk to another room to collect a tear-out. Doing so would have interrupted the flow of collecting images. In technical terms, “friction” in this context comprises measurable impediments including: navigation actions required (number of clicks, swipes, application switches); context switches (instances of leaving original content); time delay (latency measured in milliseconds or seconds between user intent and information availability); cognitive load (requirement that user remember to return to original context); and visual attention shift (removal of eyes from primary content focus). These friction points accumulate to create substantial barriers to seamless contextual information gathering.

One should be able to collect a webpage, or any media online, and have it remain visible to the user as the user keeps browsing the web, perhaps inspired by that visual. Not only is retaining visibility of the media in or on or near the same browsing window important to reduce the amount of friction in the user journey, but doing so allows embodiments of the invention to filter surrounding contextual information related to that media and save it within or associated with that media. Specifically, contextual information may be displayed within the same visual field, overlaid on current content, in peripheral vision area, in same application context, without requiring application switching, tab switching, window management, or navigation away from primary content. Furthermore, contextual information filtering and surfacing can occur concurrently with continued user engagement with primary digital content, not as a subsequent retrieval task. The disclosed embodiments are distinguished from mere “sidebar” or persistent widget implementations by dynamically filtering contextual information based on the user's current interaction focus within primary content, rather than displaying static information regardless of user activity.

### BRIEF DESCRIPTION OF THE DRAWINGS

The detailed description is set forth with reference to the accompanying figures. In the figures, the left-most digit(s) of a reference number identify the figure in which the reference number first appears. The use of the same reference numbers in different figures indicates similar or identical items or features.

FIG. 1 illustrates an embodiment of the invention.

FIG. 2 illustrates an embodiment of the invention.

FIG. 3 is a flowchart of the Product Discovery Process according to embodiments of the invention.

FIG. 4 is a flowchart of the Product Order Process according to embodiments of the invention.

FIG. 5 is a flowchart of the Related Products Process according to embodiments of the invention.

FIG. 6 is a flowchart for Looking Up Related Products according to embodiments of the invention.

FIG. 7 is a functional block diagram of the ShopThat Platform Architecture, according to a disclosed embodiment.

FIG. 8 depicts embodiments of the invention including a layered information metadata automation engine termed the SoLView engine.

FIG. 9 is a flowchart of the ML/DL/AI scanner for analyzing pixels in media and detecting objects within the media according to embodiments of the invention.

FIG. 10 is a flowchart of the ML/DL/AI classifier that takes the identified scanned objects and classifies each object according to embodiments of the invention.

FIG. 11 is a flowchart of the ML/DL/AI searcher that crawls for reference materials pertaining to each object according to embodiments of the invention.

FIG. 12 is a flowchart of the ML/DL/AI connector that connects and references all the objects along with the information gathered and links everything together according to embodiments of the invention.

FIG. 13 is a flowchart of the ML/DL/AI embedder that takes the information from the classifier, searcher, and connector and embeds the information inside of a media file according to embodiments of the invention.

FIG. 14 is a functional block diagram of a private data-store blockchain, termed SoLChain, according to embodiments of the invention.

FIG. 15 illustrates an interface for the search engine SoLSearch according to embodiments of the invention.

FIG. 16 is a flowchart for the Use of Context Vectors in Query Processing according to embodiments of the invention.

FIG. 17 illustrates an example of contextual searching on websites, using the shopThat widget associated with the chatbot, according to embodiments of the invention.

FIG. 18 illustrates a similar example of contextual searching on websites using a popup display according to embodiments of the invention.

FIG. 19 illustrates another example of contextual searching on websites in which users can drag media from the webpage into the widget associated with the SoLChat chatbot and the contextual search engine automatically provides related information related to that particular media, according to embodiments of the invention.

FIG. 20 is a flowchart of an embodiment of the invention.

FIG. 21 illustrates a user interface according to another embodiment of the invention.

FIG. 22 is a flowchart of another embodiment of the invention.

FIG. 23 illustrates passive data stream and continuous monitoring according to embodiments of the invention.

FIG. 24 illustrates continuous monitoring from multiple data streams and provides contextual information based on combined signals according to embodiments of the invention.

FIG. 25 illustrates how passive information gathering can later provide contextual information for later according to embodiments of the invention.

FIG. 26 illustrates how tracking user data provides automatic contextual information for later engagement according to embodiments of the invention.

FIG. 27 illustrates how lightweight metadata is stored and processed for user-accessible gallery interface according to embodiments of the invention.

FIG. 28 illustrates continuous passive monitoring and storing contextual metadata rather than raw data according to embodiments of the invention.

FIG. 29 illustrates an example of a museum visit and how the contextual information is assembled and stored through a single photo without human intervention according to embodiments of the invention.

FIG. 30 illustrates an example of how passive monitoring stores data based on behavior according to embodiments of the invention.

FIG. 31 illustrates an example of how doctors can gather contextual information passively from multiple sources and provide relevant information according to embodiments of the invention.

FIG. 32 illustrates how systems are able to determine private vs public spaces based on geo-location according to embodiments of the invention.

FIGS. 33A, 33B and 33C illustrate the difference traditional approaches of manual note-taking and its limitations vs automated advantages according to embodiments of the invention.

FIGS. 34A, 34B, 34C and 34D illustrate a series of enhancements for data collection and tracking for context between multiple devices according to embodiments of the invention.

FIG. 35 illustrates how the system extracts data and provides a confidence score and measures its score for output according to embodiments of the invention.

FIG. 36 illustrates a passive context stream based on AI agents and priority according to embodiments of the invention.

FIG. 37 illustrates gallery content in a multi-function hub according to embodiments of the invention.

### DETAILED DESCRIPTION

### Overview

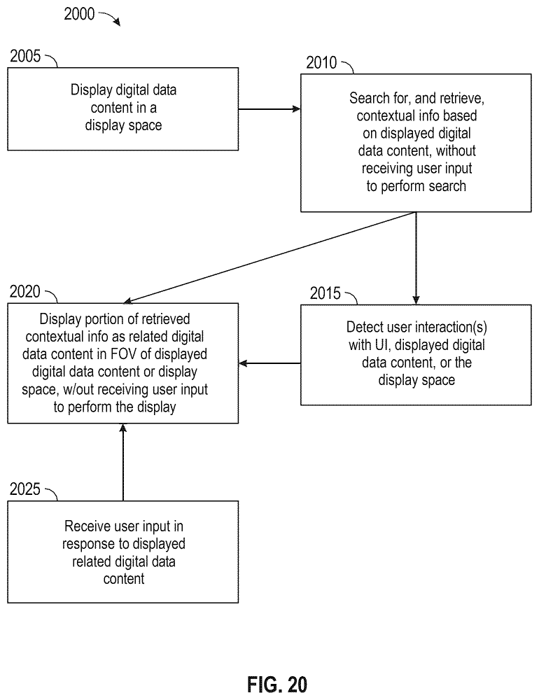

With reference to flowchart 2000 in FIG. 20, according to the disclosed embodiments, a computing system comprises a display space, one or more processors, and a memory to store computer-executable instructions. The computer-executable instructions include program code for a user interface application and a messaging platform application, such as a chatbot application.

The messaging platform application may comprise an automated information assistant, conversational interface application, AI-powered information retrieval agent, intelligent contextual assistant, or automated query response system that automatically retrieves and presents contextual information through a conversational interface, direct information display, proactive notifications, ambient information presentation, or any combination thereof.

In one embodiment, the user interface application and the messaging platform are integrated into a single software application, for example, where the user interface application is one software module, and the messaging platform is another software module that communicates with the user interface module. In the following discussion, references to a user interface application, a messaging platform, a chatbot application, etc., can be considered a reference to a code base that integrates those functions into a single software application, or in multiple modules of a single software application, or as different software applications that have an interface via which to communicate with each other.

The application(s), or modules, when executed by the one or more processors, cause the one or more processors to perform the following operations, including displaying, by the user interface application, digital data content in the display space at block 2005 and, while the user interface application continues to display the digital data content in the display space, at block 2010 searching in one or more digital data sources for, and retrieving, by the chatbot application, contextual information based on the displayed digital data content. This functionality is performed automatically, without receiving user input to perform the searching and/or retrieving operations or to cause the contextual information to be displayed.

“Without receiving user input” means the disclosed embodiments operate without: text entry (search queries, commands); voice commands (“Hey Siri, search for this”); button presses (search button, help button); gestures intended to trigger search (swipe-to-search, shake-to-search); eye gestures (prolonged stare to trigger, blink patterns to activate); or explicit permissions per-search (“Allow this search?”). The user may grant general permission once (at application install time or in settings), but no per-instance permission is required for individual search operations. User interactions with displayed content (scrolling, viewing, dwelling) constitute content engagement behaviors and not “user input” or search initiation commands; such behaviors are monitored to filter and prioritize already-retrieved contextual information, not to trigger initial retrieval, as described in more detail below. Contextual information retrieval begins immediately upon content display, contemporaneously with content loading, or in advance of content display based on predictive algorithms, without awaiting any user interaction with the content, thereby operating proactively based on content analysis rather than reactively based on user search instructions or commands, or query entry.

The chatbot application, while the user interface application continues to display the digital data content in the display space, detects one or more user interactions with one or more of the user interface application, the displayed digital data content, or the display space at block 2015. The chatbot application then displays a portion of the retrieved contextual information as related digital data content in a location within a field of view of the displayed digital data content or the display space, based in part on the detected one or more user interactions with the one or more of the user interface application, the displayed digital data content, or the display space, without receiving user input to perform the displaying, at block 2020.

At block 2025, while the user interface application continues to display the digital data content in the display space, the chatbot application may receive user input, responsive to the displayed portion of the retrieved contextual information as related digital data content.

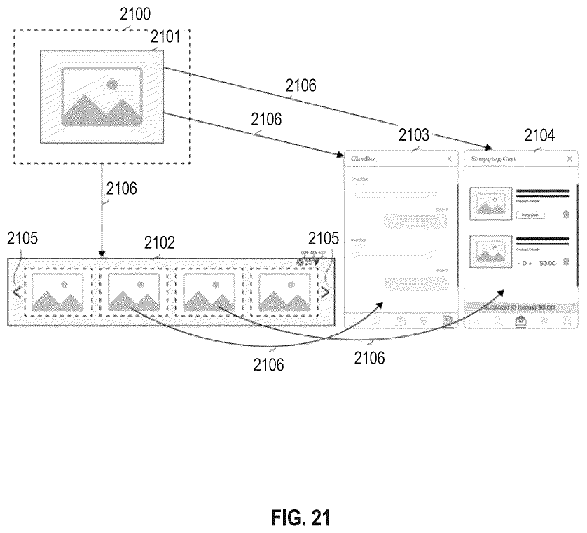

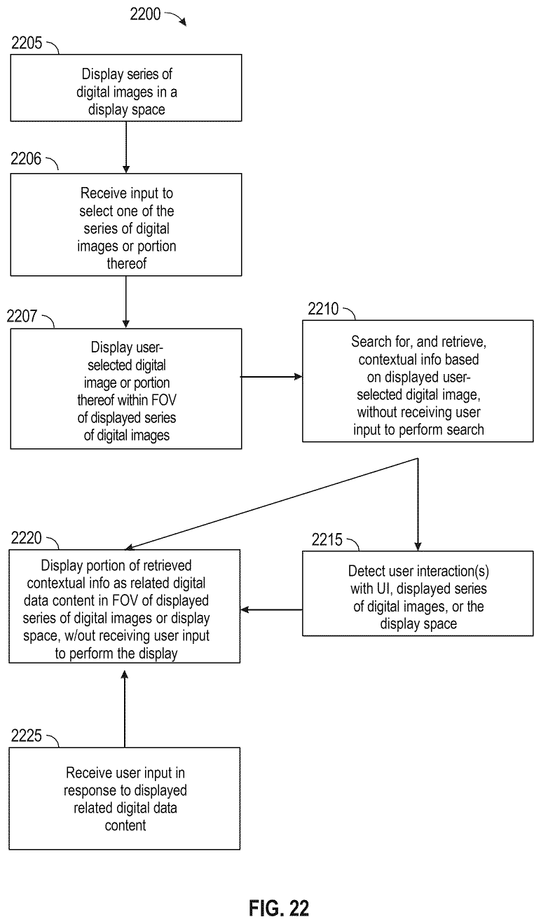

With reference to the user interface 2100 illustrated in FIG. 21 and the flowchart 2200 in FIG. 22, according to embodiments, a computing system comprises a display space, one or more processors, and a memory to store computer-executable instructions. The computer-executable instructions include program code for a user interface application 2100 and a messaging platform application 2103, such as a chatbot application. Those applications, when executed by the one or more processors, cause the one or more processors to perform the following operations, including displaying, by the user interface application 2100, a series of digital images 2101 in the display space at block 2205, followed by receiving at block 2206, via the user interface application 2100 user input 2106 to individually select any one or more of the series of digital images, or a portion of the selected one of the series of digital images, and then displaying at block 2207 the user-selected digital image, or portion thereof, in a location such as a media gallery window 2102, chatbot window 2103, or shopping cart window 2104 within a field of view (FOV) of the displayed series of digital images or the display space. A series of digital images is defined herein to mean that a user could keep browsing through a series of images after, or while, a user-selected one of the series of digital images has been transferred, e.g., dragged and dropped, to a chatbot window or a shopping cart.

The media gallery window 2102 in one embodiment is considered or treated as a personal media gallery for a user and to which the user may drag and drop one or more digital images from a webpage. The gallery potentially has infinite storage capacity. A user may browse their personal media gallery, for example, by pressing the back/reverse and front/forward arrow keys 2105 on a keyboard. They may also maximize the gallery window to a full screen for visual convenience and inspection of the digital images housed therein along with meta data associated with each of the digital images. The chatbot window 2103 in one embodiment allows users to receive unbidden contextual information about a digital image. The shopping cart window 2104 allows a user to purchase the digital image.

According to a disclosed embodiment, the media gallery window 2102 functions as a multi-function contextual intelligence hub providing: media saving and storage; automated curation of media collections; intelligent recommendation generation for related content, products, experiences, and locations; generative AI integration for content creation and analysis; and NFT minting capabilities with embedded contextual metadata. The gallery enables dynamic context reorientation wherein selection of a composite media collection causes contextual information to reorganize with the composite as primary object and individual constituent elements as secondary objects, and conversely, selection of an individual item causes contextual information to reorganize with the individual item context as primary and composite context as subordinate.

While the user interface application continues to display the user-selected digital image, or portion thereof, at block 2207, searching occurs at block 2210 in one or more digital data sources for, and retrieving, by the chatbot application, contextual information based on the displayed user-selected digital image, or portion thereof. This functionality is performed automatically, without receiving user input to perform the searching and/or retrieving operations or to cause the contextual information to be displayed.

The chatbot application, while the user interface application continues to display the user-selected digital image, or portion thereof, detects at block 2215 one or more user interactions with one or more of the user interface applications, the displayed series of digital images, and/or the display space. This user interaction could be accomplished with one or more of the web browser, a browser window, a browser tab within a browser window, a browser window or tab in which the digital image(s) is displayed, the display space (i.e., outside the browser app or windows or tabs), the media gallery, the chatbot pop up window, or the shopping cart pop up window. The chatbot application then displays at block 2220 a portion of the retrieved contextual information as related digital data content in a location within a field of view of the displayed series of digital images or the display space, based in part on the detected one or more user interactions with the one or more of the user interface application, the displayed series of digital images, or the display space, without receiving user input to perform the displaying. Thus, the display of related digital data content is essentially filtered in response to the user interactions.

Finally, at block 2225, while the user interface application continues to display the series of digital images in the display space, the chatbot application may receive user input, responsive to the displayed portion of the retrieved contextual information as related digital data.

In one embodiment, the user interface application receives user input to transfer the displayed user-selected digital image or the portion thereof in the location within the field of view of the displayed series of digital images or the display space to an online shopping cart. The online shopping cart may then retrieve the related digital data content added to or associated with, the file, the repository, or the storage location in or at which the displayed user-selected digital image, or the portion thereof, is maintained. In one embodiment, the user interface application receives the user input to select one of the series of digital images, or the portion thereof. The user input can take the form of, for example, a voice command, a gesture command, a photo, a video, or a screenshot taken by the user. The user input modalities may further comprise any combination of: touch gestures (tap, drag, drop, swipe, pinch, rotate); mouse/trackpad actions (click, drag, drop, scroll, hover); keyboard actions (arrow keys, shortcuts, text selection); voice commands (natural language phrases such as “save this” or “add to gallery”); gaze-based inputs (eye tracking with dwell time, eye gestures); neural inputs (brain-computer interface thought commands); haptic inputs (physical button presses, squeeze gestures); motion inputs (device shake, tilt, rotation); proximity inputs (near-field gestures, hand waving); or any combination thereof processed simultaneously to determine user intent. The embodiment is future-proofed to accept any future-developed input mechanism by which a user can indicate selection, transfer, or manipulation of digital content.

With reference to the embodiment discussed above and illustrated in FIGS. 21 and 22, consider a user reading an article about a vacation destination in, for example, Phoenix, Arizona. There is a beautiful digital image of a desert. Not only would the user want to be able to save the digital image (because it is aesthetically pleasing) but the user may also want to save in connection or association with the digital image related information such as hotels, restaurants, and activities in the area. Through embodiments of the invention, the digital image is representative of all the contextually relevant information. Relevant information may then further be filtered into main categories and saved to a database, for example, on a blockchain in the cloud. Searching these databases may surface product information, content, articles, etc. which are all linked within or copied to the ecosystem of the collected digital image.

According to embodiments, any media (a digital image, video, or video frame, an entire webpage, a field of view (FOV), a photo or a screenshot) can be moved or transferred, e.g., dragged and dropped, into one or more of a series of browser apps, windows, or tabs. In an iOS environment with support for detachable objects, a user can drag and drop “objects” within a jpeg, video frame, etc., or a field of view, if a user is wearing VR, AR or MR glasses. The disclosed embodiments operate across multiple device types including smartphones, tablets, computers, AR/VR/MR headsets, projection displays, holographic displays, wearable devices (watches, clothing-embedded sensors), vehicle-integrated systems, smart home/ambient computing environments, and any future display technologies. The media manipulation capabilities extend to any media type including but not limited to images, video, audio, text, 3D models, haptic data, olfactory data, and any future sensory modalities, with the contextual principles applying regardless of sensory modality.

Furthermore “drag and drop” operations are not limited to that action: drag and drop could be initiated by a voice command as in “save media into the gallery” or by taking a photo, a video, a screenshot. If a cursor is not present, a drag and drop operation can be replaced with eye movements or hand movements such as blinking, pointing and swiping.

Regarding media gallery 2102, embodiments contemplate dragging and dropping media, e.g., digital images, from user interface application 2100 into the gallery. It is appreciated that media may carry its own embedded information. The media may also be surrounded by contextual information that a live scraper can identify according to embodiments of the invention. As the media is dragged and dropped, all the contextual information is saved, for example, on a blockchain, identified with the media. As such, the media gallery is not only an interface for the user to collect media, but the media gallery may also be a converter of the media into a layered contextual media system.

In one embodiment, the media gallery may be implemented on a client site (either white-labeled or branded) or integrated on a standalone system with an ecommerce system, individualized content management system, or enterprise content management system. In one embodiment, the media gallery may be a tray that lives at the bottom of a client's webpage. It can have three states: 1) minimally visible at the bottom of the screen next to the cart or alone; 2) completely minimized; or 3) maximized for full view (full screen/floating window). More generally, the gallery interface may be presented in multiple states including at least a minimized state and an expanded state, wherein transitions between states may be discrete (fixed states) or continuous (arbitrary sizing), responsive to user input or automatic based on content relevance. The system learns and maintains the user's preferred presentation state across sessions. State presentation is not limited to the three enumerated states but may include any number of intermediate or alternative presentation modes adapted to device capabilities and user preferences. As noted above, a user can drag a potentially infinite amount of media and drop it into their media gallery. The gallery may be tied to a user's digital wallet on the blockchain for temporary storage. This storage may be maintained on a temporary database on a remote server for later viewing or purchasing. This information may be written later to the blockchain when purchased. The user may share their media gallery with anyone. A link may be shared, for example, a dynamic shortcode link that is auto-generated and linked to a portal website that displays the media gallery publicly. The shortcode link may also have a time limitation that the user can set to limit the view of the media gallery in the public portal. The user may also limit the media gallery as private at any time and stop sharing with anyone. As to a user's media gallery being tied to the user's digital wallet, in one embodiment, every media item in the user's media gallery may be a non-fungible token (NFT). The information is written to the blockchain. It does not matter if the item is a physical item that is being sold or just exists as an NFT, that designation is denoted by the seller (client). For this reason, the user's media gallery is linked to the user's digital wallet as part of a private blockchain. When the user drags the media from the personal media gallery into the shopping cart and purchases the media, the information automatically gets written into the blockchain to show that the ownership is transferred from one ID to another. The blockchain may also record date of purchase, the public wallet IDs (both buyer and seller), amount, and from whom. The media gallery may also allow a user to sell any items in their collection. This feature allows the user to share their purchased media gallery collection and resell it for a desired amount.

As noted above, in one embodiment, the user interface application receives the user input to select one of the series of digital images, or the portion thereof, in the form of, for example, a photo, a video, or a screenshot taken by the user. It is appreciated that today, much of image collecting is done via a screenshot-in which a duplicate of a web page and/or image is captured. While that method is controversial and may not provide authenticity of the original content screenshot, it is recognized as a most common way of “saving” a digital image. Embodiments can detect if an image has been captured by a screenshot using a series of tools that enable the image to be “dropped” into the application. Therefore, the same method described herein for contextually layering media or a whole page can be used for a screenshot which is a “photo” of a webpage. The screenshot can be dragged and dropped into the user's media gallery. The system further provides a “screenshot-equivalent context capture” mechanism wherein a user initiates context capture using the same input as a screenshot (button combination, gesture), but unlike a traditional screenshot, no image file is created. Instead, the associated document object model (DOM) or screen content is analyzed in real-time, contextual information is extracted and displayed without creating an image artifact, and the original application or content remains in the foreground without interruption.

As for photos, embodiments allow a user to synch their photo library with the media gallery. As discussed above this feature allows for access to another method for a user to collect/save information, either by screenshots or through photos. Photos may also be used in other instances, such as when using an iOS or android camera, or when using wearables, such as glasses or a watch. In such cases the images that are being “saved” are those which are contextually relevant to the user. The layered information being saved may be two-fold: location/GPS based information which may be tracked via a search engine, database etc.; and computer vision and/or any other type of machine learning which scans these images and layers product information. These images can then be collected, shopped and searched in the same way as described above.

It is appreciated that the interaction of contextual information can be gathered in real-time concurrently when or immediately after a photo is taken. As the photo is being captured, it can be analyzed in real-time and information sent to the user for the user to receive the contextual information in real-time and make informed decisions. The feedback, for example, can be an image taken with a mobile device (e.g., a watch, smart phone, glasses, tablet, etc.), for example, on the street of a person wearing a particular shirt. The image is instantly analyzed with the detection of geolocation, and the object in the image (clothing, jewelry, art, or any inanimate object) is analyzed and the user given options on where they can purchase that item locally, who manufactures it, or options to purchase online. This ability allows users to learn where they can purchase an item or what the object/item is about in real-time.

According to an alternative embodiment to those embodiments discussed with reference to FIGS. 21 and 22 it is appreciated that the claims need not be limited to displaying a series of digital images, followed by the user selecting one of the images, and then displaying the selected image or portion thereof. It is contemplated that the claims may simply recite displaying a digital image, or portion thereof in a display space, and then processing this digital image, rather than processing a user-selected digital image. In this embodiment, the claims are not limited to a “gallery” scenario.

It is further contemplated that the disclosed embodiments contemplate working with an image, and not necessarily a digital image. It is appreciated that embodiments may cover both active and passive modes mentioned herein, as well as the zero-photo contextual intelligence embodiment described herein. For example, an image may simply be something, e.g., an object, in the user's field of view while wearing smart glasses or an AR headset. The user does not have to capture or select the image, and it may not be a digital image—it may be a real image, e.g., a product advertisement on a billboard viewed by the user through smart glasses or an AR headset.

It is further contemplated that the claims may recite displaying, in a UI application, an image, rather than displaying, by the UI application, an image, so the embodiments cover smart glasses or AR headsets environments—in other words, an image in the real world may be displayed in a user interface for smart glasses versus an image may be displayed by a UI app on a display screen of a mobile device.

Continuous Contextual Data Stream Architecture. According to embodiments of the invention, the system operates on a fundamentally different paradigm than traditional media capture and analysis systems. Rather than requiring discrete user-initiated capture events such as taking a photo or screenshot, the system maintains a continuous stream of contextual data gathering that operates passively and perpetually.

The system distinguishes between two operational modes with fundamentally different characteristics. In the Active Mode, which represents the traditional approach used by prior technology systems, the user consciously decides to capture a moment and must initiate an action such as tapping a camera button or pressing a screenshot key combination. This creates a discrete artifact in the form of a photo file or screenshot file, and analysis occurs on this artifact only after its creation. The burden falls on the user to remember to capture important moments, which may result in missed opportunities and/or incomplete records of experiences.

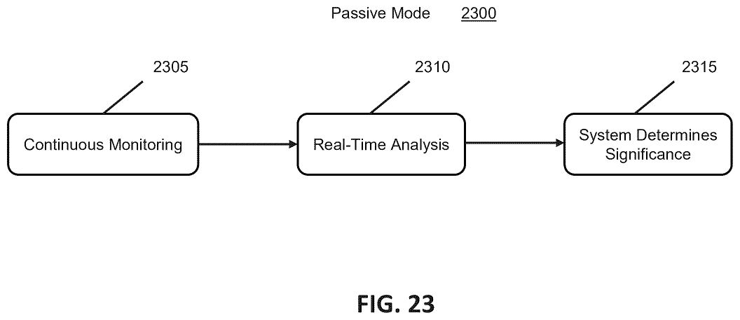

In contrast, with reference to FIG. 23, Passive Mode 2300, according to the disclosed embodiments, eliminates all user initiation requirements. The system continuously monitors at block 2305 the user's visual field of view, location, and digital context without any conscious user action or need for user input to do so. No discrete artifacts are necessarily created during this monitoring process. Analysis occurs at block 2310 on the continuous data stream in real-time rather than retrospectively on captured files. Most significantly, the system itself determines at block 2315 what is contextually significant rather than relying on the user's judgment in the moment.

This fundamental shift from active capture to passive monitoring represents a paradigm change in how contextual information is gathered and preserved. Users are freed from the cognitive burden of deciding what content to capture, the physical burden of initiating captures of the content, and the risk of missing important contextual information related to the content due to delayed or forgotten content capture actions.

Zero-Photo Contextual Intelligence. an innovation of the disclosed embodiments is that the user may never actually take, or need to take, a photo, or screenshot, or perform any discrete media capture action, yet the embodiments still assemble comprehensive contextual information about the user's experiences and environment. This capability fundamentally differentiates the system from all prior technology, which universally requires some form of media capture as a prerequisite for contextual analysis.

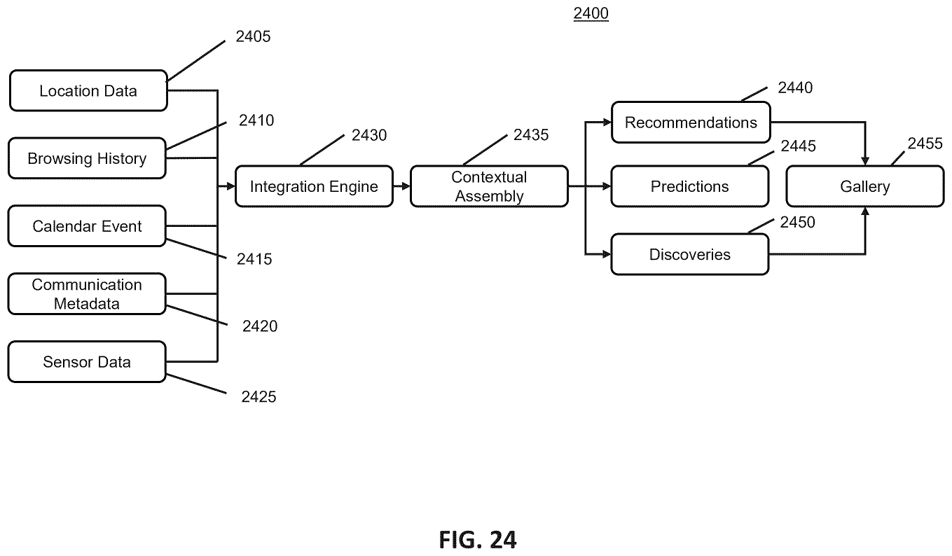

This zero-photo contextual intelligence is achieved through multiple complementary approaches, according to the disclosed embodiments, each capable of operating independently or in combination with the others, as further discussed below, with reference to the functional block diagram 2400 in FIG. 24.

Extended Duration Visual Analysis. When the disclosed embodiments have access to continuous visual footage from a camera for a selected period of time, for example, for two to three hours or more of continuous visual footage from a camera, whether from a wearable device, vehicle camera, security camera, or screen recording, the disclosed embodiments process the some or all of the entire stream without requiring the user to mark specific moments of interest. The disclosed embodiments automatically identify objects, people, locations, text, products, and activities throughout the stream using computer vision and machine learning algorithms. All identified elements are indexed with precise temporal markers, enabling later retrieval and analysis. The disclosed embodiments assemble automatically, without requiring any user input to do so, contextual information for everything encountered during the recording period, creating a comprehensive record of the user's visual experience.

This capability enables powerful retrospective querying. For example, a user can ask “What restaurants did I pass?” without having photographed any restaurants. The disclosed embodiments can answer this query by analyzing the continuous visual stream, identifying restaurant signage, storefronts, and other visual cues, and assembling relevant contextual information about each establishment even though the user never explicitly indicated interest in any specific restaurant at the time, or in real time.

One distinction from active recording systems is that the user does not need to decide in the moment what is worth capturing. The disclosed embodiments capture and analyze everything, continuously extracting contextual information, and making all of this information available for later exploration and querying.

Location-Only Context Assembly. With appropriate user permissions, the disclosed embodiments, at block 2405, can build comprehensive contextual information using location data alone, without any visual media whatsoever. GPS signals, Wi-Fi positioning, Bluetooth beacons, and/or cell tower triangulation, as examples, provide a continuous location stream that tracks the user's movements throughout the day. The disclosed embodiments query contextual databases for information about businesses at each location, events occurring at those locations, historical significance of places visited or nearby, weather conditions experienced, traffic patterns encountered, and numerous other contextual factors.

The user's dwell time at each location may serve as an indicator of significance, according to the disclosed embodiments. If a user remains at a particular location for an extended period, the disclosed embodiments infer that this location is likely important and allocates more resources to gathering contextual information about it. Multiple visits to the same location over time strengthen these contextual associations and enable the disclosed embodiments to recognize patterns in the user's behavior and preferences.

At any later time, the user can review their activities by asking, for example, “Where was I on Tuesday?” and receive full contextual information about all locations visited that day, including details about businesses, events, and other relevant information, without having captured any photos or other media during those visits. This capability is particularly valuable for reconstructing timelines, remembering conversations or meetings at specific locations, or simply reviewing one's activities without the need for contemporaneous documentation.

Browsing History Context Integration For digital contexts involving phone or computer usage, the disclosed embodiments, at block 2410, monitors the user's browsing history, application usage, and document access with explicit user permission. The disclosed embodiments assemble contextual information about some or all visited websites, viewed content, and searched terms without requiring the user to take screenshots or save links or otherwise provide input for the disclosed embodiments to perform the assembly. According to the disclosed embodiments, URL and timing information alone may be sufficient for the system to retrieve and reconstruct the context of the user's digital activities.

This capability enables queries such as “What was that article about renewable energy I read last week?” even when the user has not saved anything, bookmarked the page, or taken any explicit action to preserve the information. The system maintains a temporal index of all digital interactions and can retrieve contextual information about any previously-viewed content.

The integration of browsing history context with, or without, other data streams creates a comprehensive picture of the user's digital life without requiring manual curation or organization by the user to do so. The disclosed embodiments automatically categorize and index digital contexts, making them searchable and retrievable, by themselves, or alongside physical location contexts and visual contexts captured through cameras or other sensors.

Composite Context Across Multiple Passive Streams. The system's most powerful capability emerges when it integrates at block 2430 multiple passive data streams simultaneously. For example, by combining location data obtained at block 2405, browsing history obtained at block 2410, calendar events obtained at block 2415, communication metadata obtained at block 2420, and other available data sources, for example, sensor data obtained at block 2425, the disclosed embodiments can synthesize insights at block 2430 that would not be apparent from any single data stream in isolation into a contextual assembly of data at block 2435.

Consider a practical example: a user is physically present at a coffee shop, browsing travel websites on their computing device, for example, a smartphone, and has a calendar event labeled “vacation planning” scheduled for later that day. The disclosed embodiments synthesize these passive signals without any explicit user input and proactively surfaces relevant contextual information, whether recommendations at block 2440, predictions at block 2445, or discoveries at block 2450. This might include travel guides for coffee-producing regions, information about coffee plantation tours in various countries, articles about coffee culture in different destinations, and recommendations for coffee-themed travel experiences.

No action was required from the user to trigger this contextual assembly. The disclosed embodiments continuously monitor multiple data streams at blocks 2405-2425, recognize patterns and relationships among them, and automatically assemble at block 2435 relevant contextual information based on the emergent meaning derived from these combined signals. This represents a level of contextual intelligence that far exceeds what any prior technology system achieves. This contextual information may then be associated with the user's gallery of photos or images at block 2455. According to the disclosed embodiments the user need not capture that photos or images in the gallery. The disclosed embodiments may automatically capture photos or images and associate the auto-generated contextual information with the same.

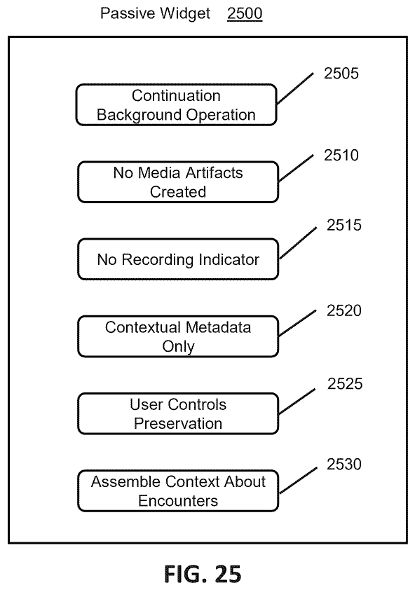

The “Passive Widget” Paradigm. With reference to FIG. 25, the disclosed embodiments operate as a passive widget 2500 that has fundamentally different characteristics from active recording systems employed by competitors and prior technology solutions.

The passive widget 2500 exhibits several characteristics that distinguish it from conventional approaches. First, as noted at 2505, the widget operates continuously in the background of any application without requiring explicit activation for each session. Unlike traditional recording applications that must be launched and initiated by the user, the passive widget 2500 maintains awareness of the user's context at all times when the system is active. Second, as noted at 2510, the widget does not create media artifacts unless the user explicitly requests such creation. This represents a fundamental departure from recording-based systems that generate large media files as their primary output. Third, as noted at 2515, the widget does not display a recording indicator because it is not “recording” in the traditional sense of capturing and storing raw sensory data. Instead, the widget extracts and stores contextual metadata while discarding the raw data streams.

as noted at 2520, the passive widget extracts and stores contextual metadata rather than raw sensory data, which has profound implications for storage requirements, privacy protection, and system performance. As noted at 2530, the widget assembles information about what the user encountered rather than capturing exhaustive recordings of what the user saw, heard, or experienced. This distinction is not merely technical but represents a fundamental philosophical difference in approach. The disclosed embodiments focus on meaning and context rather than raw data preservation.

Importantly, at noted at 2525, the user retains complete control over which contexts are preserved versus which contexts are discarded. The disclosed embodiments may recommend retention based on predicted future value, but the user makes the final determination. This ensures that privacy concerns are addressed while enabling comprehensive contextual awareness.

Active recording systems create continuous video and audio recordings that consume massive storage capacity. Users must explicitly start each recording session, making a conscious decision to begin capturing. Storage requirements are enormous, potentially requiring hours of video and audio to be preserved. Privacy concerns are heightened around constant recording, leading to regulatory requirements in many jurisdictions. Recording indicators are typically required by law to inform others when recording is in progress. Finally, users must review entire recordings to find moments of interest, imposing significant cognitive burden and time investment.

The distinctions of the passive widget according to the disclosed embodiments can be summarized as follows: the passive widget is action-oriented in terms of assembling useful contextual information while being passive in terms of user initiation and/or interaction requirements. Active recording systems are action-oriented in terms of user initiation, requiring users to press record, but then become passive in what they capture, recording everything indiscriminately without intelligent selection or filtering.

This paradigm shift from “record everything and sort it out later” to “extract meaningful context continuously and make it query-able”, according to the disclosed embodiments, represents a fundamental innovation that enables practical, privacy-preserving contextual awareness at scale.

Gallery Auto-Collection of Contextual Data. The gallery component 2455 serves as the primary interface and repository for passively collected contextual data. However, the gallery is far more than a simple storage location. It functions as an intelligent hub that organizes, enriches, and presents contextual information in ways that maximize or increase utility for users while minimizing or decreasing cognitive burden.

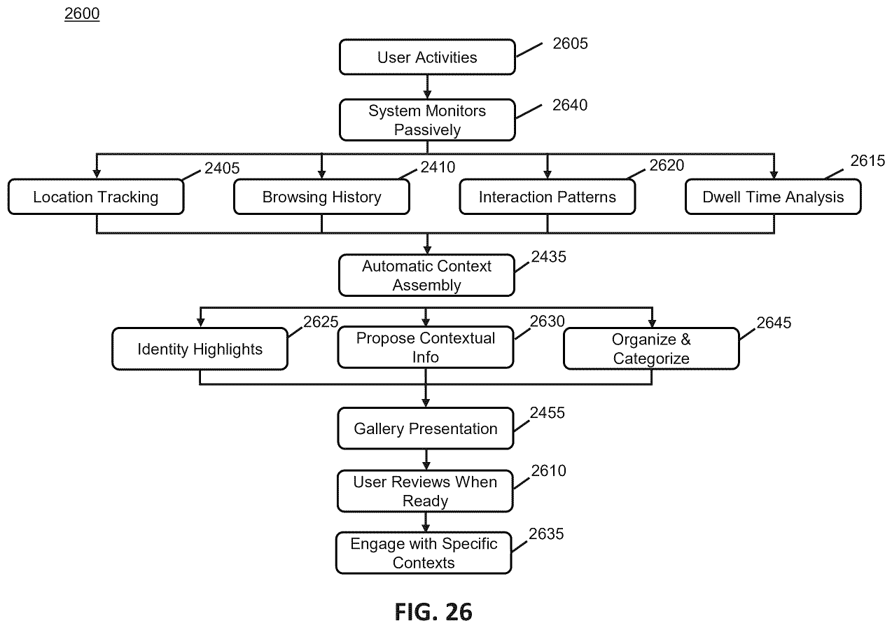

Automatic Contextual Highlights. With reference to the functional block diagram 2600 in FIG. 26, when a user scrolls at block 2610 through their timeline of activities captured at block 2605, covering a selected time period, for example, a 24-hour period, whether reviewing, for example, visual footage, location tracking history captured at block 2405, or browsing history captured at block 2410, the disclosed embodiments do not present an undifferentiated stream of information. Instead, the disclosed embodiments automatically identify some areas, locations, and/or contexts where the user spent time or encountered content. For example, the disclosed embodiments may identify a plurality of (e.g., four or five) key or interesting areas, locations, or contexts where the user spent significant time or encountered notable content. Each highlight is presented with contextual information auto-assembled at block 2435 that provides an immediate understanding of what occurred and where during that selected time period.

Notably, the user need not mark these moments or indicate their significance in real-time. The disclosed embodiments determined their importance based on one or more multiple factors such as but not limited to dwell time analyzed at block 2615, frequency of interaction obtained at block 2620, uniqueness of context, and learned patterns about what types of contexts the user typically finds valuable. This automatic significance detection eliminates the need for users to consciously curate their experiences in the moment.

Consider a practical example: a user spent 45 minutes at Central Park on a particular afternoon. The system automatically identifies this a highlight at block 2625 and further identifies this as a significant context at block 2630 based on the duration obtained at block 2615 and location obtained at block 2405. When the user reviews their day at block 2610, the gallery at block 2455 presents this as a highlight with auto-assembled contextual information. This might include details about the sculpture garden that was nearby (even though the user did not photograph it), information about the food festival happening that day (even though the user did not attend it), and recommendations for similar parks the user might enjoy based on their demonstrated interest in urban green spaces.

The power of this approach is that the user receives valuable contextual information about their environment and experiences without having taken any explicit action to capture or request that information. The system assembles the context proactively, making it available for exploration at block 2635 whenever the user chooses to review their timeline.

Contextual Information Proposals. With reference to block 2630 in FIG. 26, for each identified significant segment in the user's timeline, the disclosed embodiments propose relevant contextual information drawn from multiple sources, for example, at blocks 2405, 2410, 2615 and 2620. The nature of these proposals varies based on the type of context detected.

When a user visits a new location for a period of time, say, an extended period of time, the disclosed embodiments may recognize this as a novel or important context deserving of information gathering, perhaps detailed or rich information gathering. The disclosed embodiments automatically surface information about local attractions in the area, restaurants with ratings and reviews, transportation options for getting around, cultural context about the neighborhood or city, safety information relevant to travelers, and other details that help the user understand and navigate their environment. The user did not request any of this information, yet it becomes available automatically because the system detected the user's presence in an unfamiliar or otherwise notable location.

Similarly, when a user browses certain topics on the web, the system detects thematic patterns and assembles relevant contextual information. This might include related articles from authoritative sources, expert opinions on the topic, products or services related to the subject matter, educational courses for deeper learning, or upcoming events relevant to the theme. Again, no explicit request was made—the system inferred the user's interest from their browsing behavior and proactively assembled relevant context.

The critical innovation here is that no photo or discrete media capture is required for this context proposal system to function. The system operates based on passive data signals obtained by the system passively monitoring at block 2640 such information as location obtained at location tracking block 2405, browsing history obtained at browsing history block 2410, dwell time obtained at dwell time analysis block 2615, and interaction patterns obtained at interaction patterns block 2620. These signals are sufficient to trigger comprehensive contextual information assembly at block 2435 without any media artifacts being created.

Zero-Action User Experience. The ultimate goal of the passive widget 2500 and gallery system is to provide a completely passive experience from the user's perspective, eliminating most, perhaps all, friction and cognitive burden from the process of building and maintaining a rich contextual record of one's life or a selected time segment thereof.

In one disclosed embodiment, users simply go about their daily activities, which might include physical movement through various locations, digital browsing and content consumption, digital or face-to-face communication with others, and any other normal behaviors. The system continuously assembles contextual intelligence in the background without requiring any attention or action from the user. At any time, the user can open the gallery to review the automatically collected contexts at block 2635. When they do so, they discover that the system has already organized and/or categorized at block 2645, and enriched all of the data, presenting it in an immediately useful and understandable format.

The user only needs to take action when they want to engage with a specific context at block 2635—perhaps to learn more, to share information with others, to purchase a product, or to save something for future reference. All of the preliminary work of gathering, organizing, and presenting information has been completed automatically by the disclosed embodiments.

Consider a comprehensive example that illustrates the power of this zero-action approach: a user travels to Paris and walks around the city for two days with their smartphone in their pocket or their AR glasses on their face. During this entire time, they never take a single photo, never open any specific apps to record information, and never make any conscious effort to document their experiences. On day three, they open the gallery and discover a complete record of their Paris experience.

For example, the gallery at block 2455 shows a detailed map of everywhere they went over the two days, with their walking routes clearly marked. For every landmark they passed, the system has gathered information, e.g., historical information, architectural details, visitor reviews, and interesting facts. Every restaurant they walked by is documented with menu information, pricing, reviews from other diners, and recommendations about signature dishes. Museums they could visit are suggested based on locations where they seemed to linger or show interest, with information about current exhibitions, ticket prices, and optimal visiting times. A suggested itinerary for their remaining days in Paris is automatically generated based on the types of locations and experiences they gravitated toward during their first two days.

This rich, valuable, actionable information was assembled without a single conscious action on the user's part. They were free to immerse themselves in the experience of being in Paris without the distraction of documenting everything. Yet they have a more complete and useful record than they could ever hope to have created through even very careful and thoughtful and detailed manual photo-taking and note-keeping. This represents the realization of truly passive contextual intelligence gathering, well beyond what could be accomplished by the user's mental processes, whether or not with pen and paper or a computing device used to record the details of their experience.

The zero-action user experience represents the culmination of the passive widget paradigm. By eliminating all user burden from the information gathering process, the system enables users to focus on living their experiences while still building a comprehensive, searchable, contextually-rich record that enhances memory recall, enables discovery, and supports decision-making, reporting and recollecting, long after the original experiences have faded from active memory.

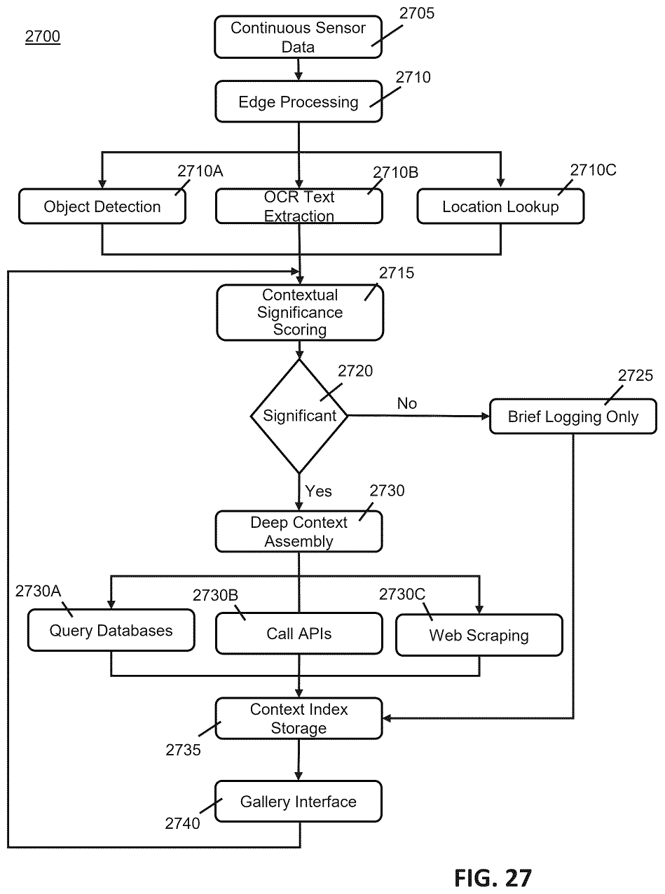

Technical Implementation of Continuous Passive Context Stream. With reference to FIG. 27, the technical architecture 2700 underlying the continuous passive context stream requires sophisticated engineering to achieve the goals of comprehensive context gathering while maintaining acceptable performance, battery life, and privacy protections. This section details the main architectural components and their interactions, according to the disclosed embodiments.

Architecture Components. The disclosed embodiments comprise five primary architectural components that work together to enable continuous passive contextual intelligence gathering, namely, a multimodal sensor fusion engine, a real-time context extraction pipeline, temporal context indexing, context decay and reinforcement, and privacy-preserving context compression. Each component plays a specific role in the overall system, and their integration enables capabilities that exceed what any single component could provide.

Multi-Modal Sensor Fusion Engine. The Multi-Modal Sensor Fusion Engine serves as the foundation of the system's environmental awareness. It ingests at block 2705 data from a diverse array of sensors available on modern devices and wearables. These sensors include one or more motion detection sensors, cameras or optical devices capable of capturing visual information about the user's environment or movements, Global Positioning Satellite (GPS) receivers that provide coarse-grained location information, inertial navigation units, accelerometers and gyroscopes that detect device orientation and movement patterns, microphones that can capture ambient audio for analysis, near field communication (NFC) and radio frequency identifier (RFID) readers that detect proximity to tagged objects or locations, Bluetooth radios that identify nearby devices and beacons, and Wi-Fi scanners that detect available networks and their signal strengths.

The fusion engine operates continuously at low power consumption levels, typically running on a dedicated low-power processor or neuromorphic chip specifically designed for always-on sensor processing. This specialized hardware enables continuous operation without draining the device battery, making truly passive monitoring practical for extended periods.

The core function of the fusion engine is to combine inputs from multiple sensors to determine the current context with higher confidence than any single sensor could provide. For example, when the camera detects a product, GPS shows the device is located at a retail store, and Wi-Fi scanning confirms connection to that store's wireless network, the disclosed embodiments can establish with high confidence that the user is shopping at that specific location. This multi-sensor confirmation approach reduces false positives and enables more accurate context extraction.

Real-Time Context Extraction Pipeline. The Real-Time Context Extraction Pipeline processes the continuous stream of sensor data to identify and extract meaningful contextual information. This pipeline operates as a series of processing stages, each adding value and refinement to the extracted context.

The pipeline begins with continuous sensor data flowing from the Multi-Modal Sensor Fusion Engine at block 2705. This raw data stream undergoes edge processing at block 2710, meaning computation or processing is performed locally on the user's device rather than in the cloud or intermediate device between the user's device and the cloud. Edge processing includes, for example, object detection at block 2710A to identify items in camera feeds, optical character recognition (OCR) at block 2710B to extract text from images, and location lookup at block 2710C to identify businesses or landmarks at the current GPS coordinates.

Following edge processing at block 2710, the disclosed embodiments apply contextual significance scoring is performed at block 2715 to determine whether each detected element merits deeper analysis. Not every object seen by the camera or every location passed through warrants comprehensive context assembly. A significance scoring algorithm considers factors such as dwell time at a location obtained at location lookup block 2710C, frequency of encounters with an object or place obtained at object detection block 2710A, uniqueness or novelty of the context, and/or learned patterns about what the user typically finds valuable. Decision block 2720 determines the significance of an object. Objects with low significance scores may be logged briefly at block 2725 but not subjected to expensive deep analysis.

For contexts deemed significant, the disclosed embodiments proceed to deep context assembly at block 2730. This block queries external databases at block 2730A, calls relevant APIs at block 2730B, and performs web scraping at block 2730C to gather comprehensive information about the significant context. For a restaurant, this might include menu information, pricing, reviews, health inspection scores, chef background, and cuisine style. For a product, it might include manufacturer details, pricing across retailers, reviews, specifications, and alternatives.

The assembled context is then stored at block 2735 in a context index, which maintains lightweight metadata rather than raw media files. Each context entry includes temporal information, location data, identified objects or entities, significance scores, and pointers to any associated media that the user explicitly chose to capture. This index enables rapid searching and retrieval of past contexts.

The indexed contexts are made available through the user-accessible gallery interface at block 2740, where users can browse, search, and interact with their accumulated contextual information at their convenience.

Temporal Context Indexing. The Temporal Context Indexing system at bock 2735 ensures that all contextual information is precisely anchored in time, enabling powerful temporal queries and correlations across different data streams. Every context element is timestamped, for example, down to nanosecond precision, using synchronized system clocks. This degree of precision may be necessary since users often engage in rapid context switching, and being able to precisely sequence events is needed for understanding causality and relationships.

The temporal precision enables correlation across different data streams that might otherwise appear unrelated. For example, the disclosed embodiments can determine that a user thought about buying a new car (detected from a voice memo) at the exact moment they drove past a car dealership (known from GPS), while simultaneously researching automotive reviews on their phone (known from browsing history). These three data streams, properly time-aligned, reveal a strong purchase intent signal that would not be apparent from any single stream by itself.

The temporal context indexing system supports sophisticated queries that leverage this time-based organization. Users can ask via gallery interface 2740 questions such as “What was I doing when I thought about buying a new car?” and the system can correlate the voice memo timestamp with location data, browsing history, calendar events, and other contexts from that precise time period to provide a comprehensive answer.

Context Decay and Reinforcement. The Context Decay and Reinforcement system recognizes that not all contexts maintain equal importance over time. Some contexts become more valuable as they are revisited or acted upon, while others fade in relevance and can be given lower storage priority or eventually purged.

Contexts that the user engages with by opening them in the gallery via gallery interface 2740, sharing them with others, or acting upon them (such as making a purchase or visiting a location) receive reinforcement. The disclosed embodiments feed this information back to contextual significance scoring block 2715, which increases the significance scores associated with the engaged contexts, thereby ensuring the contexts are retained, perhaps indefinitely, and the disclosed embodiments use them as positive examples when training machine learning models to predict future context relevance.

Conversely, contexts that the user never engages with gradually decay in priority. The system does not immediately delete these contexts, as they might become relevant later, and they may be moved to lower-cost storage tiers, compressed more aggressively, or marked as candidates for eventual purging, for example, depending storage constraints.

Machine learning models continuously predict which contexts will prove valuable to preserve based on patterns in the user's past behavior. These models consider factors such as context type, location categories, product categories, information domains, time of day, and user's current projects or interests. By learning from the user's engagement patterns, the disclosed embodiments become increasingly accurate at predicting which contexts deserve preservation and enrichment.

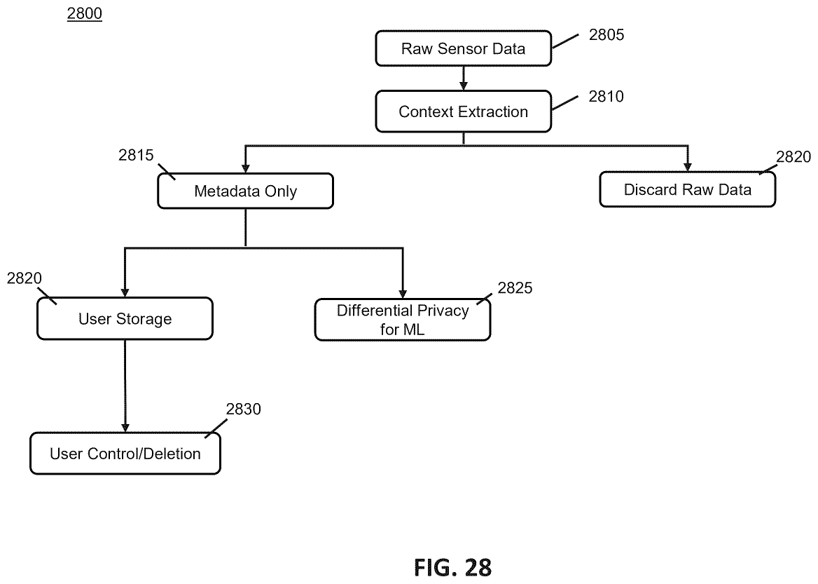

Privacy-Preserving Context Compression. The Privacy-Preserving Context Compression system addresses the fundamental privacy challenge inherent in continuous contextual monitoring. The disclosed embodiments are designed to extract meaningful context while discarding potentially sensitive raw data, implementing a privacy-by-design approach depicted at 2800 in FIG. 28.

After contextual information is extracted at block 2710/2810 from raw sensor data 2805 obtained at block 2705, the raw data itself is immediately discarded at 2820. Only the extracted metadata is preserved at 2815. For example, rather than storing an image of a French restaurant storefront, the system stores the metadata “saw French restaurant ‘Le Petit Bistro’ at 123 Main Street, 2:30 PM, cuisine style: traditional French, price range: $$, rating: 4.5 stars.” This metadata conveys the meaningful context while eliminating the raw visual data that might inadvertently capture other people's faces, license plates, or other sensitive information.

At block 2830, users maintain complete control over their contexts and can delete any context at any time without affecting other data. For example, when contexts are stored at 2820 as discrete, independent records rather than as frames within a continuous video, deletion is granular and complete. Deleting a restaurant context in such an embodiment removes all information about that restaurant encounter without affecting contexts from before or after.

The disclosed embodiments implement differential privacy techniques at block 2825 when aggregating contexts for machine learning training. Individual user data may not be transmitted in identifiable form. Instead, the system may add calibrated noise to aggregated statistics, ensuring that insights can be derived to improve the system for all users while preventing any individual user's specific contexts from being identified or reconstructed.

This privacy-preserving approach makes continuous passive monitoring acceptable to users who would rightfully object to systems that record and retain raw video or audio. By focusing on contextual metadata rather than raw recordings, the disclosed embodiments provide the benefits of comprehensive contextual awareness while respecting user privacy.

The combination of these five architectural components creates a system capable of continuous passive contextual intelligence gathering at scale, according to the disclosed embodiments. The Multi-Modal Sensor Fusion Engine provides comprehensive environmental awareness, the Real-Time Context Extraction Pipeline transforms raw sensor data into meaningful context, the Temporal Context Indexing enables powerful temporal queries and correlations, the Context Decay and Reinforcement system ensures efficient use of storage resources, and the Privacy-Preserving Context Compression protects user privacy while enabling system improvements through machine learning.

Together, these components implement a technical architecture that is fundamentally different from and superior to prior technology approaches that rely on discrete media capture, user-initiated recording, or indiscriminate data preservation. The disclosed embodiments achieve the optimal balance between comprehensive context gathering, computational efficiency, storage efficiency, and privacy protection.

Technical Implementation of Continuous Passive Context Stream. The technical architecture underlying the continuous passive context stream requires sophisticated engineering to achieve the goals of comprehensive context gathering while maintaining acceptable performance, battery life, and privacy protections. This section details the key architectural components and their interactions.

Architecture Components. The system comprises five primary architectural components that work together to enable continuous passive contextual intelligence gathering. Each component plays a specific role in the overall system, and their integration enables capabilities that exceed what any single component could provide.

Multi-Modal Sensor Fusion Engine. The Multi-Modal Sensor Fusion Engine serves as the foundation of the system's environmental awareness. It ingests data from a diverse array of sensors available on modern devices and wearables. These sensors include one or more cameras capable of capturing visual information about the user's environment, GPS receivers that provide coarse-grained location information, accelerometers and gyroscopes that detect device orientation and movement patterns, microphones that can capture ambient audio for analysis, NFC and RFID readers that detect proximity to tagged objects or locations, Bluetooth radios that identify nearby devices and beacons, and Wi-Fi scanners that detect available networks and their signal strengths.

The fusion engine operates continuously at low power consumption levels, typically running on a dedicated low-power processor or neuromorphic chip specifically designed for always-on sensor processing. This specialized hardware enables continuous operation without draining the device battery, making truly passive monitoring practical for extended periods.

The core function of the fusion engine is to combine inputs from multiple sensors to determine the current context with higher confidence than any single sensor could provide. For example, when the camera detects a product, GPS shows the device is located at a retail store, and WiFi scanning confirms connection to that store's network, the system can establish with high confidence that the user is shopping at that specific location. This multi-sensor confirmation approach reduces false positives and enables more accurate context extraction.

Real-Time Context Extraction Pipeline. The Real-Time Context Extraction Pipeline processes the continuous stream of sensor data to identify and extract meaningful contextual information. This pipeline operates as a series of processing stages, each adding value and refinement to the extracted context.

The pipeline begins with continuous sensor data flowing from the Multi-Modal Sensor Fusion Engine. This raw data stream undergoes edge processing, meaning computation performed locally on the user's device rather than in the cloud. Edge processing includes object detection to identify items in camera feeds, optical character recognition (OCR) to extract text from images, and location lookup to identify businesses or landmarks at the current GPS coordinates.

Following edge processing, the system applies contextual significance scoring to determine whether each detected element merits deeper analysis. Not every object seen by the camera or every location passed through warrants comprehensive context assembly. The significance scoring algorithm considers factors such as dwell time at a location, frequency of encounters with an object or place, uniqueness or novelty of the context, and learned patterns about what the user typically finds valuable. Elements with low significance scores may be logged briefly but not subjected to expensive deep analysis.

For contexts deemed significant, the system proceeds to deep context assembly. This stage queries external databases, calls relevant APIs, and performs web scraping to gather comprehensive information about the significant context. For a restaurant, this might include menu information, pricing, reviews, health inspection scores, chef background, and cuisine style. For a product, it might include manufacturer details, pricing across retailers, reviews, specifications, and alternatives.

The assembled context is then stored in a context index, which maintains lightweight metadata rather than raw media files. Each context entry includes temporal information, location data, identified objects or entities, significance scores, and pointers to any associated media that the user explicitly chose to capture. This index enables rapid searching and retrieval of past contexts.

The indexed contexts are made available through the user-accessible gallery interface, where users can browse, search, and interact with their accumulated contextual information at their convenience.

Temporal Context Indexing. The Temporal Context Indexing system ensures that all contextual information is precisely anchored in time, enabling powerful temporal queries and correlations across different data streams. Every context element is timestamped with nanosecond precision using synchronized system clocks. This extreme precision is necessary because users often engage in rapid context switching, and being able to precisely sequence events is critical for understanding causality and relationships.

The temporal precision enables correlation across different data streams that might otherwise appear unrelated. For example, the system can determine that a user thought about buying a new car (detected from a voice memo) at the exact moment they drove past a car dealership (known from GPS), while simultaneously researching automotive reviews on their phone (known from browsing history). These three data streams, properly time-aligned, reveal a strong purchase intent signal that would not be apparent from any single stream.

The temporal indexing system supports sophisticated queries that leverage this time-based organization. Users can ask questions such as “What was I doing when I thought about buying a new car?” and the system can correlate the voice memo timestamp with location data, browsing history, calendar events, and other contexts from that precise time period to provide a comprehensive answer.

Context Decay and Reinforcement. The Context Decay and Reinforcement system recognizes that not all contexts maintain equal importance over time. Some contexts become more valuable as they are revisited or acted upon, while others fade in relevance and can be given lower storage priority or eventually purged.

Contexts that the user engages with by opening them in the gallery, sharing them with others, or acting upon them (such as making a purchase or visiting a location) receive reinforcement. The system increases their significance scores, ensures they are retained indefinitely, and uses them as positive examples when training machine learning models to predict future context relevance.

Conversely, contexts that the user never engages with gradually decay in priority. The system does not immediately delete these contexts, as they might become relevant later, but they are moved to lower-cost storage tiers, compressed more aggressively, or marked as candidates for eventual purging if storage constraints require it.

Machine learning models continuously predict which contexts will prove valuable to preserve based on patterns in the user's past behavior. These models consider factors such as context type, location categories, product categories, information domains, time of day, and user's current projects or interests. By learning from the user's engagement patterns, the system becomes increasingly accurate at predicting which contexts deserve preservation and enrichment.

Privacy-Preserving Context Compression. The Privacy-Preserving Context Compression system addresses the fundamental privacy challenge inherent in continuous contextual monitoring. The system is designed to extract meaningful context while discarding potentially sensitive raw data, implementing a privacy-by-design approach.

After contextual information is extracted from raw sensor data, the raw data itself is immediately discarded. Only the extracted metadata is preserved. For example, rather than storing an image of a French restaurant storefront, the system stores the metadata “saw French restaurant ‘Le Petit Bistro’ at 123 Main Street, 2:30 PM, cuisine style: traditional French, price range: $$, rating: 4.5 stars.” This metadata conveys the meaningful context while eliminating the raw visual data that might inadvertently capture other people's faces, license plates, or other sensitive information.

Users maintain complete control over their contexts and can delete any context at any time without affecting other data. Because contexts are stored as discrete, independent records rather than as frames within a continuous video, deletion is granular and complete. Deleting a restaurant context removes all information about that restaurant encounter without affecting contexts from before or after.

The system implements differential privacy techniques when aggregating contexts for machine learning training. Individual user data is never transmitted in identifiable form. Instead, the system adds carefully calibrated noise to aggregated statistics, ensuring that insights can be derived to improve the system for all users while preventing any individual user's specific contexts from being identified or reconstructed.

This privacy-preserving approach makes continuous passive monitoring acceptable to users who would rightfully object to systems that record and retain raw video or audio. By focusing on contextual metadata rather than raw recordings, the system provides the benefits of comprehensive contextual awareness while respecting user privacy.

The combination of these five architectural components creates a system capable of continuous passive contextual intelligence gathering at scale. The Multi-Modal Sensor Fusion Engine provides comprehensive environmental awareness, the Real-Time Context Extraction Pipeline transforms raw sensor data into meaningful context, the Temporal Context Indexing enables powerful temporal queries and correlations, the Context Decay and Reinforcement system ensures efficient use of storage resources, and the Privacy-Preserving Context Compression protects user privacy while enabling system improvements through machine learning.

Together, these components implement a technical architecture that is fundamentally different from and superior to prior technology approaches that rely on discrete media capture, user-initiated recording, or indiscriminate data preservation. The disclosed system achieves the optimal balance between comprehensive context gathering, computational efficiency, storage efficiency, and privacy protection.

Detailed Examples of Passive Zero-Photo Context Assembly. To fully illustrate the capabilities and practical applications of a continuous passive contextual data stream system according to the disclosed embodiments, the following discussion presents four detailed examples spanning different use cases and user types. Each example demonstrates how the disclosed embodiments assemble comprehensive contextual information without requiring the user to capture any photos or take any explicit actions to do so.

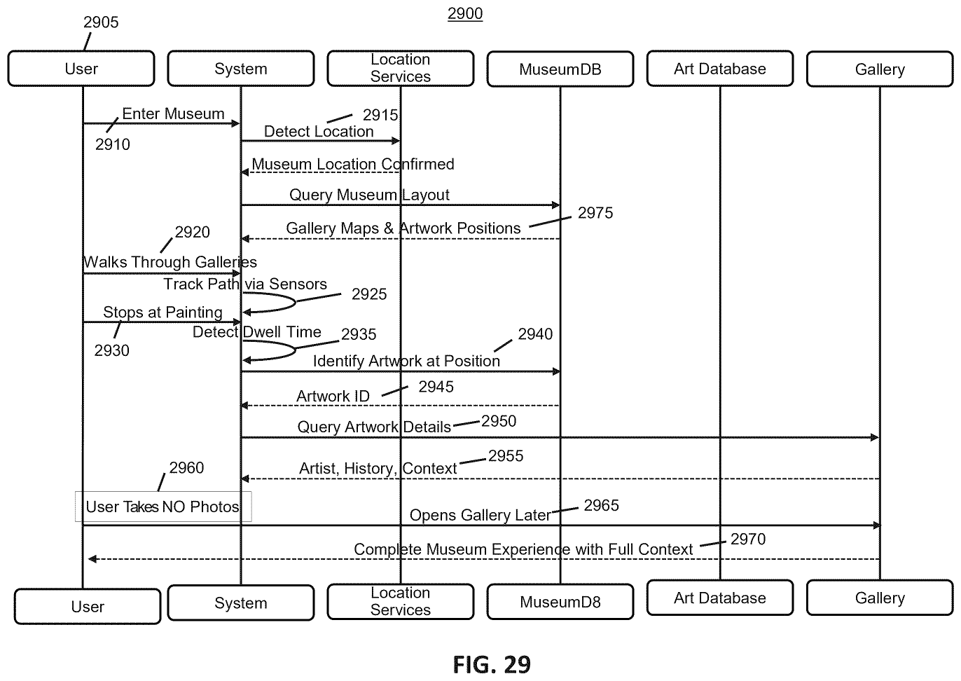

Example: Museum Visit. With reference to the timing diagram 2900 in FIG. 29, consider a user 2905 visiting an art museum for an afternoon. The user enters the museum at 2910, which is immediately detected at 2915 through GPS location data combined with Wi-Fi network identification when their device connects to the museum's visitor network. The disclosed embodiments recognize this as a significant context—a cultural institution that typically warrants contextual information gathering.

As the user walks through the galleries at 2920, their path is continuously tracked at 2925 through a combination of GPS (for general position), Wi-Fi signal strength triangulation (for more precise indoor positioning), and accelerometer data (to detect walking patterns and stops). The disclosed embodiments thereby maintain a detailed map of the user's route through the museum, including which galleries were visited and in what sequence.

When the user stops in front of particular paintings or sculptures at 2930, the disclosed embodiments detect these pauses through multiple signals. Dwell time accrues at a specific location 2935, the accelerometer indicates the user has stopped moving, and if the user is wearing smart glasses with gaze tracking, the system can identify at 2940 the specific artwork being viewed. Even without gaze tracking, the system can infer at 2940 which artwork is being observed based on the user's position relative to the gallery layout, which the system retrieves from museum databases or mapping services.

The user need not take a single photograph during the entire visit as noted at 2960. Yet, when the user later opens their gallery at 2965 to review the museum experience, they find a wealth of information at 2970 that far exceeds what any collection of photographs could provide, including artwork IDs 2945, artwork details 2950, and information about the artist, historic details and other context 2955 related to the artwork observed by the user.

The gallery 2965 displays at 2970 a complete map of the museum obtained at 2975 with the user's walking path traced through it at 2925, showing which galleries were visited and how much time was spent in each. For every artwork where the user paused as detected at 2935, the disclosed embodiments assembled comprehensive information 2955 including the artist's name and biographical details, the artwork's title and creation date, historical context explaining the period in which it was created, artistic techniques and materials used, and critical interpretations and significance of the work. The gallery may also provide links at 2970 to purchase prints or reproductions of artworks that seemed to interest the user most, information about similar artworks in other museums that the user might enjoy, and upcoming exhibitions featuring the same artists or related artistic movements. The disclosed embodiments calculates the estimated time spent in each gallery section, enabling the user to understand their engagement patterns and preferences. Finally, the disclosed embodiments suggest a return visit itinerary focused on galleries or artists the user missed but would likely appreciate based on demonstrated preferences.

All this rich contextual information is assembled without the need for the user to take a single photo, without the user manually taking notes, or recording to paper or a digital device any information, and without any conscious effort on the user's part beyond simply visiting the museum and walking through the galleries. The user was free to immerse themselves in the experience of viewing art without the distraction of documenting it, yet they have a more comprehensive record than any photo collection could provide or that would be possible to compile using mental processes or pen and paper or digital devices in the aid of such mental processes.

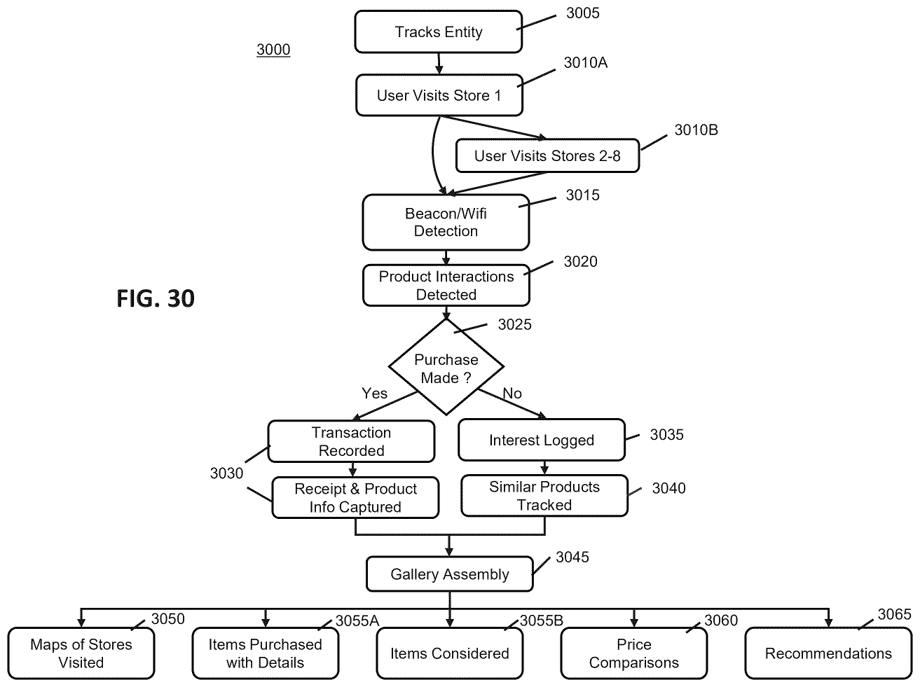

Example: Shopping Trip. With reference to the flow diagram 3000 in FIG. 30, consider a user embarking on a shopping trip to a large mall. The user drives to the mall, which the disclosed embodiments detect at block 3005, for example, through GPS tracking combined with integration with the vehicle's systems if available. The disclosed embodiments note the departure time, route taken, traffic conditions encountered, and arrival time at the mall parking area.

Once inside the mall, the user walks through eight different stores over the course of two hours. The disclosed embodiments track this movement at block 3010A-3010B through a combination of Bluetooth beacon detection (many retailers deploy beacons for their own marketing purposes), Wi-Fi network identification (each store typically has its own Wi-Fi network), GPS (which continues to provide coarse location even indoors), and pattern recognition of the user's walking pace and stops, as depicted at block 3015.

As the user browses merchandise, they pick up approximately fifteen different items to examine more closely. If the user is wearing smart glasses with camera capabilities, the system can identify these items at block 3020 through one or more of barcode scanning, product recognition via computer vision, and OCR of price tags and labels. Even without smart glasses, the system can infer at block 3020 product interest from the combination of store location, time spent in specific store sections, and credit card transaction data if the user has granted permission for such integration.

The user ultimately purchases three items, which the system detects at block 3030 through credit card transaction notifications if integrated, or through Bluetooth receipt transmission from point-of-sale systems, or through email receipt analysis. The remaining twelve items that were examined but not purchased represent important contextual information about the user's interests and preferences even though no purchase was completed, at which point, such interest may be logged at block 3035 and similar products tracked at block 3040.

Throughout this entire shopping experience, the user need not take a single photograph of any product, price tag, or storefront. Similarly, their smartphone or smart glasses need not track any interaction with any store or product therein. Yet, when the user opens their gallery at block 3045 after the shopping trip, they find a comprehensive record of the entire experience, in such detail that would be impossible for the user to recollect using merely their mental processes, with or without the aid of pen and paper and/or digital recording devices.

The gallery at block 3045 displays a map of the mall at block 3050 showing all eight stores visited, with the walking path traced between them. For each store, the gallery provides the time of entry and exit, allowing the user to understand where they spent the most time. The gallery presents at blocks 3055A and 3055B a complete list of all fifteen items that were picked up and examined, with detailed information for each. This information includes full product specifications and features, price comparison at block 3060 across multiple retailers showing where the same item is available for less, availability for online purchase with links to retailer websites, similar products from other brands that might better meet the user's needs, and recommendation at block 3065, for example, style recommendations about how the item could be used or what it pairs well with.

For the three items that were actually purchased, the gallery provides at block 3055A electronic copies of receipts, warranty information and registration links, user reviews from other customers who bought the same items, care instructions and maintenance tips, and links to purchase complementary accessories or replacement parts in the future.

For the twelve items that were examined but not purchased, the gallery saves these at block 3055B as a “considered but not purchased” collection, enabling the user to return later if they change their mind. The system can also send notifications if these items go on sale or if similar alternatives become available.

This comprehensive shopping intelligence was assembled entirely through passive monitoring, with zero photos taken and zero manual data entry required. The user was free to focus on evaluating products and making purchase decisions without the distraction of documenting everything for future reference.

Example: Work Research Session. Consider a business professional researching competitors in preparation for an important presentation. The user spends three hours at their computer, opening and reading approximately thirty different websites. Each website receives between two and ten minutes of attention as the user reads content, examines data tables, and reviews the competitor's product offerings.

The system monitors this research session through browser integration, tracking which websites are visited, how long each tab remains in focus, which sections of each page the user scrolls to and reads, and which links the user hovers over even if not clicked. The system captures no screenshots, the user captures no screenshots, copies no text, and no information is manually saved to any file or note-taking application.

Despite the apparent lack of documentation, when the user later opens their gallery to review the research session, they find that the system according to the disclosed embodiments has assembled a comprehensive competitive intelligence package that would have taken many additional hours of manual compilation to create.

The gallery presents a timeline showing all thirty websites visited in chronological order with the time spent on each. For each competitor website analyzed, the system has extracted and organized key information including a company overview with founding date, leadership, and corporate structure, a complete catalog of product offerings with descriptions, a pricing analysis comparing the competitor's pricing structure to industry norms, recent news mentions from business publications and trade journals, and stock price information and funding history for publicly-traded or venture-backed companies.

Beyond this basic information capture, the system according to the disclosed embodiments has performed sophisticated analysis and synthesis, not possible for the user to conduct using mental processes, with or without the aid of pen and paper and/or digital recording devices. The system has automatically generated a comparison table presenting all competitors side-by-side across key dimensions such as product features, pricing, target markets, geographic presence, and company size. The system has identified common themes and trends across competitors, such as emerging focus areas or shared strategic directions. It has suggested additional sources of information that the user has not yet reviewed but might be valuable based on the research pattern observed. Most impressively, the system has generated a draft outline for the presentation itself, organizing the research findings into a logical structure with sections for market overview, competitor analysis, strategic positioning, and recommendations.

Each element of this synthesized information includes references back to the specific source websites in the gallery, maintaining provenance and enabling the user to verify details or explore further. The user can click on any fact in the comparison table or draft outline and see which website or websites provided that information.

This comprehensive competitive intelligence package was assembled entirely passively while the user conducted their research. The user did not need to interrupt their thinking to document findings, create comparison spreadsheets, or organize information. They could focus entirely on understanding the competitive landscape, trusting that the system was capturing and organizing everything in the background.

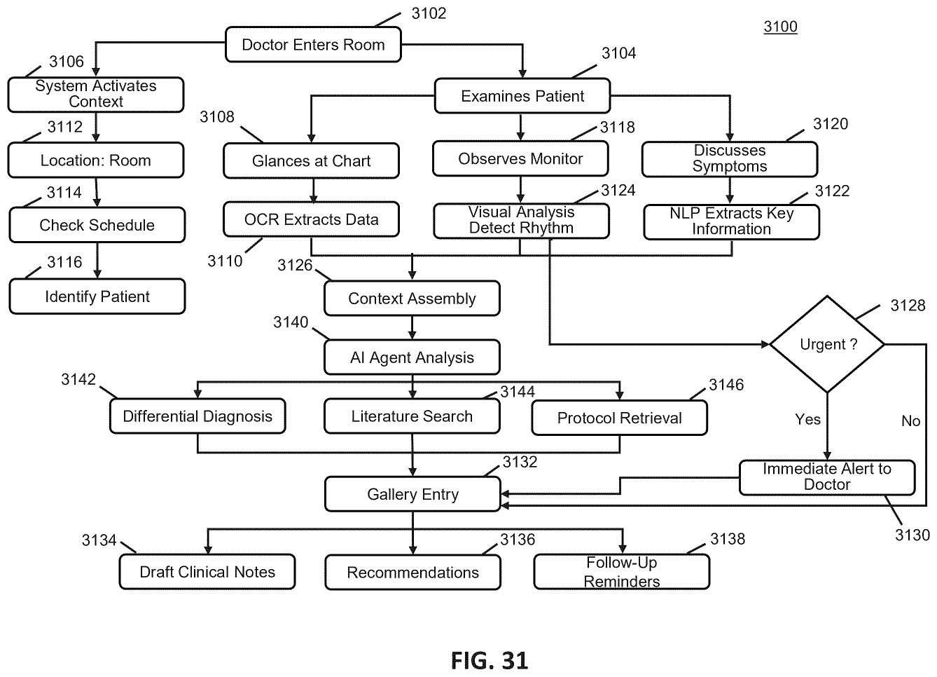

Example: Medical Appointment. With reference to the flow diagram 3100 in FIG. 31, consider a physician using a system during a patient consultation according to the disclosed embodiments. This example demonstrates the system's utility in professional contexts where comprehensive documentation is critical but taking explicit notes or photographs would be impractical or inappropriate.

The doctor enters the examination room at block 3105, which the system detects through location services operating on the doctor's wearable or on-person mobile computing devices, or on a computing device located in the room, or a combination of the two computing devices coupled in communication with each other. The system learns or knows at block 3112 this is patient or examination room 312 and cross-references with the doctor's appointment schedule in their digital calendaring application at block 3114 to identify the patient at block 3116 as John Doe with a scheduled 3:00 PM appointment for a cardiology consultation.

As the doctor examines the patient at block 3014, the system passively gathers contextual information from multiple sources at block 3106. The doctor glances at the patient chart displayed on a computer screen at block 3108, which the system detects through eye tracking, for example, if the doctor is wearing smart glasses. The system uses OCR to extract key information from the visible portions of the chart including current medications, previous diagnoses, and relevant family history, at block 3110. The doctor observes the vital signs monitor at block 3118, which shows an irregular heart rhythm. The system captures this observation through the same visual analysis, identifying the specific rhythm pattern displayed, at block 3124. The doctor and patient discuss symptoms at block 3120, with the conversation being transcribed in real-time with patient consent. The system applies at block 3122 natural language processing to the transcription to extract, for example, key symptoms, concerns, hypotheses, diagnoses, potential treatments, medications, referrals, procedures, tests, treatment protocols, outcomes, risks, restrictions, limitations, costs, medical terminology, medical literature, etc., in short, any or all the types or kinds of information a doctor and patient might discuss in such a setting.

Throughout this consultation, the doctor takes no photographs, writes no notes, and does not interact with any computer system for documentation purposes. All of their attention is focused on the patient and the clinical assessment. Nevertheless, when the doctor completes the consultation and moves to the next patient, the system has assembled a comprehensive record of the encounter.

Later, when the doctor opens their gallery at block 3132 to review the day's patient visits, they find detailed documentation for each appointment. For the patient in room 312, the gallery provides at block 3132 a complete visit summary that has been automatically generated, synthesizing the information gathered during the encounter. The system has assembled extensive contextual medical information at block 3126 including identification of the irregular heart rhythm pattern observed on the monitor, a list of the three most likely diagnoses based on the rhythm pattern, patient history, and symptoms discussed, retrieval of current treatment protocols from medical databases for each possible diagnosis, recent medical literature relevant to this presentation including studies published within the past month, and recommendations at block 3136 for follow-up actions such as ordering an EKG, reviewing anticoagulation therapy, or consulting with a cardiac electrophysiologist.

The system has also recognized at block 3128 that the irregular rhythm combined with the patient's history of previous myocardial infarction and family history of arrhythmia represents a potentially acute risk. This triggered the urgent medical alert agent (part of the hierarchical AI agent system discussed elsewhere in this patent), which immediately surfaced critical information in the doctor's field of view during the appointment, at block 3130: “Possible atrial fibrillation—patient at high stroke risk. Recommend: EKG, anticoagulation review, cardiology consult.”

The gallery entry for this patient also includes draft clinical notes produced at block 3134 that are ready for review and approval before entry into the electronic health record system, links to relevant medical literature with key passages highlighted, and at block 3138 reminders for follow-up actions that need to be scheduled.

This comprehensive medical documentation was assembled without the doctor taking any explicit documentation actions during the appointment. The passive system captured everything relevant while the doctor-maintained focus on the patient, eye contact, and the human aspects of care that are so critical in medicine yet often compromised when doctors must simultaneously interact with computer systems for documentation.

These four examples demonstrate the breadth and depth of contextual information that can be assembled through continuous passive monitoring without any photo capture or explicit user actions. Across cultural experiences, shopping activities, professional research, and medical practices, the system provides comprehensive documentation and contextual intelligence that exceeds what is possible with one's memory, supports decision-making, and reduces cognitive burden. The key innovation is that all of this capability is provided passively, without requiring users to interrupt their activities or divide their attention between experiencing the moment and documenting it.

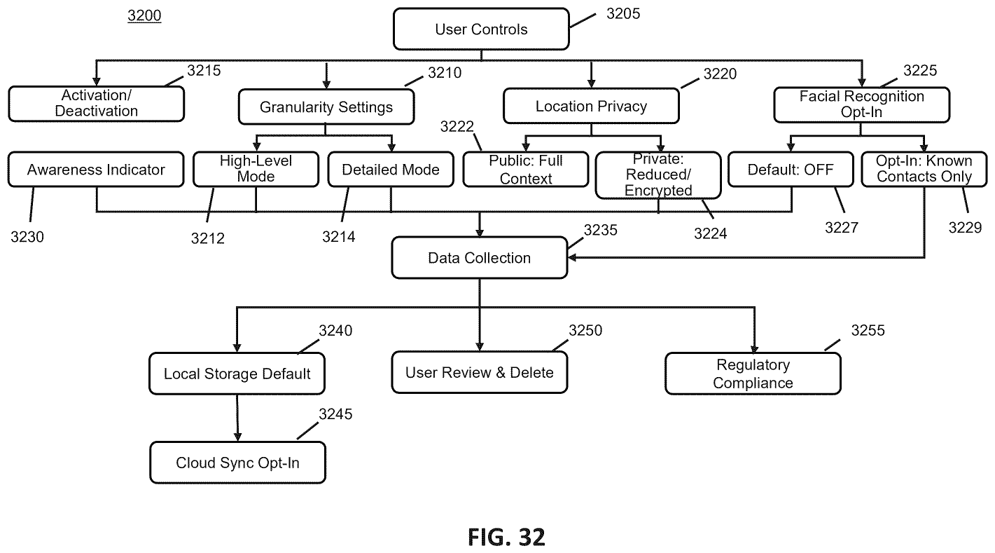

Regulatory and Ethical Considerations. With reference to FIG. 32, the implementation of continuous passive contextual monitoring according to the disclosed embodiments raises important regulatory and ethical considerations addressed through thoughtful system design and transparent user controls 3205. The disclosed embodiments incorporate Privacy by Design principles from its foundation, ensuring that privacy protection is not an afterthought but rather a core architectural component.

Passive vs. Surveillance. With reference to FIG. 32, a critical distinction is drawn between the passive contextual monitoring according to the embodiments disclosed herein and surveillance systems that might appear superficially similar. The disclosed embodiments are fundamentally different from surveillance in both architecture and intent, and these differences have important legal and ethical implications.

A system according to the disclosed embodiments provide users with complete control over activation and deactivation of passive monitoring activities. Users can enable or disable the passive monitoring at any time through simple controls in the system settings. Unlike surveillance systems that operate without the subject's knowledge or consent, the disclosed embodiments require affirmative opt-in by the user and clearly communicates when passive monitoring is active. The system displays a clear indication when passive monitoring is active, though importantly this is not a “recording indicator” in the traditional sense because the system is not creating recordings. Rather, it is an awareness indicator at block 3230 that informs the user that contextual analysis is occurring in real-time. This distinction is important both technically and legally.

All data collected by the system at block 3235 is stored locally on the user's device by default at block 3240. Cloud synchronization is available as an opt-in feature, not a requirement, at block 3245. Users who are concerned about cloud security or who operate in regulated industries can use the full functionality of the system while keeping all data on-premise. Users can review and delete any context at any time at block 3250 through the gallery interface. Deletion is immediate and complete—there are no hidden backups or delayed deletion windows. If a user deletes a context, it is permanently removed from their device and, if applicable, from any cloud storage.

The system derives contextual information rather than preserving raw recordings. After contextual metadata is extracted from sensor data, the raw sensor data is discarded. This means that even if a device were lost, stolen, or subpoenaed, the raw sensory recordings would not be available because they were never retained. Only the extracted contextual metadata exists.

The system is designed for compliance with major privacy regulations including the General Data Protection Regulation (GDPR) in the European Union, the California Consumer Privacy Act (CCPA) in California, and the Health Insurance Portability and Accountability Act (HIPAA) for medical applications. Compliance mechanisms provided via block 3255 include data minimization (collecting only what is necessary), purpose limitation (using data only for stated purposes), transparency (clear communication about data practices), and user rights (access, deletion, portability, and objection).

Consent and Transparency. With reference to the functional block diagram 3200 in FIG. 32, the system's approach to consent and transparency goes beyond mere legal compliance to establish a trust relationship with users based on clear communication and meaningful control.

During initial setup, the system explains in clear, non-technical language what data is collected and why. Users are not presented with lengthy legal documents written for lawyers; instead, they see concise, understandable explanations such as “We will track your location to provide information about places you visit” or “We will analyze what you see to identify products and provide shopping options.” The purpose and benefit of each type of data collection is clearly articulated.

Via user controls at block 3205, users set at block 3210 the granularity of context collection according to their preferences and comfort level. A high-level mode at bock 3212 captures only major contexts such as locations visited and general activities, without detailed analysis of specific objects or text. A detailed mode at block 3214 captures comprehensive contextual information including specific products seen, text read, people encountered (if facial recognition is enabled), and fine-grained activity logs. Users can select the mode that matches their privacy preferences and use case requirements.

An important ethical consideration is the treatment of other people who may appear in the user's visual field. The system does not identify other people by default through facial recognition as indicated at block 3227. Facial recognition is an opt-in feature that can be enabled at block 3225 that requires explicit user activation via block 3215. Even when facial recognition is enabled, the system only identifies people for whom the user has provided relationship information (such as contacts in their address book who have consented to identification) at block 3229. Random people encountered in public spaces are not identified or tracked, though contextual information about locations may still be assembled.

The system clearly distinguishes between public and private location contexts. Public locations such as retail stores, museums, and restaurants are subject to full contextual information gathering at block 3222 because the user is in a space where they have limited privacy expectations. Private locations such as homes, medical facilities, and places of worship receive special treatment at block 3224 with reduced or encrypted contextual logging unless the user explicitly indicates otherwise at block 3220. The system can be configured to pause contextual monitoring entirely in certain location categories if the user desires.

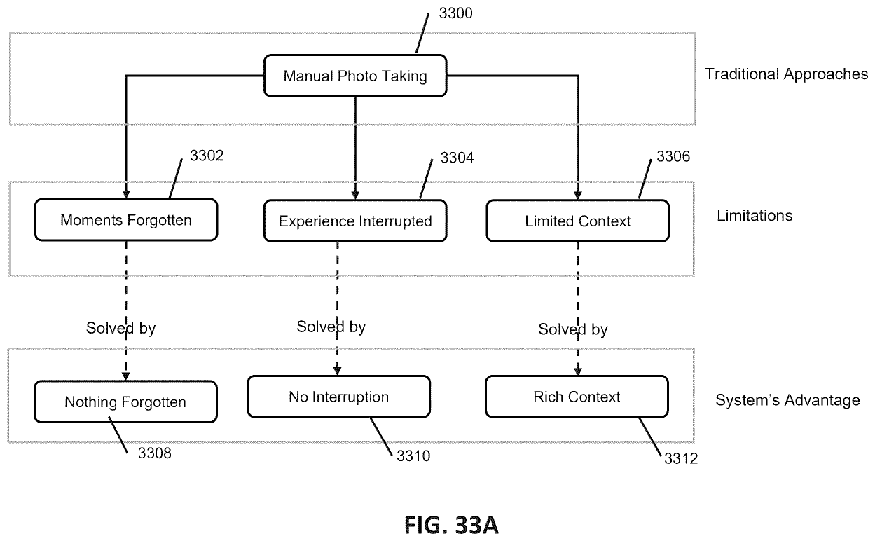

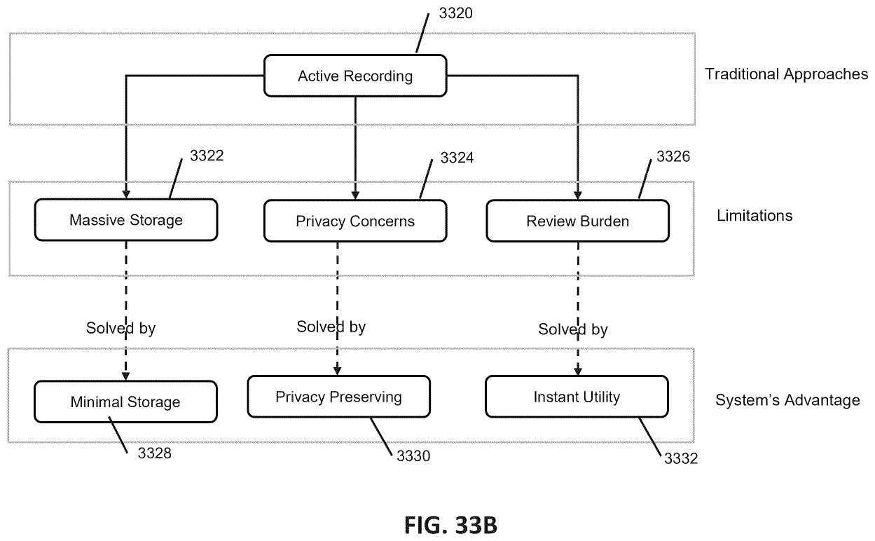

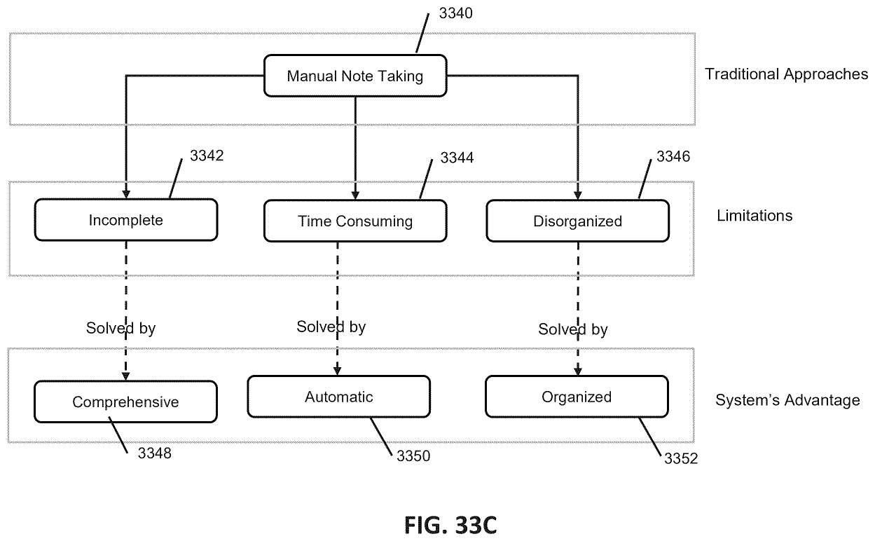

Advantages Over Traditional Systems. The continuous passive contextual monitoring system according to the embodiments disclosed herein provides significant advantages over traditional approaches to information capture and organization. These advantages span user experience, information quality, privacy protection, and cognitive efficiency, as discussed further below with reference to FIGS. 33A, 33B, and 33C.

Compared to Manual Photo-Taking. With reference to FIG. 33A, traditional photo-taking requires users to consciously decide in each moment what is worth capturing and manually take a picture at block 3300. This imposes several burdens and limitations. Users inevitably forget to capture important moments at block 3302 because they are focused on the experience rather than documentation. Critical contextual information is lost when users fail to photograph relevant elements of their environment. The act of taking photos interrupts the natural flow of experience at block 3304, removing users from the moment and placing them in a documentation mindset. Photos, even when successfully captured, provide only limited contextual information at block 3306—primarily visual appearance without the rich metadata about location, timing, related information, or connections to other contexts.

The disclosed passive system eliminates all of these limitations. Users never forget to capture important moments because the system captures everything automatically at block 3308. The continuous monitoring ensures that no significant context is lost. Users can remain fully immersed in their experiences without any interruption for documentation purposes at block 3310. Their attention can be devoted entirely to experiencing, understanding, and enjoying the moment rather than being divided between participation and documentation. The contextual information assembled by the system at block 3312 is far richer than any photo could provide, including not just visual information but also location data, temporal relationships, connections to other contexts, background information from external sources, and learned patterns about the user's interests and preferences.

Additionally, the system enables retrospective analysis of moments that the user did not recognize as important at the time. A user might walk past a restaurant without giving it much thought, but later recall that a friend recommended that specific restaurant. With traditional photo-taking, if the user did not photograph the restaurant, that information is lost. With the passive system, the context was captured automatically, and the user can later retrieve it by searching for restaurants encountered that day or in that neighborhood.

Compared to Active Recording Systems. With reference to FIG. 33B, active recording systems at block 3320 such as life-logging cameras or continuous video capture represent an alternative approach to comprehensive documentation. However, these systems have severe limitations that make them impractical for most users and use cases.

Active recording systems have vastly higher storage requirements at block 33222, typically consuming multiple gigabytes per hour of recording. Even with modern storage capacities, this limits how long users can record before exhausting available storage. They also have better privacy profiles at block 3324 because they create comprehensive recordings that might inadvertently capture sensitive information, other people's faces or conversations, or confidential information in the user's environment. However, the legal and ethical implications of continuous recording are significant, and many jurisdictions require visible recording indicators that may make others uncomfortable.

Most critically, active recording systems impose at block 3326 significant cognitive burden on users who must later review hours of footage to find moments of interest. A user might record an entire day's activities, generating eight to twelve hours of video, but they must then spend substantial time reviewing that video to identify and extract the portions that matter. This review burden is so onerous that most recorded footage is never reviewed, making the recording effort largely wasted.

The disclosed embodiments address all these limitations through its passive, metadata-focused approach. Storage requirements at block 3328 are vastly lower—typically ten to fifty megabytes per day of contextual metadata compared to multiple gigabytes for video recording. The privacy profile at block 3330 is much better because the system extracts contextual metadata and discards raw recordings, meaning there are no video files to be leaked, stolen, or subpoenaed. The system performs intelligent extraction in real-time at block 3332, instantly, in real-time or near real-time, identifying and highlighting key moments automatically so that users never need to review hours of raw footage. Contextual information is immediately useful and accessible at block 3332 through search and browsing interfaces rather than requiring linear review of recordings.

Compared to Manual Note-Taking. With reference to FIG. 33C, some users attempt to maintain comprehensive records of their activities through manual note-taking at block 3340, journaling, or list-keeping. While this approach provides some benefits, it has severe limitations compared to the disclosed passive system.

Manual note-taking is inevitably incomplete as indicated at block 3342 because users forget to note many experiences and observations. The act of note-taking is time-consuming, at indicated at block 3344, and slow and cumbersome, particularly on mobile devices, and interrupts the flow of activities. Notes are typically text-only, lacking the rich multimedia context, metadata, and connections that the passive system provides. Manual notes require users to organize and file their notes in some coherent system, which many users find difficult to maintain consistently. The result is often disorganized, scattered notes in multiple applications, physical notebooks, and random text files that are difficult to search and retrieve later, as indicated at block 3346.

The disclosed system eliminates all of these problems through comprehensive automatic capture as indicated at block 3348, instant recording without user effort or interruption, rich multimedia context including images, location data, timing information, and connections to related contexts, automatic organization and categorization without any user effort as indicated at blocks 3350 and 3352, and powerful search and retrieval capabilities across all accumulated contexts.

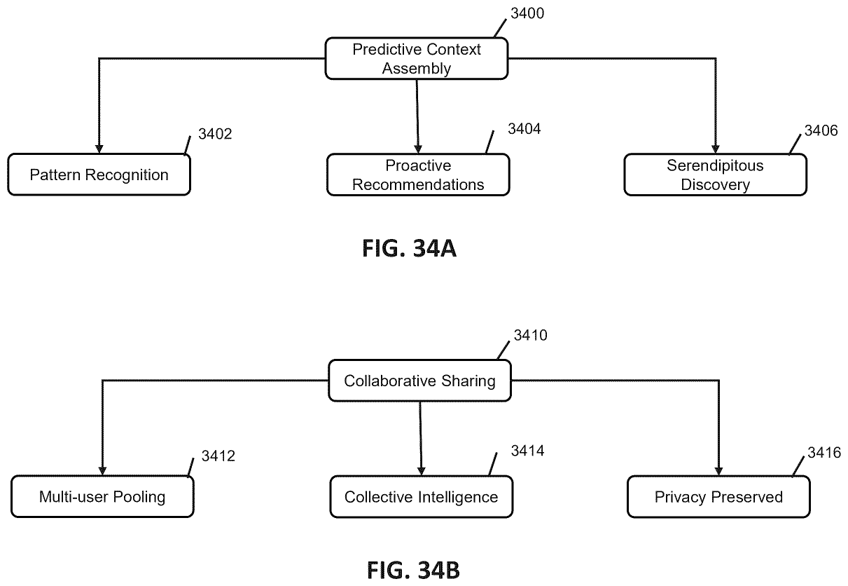

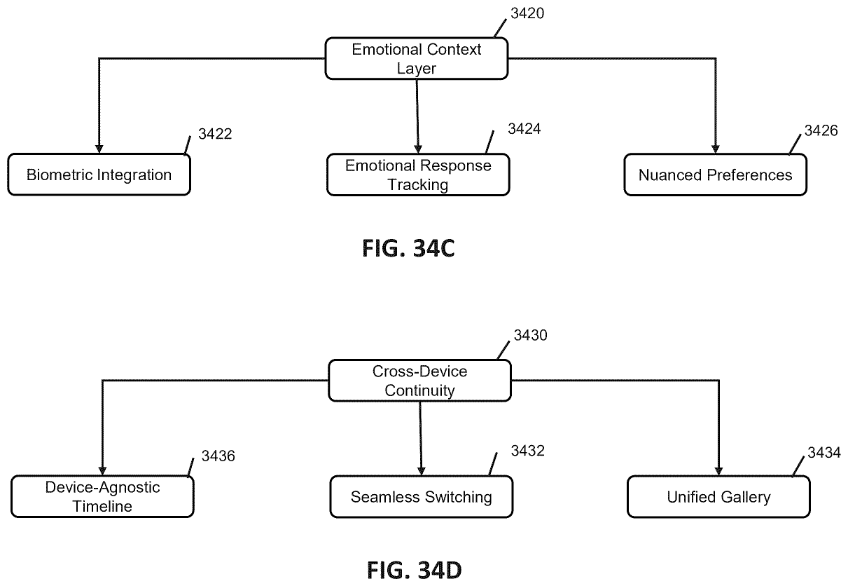

Future Enhancements to Passive Context Stream. With reference to FIGS. 34A-34D, the disclosed system architecture is designed to accommodate future enhancements as technologies evolve and user needs expand. Several promising directions for enhancement are described below, each building on the foundation of continuous passive contextual monitoring.

Predictive Context Assembly. With reference to FIG. 34A, as the disclosed embodiments accumulate more data about user patterns and preferences, it can begin to predict at block 3400 what contexts users will need before those contexts become immediately relevant. This predictive capability transforms the system from reactive (responding to what the user encounters) to proactive (anticipating what the user will want to know).

Based on patterns learned at pattern recognition block 3402, the system can predict what contexts users will need and assemble them in advance. For example, if a user regularly visits a particular coffee shop on Tuesday mornings, the system can proactively assemble at block 3404 contextual information for nearby areas that the user has not yet explored. On Tuesday morning, before the user even leaves for the coffee shop, the system might present “suggested explorations” in the gallery showing new restaurants in the area, upcoming events at nearby venues, or shops that match the user's demonstrated interests.

This predictive context assembly enables serendipitous discovery at block 3406. Users find valuable information about opportunities they were not actively seeking but that align with their interests and patterns. The system essentially acts as a personalized discovery engine, continuously finding relevant opportunities in the user's environment and presenting them at appropriate times.

Collaborative Context Sharing. With reference to FIG. 34B, in many situations, multiple users are present at the same location or participating in the same activity. The system can enable at block 3410 these users to pool at block 3412 their contextual data with appropriate permissions, creating a richer collective understanding at block 3414 than any individual could achieve alone.

Consider a conference where hundreds of attendees are using the system. Each attendee's device captures contexts about sessions attended, speakers heard, networking contacts made, and materials reviewed. With user permission, these individual contexts can be pooled at block 3412 to create a collective conference experience. The group gallery shows which sessions were most attended and highly rated, which speakers generated the most engagement, which topics were discussed most frequently in networking conversations, and which materials were most commonly saved or shared.

Privacy is carefully preserved at block 3416 in this collaborative model. Only contexts that users explicitly mark as shareable are included in the collective pool. Individual contributions are attributed when appropriate but can also be anonymized if users prefer. Users can withdraw their contributions at any time, and the system ensures via block 3416 that sensitive contexts remain private even as users participate in collaborative sharing.

Emotional Context Layer. With reference to FIG. 34C, modern wearable devices include biometric sensors that can detect physiological indicators of emotional state, including heart rate, heart rate variability, skin conductance (galvanic skin response), and respiration rate. The system can incorporate or integrate these biometric signals at block 3422 to add an emotional dimension to contexts.

To that end, an emotional context layer at block 3420 enables the system to learn which contexts correlate with positive or negative emotional responses at block 3424. A user might linger at an art gallery, which the system records as a significant context. However, if biometric sensors show elevated stress indicators during this visit, the system learns that despite spending time there, the experience was not enjoyable. Future recommendations can be weighted accordingly at block 3426—the system might note the user's interest in art galleries but avoid over-recommending crowded or stressful environments.

This emotional feedback creates a more nuanced understanding of user preferences. Two users might visit the same restaurant and spend the same amount of time there, but their emotional responses might be completely different. The system learns these individual response patterns and tailors future contextual information and recommendations accordingly.

Cross-Device Context Continuity. With reference to FIG. 34D, modern users interact with multiple devices throughout their day, including smartphones, tablets, laptops, desktop computers, smart watches, and potentially AR glasses or other wearables. The system provides seamless context continuity across all of these devices at block 3430, creating a unified, device-agnostic contextual timeline at block 3436 regardless of which device captured each context.

A user might start browsing travel websites on their smartphone during a morning commute, generating contextual information about vacation destinations. When they arrive at work and open their laptop, the system automatically surfaces the same travel contexts on the laptop at block 3432, allowing seamless continuation of their research. In the evening, when they put on AR glasses to browse for activities, the system presents the accumulated travel contexts in an immersive spatial interface.

The gallery at block 3434 shows a unified timeline across all devices, eliminating the artificial fragmentation that occurs when different devices maintain separate data stores. Context switching at block 3432 between devices is seamless—the user does not need to think about which device captured which context. The system handles all synchronization and merges automatically, presenting a coherent view of the user's activities regardless of device boundaries.

This cross-device continuity is particularly valuable for users who work across multiple computing environments or who use specialized devices for specific activities. The contextual thread remains unbroken even as users move between devices, ensuring that relevant information is always available in the appropriate format for each device and use case.

These features demonstrate the extensibility and forward-looking design of the disclosed embodiments. Each feature builds naturally on the foundation of continuous passive contextual monitoring, adding new dimensions of intelligence and utility without changing the fundamental architectural. The system is positioned to evolve as new sensors, new devices, and new user needs emerge, maintaining its core value proposition of comprehensive contextual intelligence without user burden.

Technical Specifications for Passive Context Stream Processing. The continuous passive context stream balances technical specifications to achieve comprehensive contextual awareness while maintaining acceptable performance, battery life, and storage efficiency. The following discussion provides detailed quantitative specifications that define the system's operational parameters according to the disclosed embodiments.

Data Rate and Volume. The system processes contextual information at rates that vary based on user activity level and context richness, but typical operational parameters can be quantified to distinguish the system from prior technology and establish performance benchmarks.

During active use periods when the user is moving through environments with rich contextual information, visual context extraction operates at a rate of one to ten events per minute, according to an embodiment. An event represents a discrete contextual element such as identifying a store, recognizing a product, reading a sign, or detecting a landmark. The variable rate accommodates both sparse environments where few significant contexts are encountered and rich environments such as shopping districts or museums where contexts are densely packed.

Location context updates occur at a rate of one update per thirty seconds to five minutes, with the update frequency adapting dynamically based on movement patterns, according to an embodiment. When the user is stationary, updates occur infrequently to conserve battery power. When the user is moving rapidly, such as driving or walking through a busy area, updates occur more frequently to maintain accurate positioning. This adaptive approach optimizes the balance between context accuracy and power consumption.

Digital context events, including browsing history and application usage, generate approximately one event per page view or application switch, according to an embodiment. A typical user might generate twenty to one hundred digital context events per hour depending on their level of digital engagement. Each event captures one or more of the URL or application identifier, the duration of engagement, and any relevant metadata such as search terms or content categories.

The cumulative storage requirement for all of these context streams is approximately ten to fifty megabytes per day of passive collection. This figure represents metadata only—no raw media files are included in this calculation. The storage requirement scales linearly with usage intensity, with more active users and richer contexts generating data at the higher end of the range. This storage footprint is negligible compared to modern device storage capacities, enabling months or years of contextual history to be maintained, for example, on-device without storage pressure.

To provide perspective on the efficiency of this approach, consider the contrast with video recording systems. A single hour of HD video recording typically consumes one to five gigabytes of storage. The disclosed embodiments can capture an entire day's worth of contextual information—potentially twelve to sixteen hours of active monitoring—using less storage than the equivalent of ten minutes of HD video. This dramatic efficiency difference makes continuous passive monitoring practical where continuous video recording would be infeasible or impractical.

Processing Requirements. The system divides processing between edge processing performed on the user's device and cloud processing performed on remote servers, with the division optimized based on one or more of device capabilities, network availability, and privacy preferences.

Edge processing encompasses the time-critical and privacy-sensitive operations that occur locally on the device. This includes object detection in camera feeds to identify visible items, optical character recognition to extract text from images, and location lookup to identify the user's current position and nearby points of interest. These edge operations operate with low latency to enable real-time contextual awareness. The target latency for frame analysis is less than one hundred milliseconds per frame, ensuring that context extraction keeps pace with the user's activities without perceptible delay.

The power consumption for continuous edge processing may be controlled to maintain acceptable battery life. Typical power consumption ranges from fifty to two hundred milliwatts for continuous operation, which represents a negligible impact on modern device battery life. This efficiency is achieved through use of specialized low-power processors, neuromorphic chips designed for always-on sensing, and aggressive optimization of processing algorithms to minimize computational overhead.

Cloud processing, which is opt-in and may be triggered for significant events rather than operating continuously, handles the deeper contextual analysis that benefits from access to large databases, powerful computing resources, and machine learning models that are too large to deploy on edge devices. When a significant context is identified through edge processing, the system can invoke cloud services to assemble comprehensive information. The target latency for cloud-based comprehensive context assembly is one to five seconds, which is acceptable because users do not require instant access to deep context—they may need only the high-level context immediately, with detailed information available shortly thereafter.

The decision to invoke cloud processing is made intelligently based on one or more factors. Network availability may be checked before initiating cloud requests to avoid failed operations or excessive latency. Device capabilities may be assessed to determine whether the requested processing could reasonably be performed locally. Privacy preferences are respected, with users who have disabled cloud features receiving only locally computed context. Processing priority may be evaluated, with high-priority contexts receiving immediate cloud processing while lower-priority contexts may be queued for batch processing during idle periods.

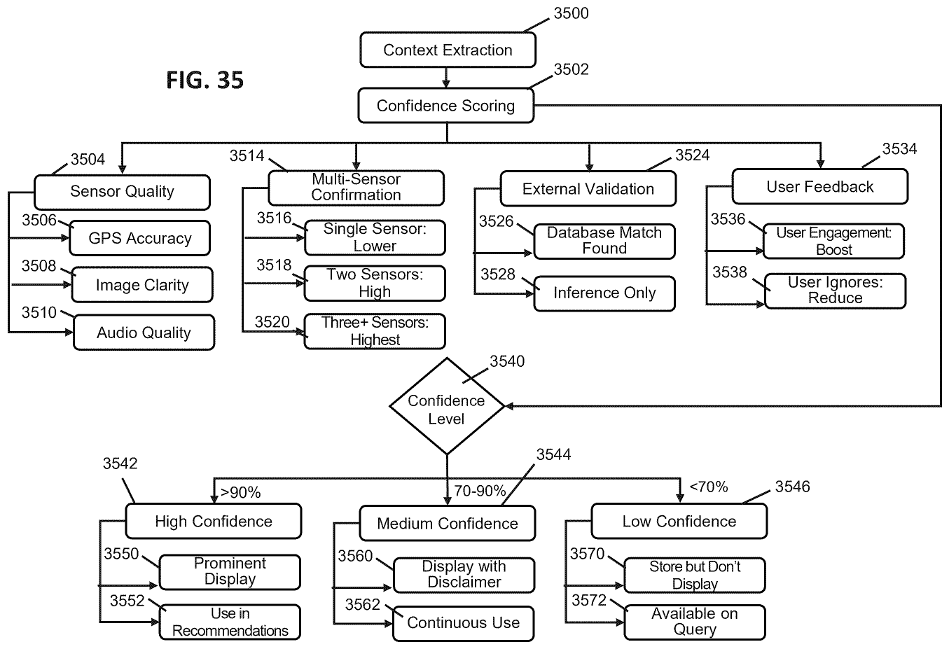

Context Confidence Scoring. With reference to context extraction and identification 3500 depicted in FIG. 35, not all contexts can be identified with equal certainty. Thus, the disclosed embodiments communicate this uncertainty appropriately to users while using confidence levels to inform the disclosed embodiments' own decision-making about context presentation and enrichment.

Each extracted and/or identified context element is assigned a confidence score at block 3502 based on multiple factors that contribute to certainty about the identification of the context element. Sensor quality at block 3504 represents the first factor—GPS accuracy measured in meters at block 3506, image clarity measured by focus and lighting quality at block 3508, and audio clarity measured by signal-to-noise ratio at block 3510 all contribute to the confidence score. Generally speaking, higher quality sensor data enables more confident context extraction.

Multi-sensor confirmation at block 3514 provides another confidence boost. When two independent sensors agree about a context at block 3518, confidence increases substantially. For example, if GPS indicates the user is at a specific restaurant and Wi-Fi network identification confirms connection to that restaurant's network, the combined confidence is much higher at block 3518 than either sensor alone would provide at block 3516. Three-way confirmation from GPS, Wi-Fi, and visual identification of signage provides even higher confidence at block 3520.

External validation at block 3524 through database matches at block 3526 contributes additional confidence. When the system identifies a product through computer vision and successfully matches it to a product in a retail database with high similarity scores, confidence increases. Conversely, when no database match can be found and the identification is based purely on inference at block 3528, confidence is lower.

User feedback over time provides the final confidence adjustment at block 3534. When users engage with contexts similar to a newly identified context, the system gains confidence that such identifications are valuable and accurate, at block 3536. When users consistently ignore or delete certain types of contexts, the system reduces confidence in those identifications, at block 3538. This feedback loop enables continuous improvement in context identification accuracy.

The system uses three confidence level tiers for presentation and decision-making at block 3540. High confidence contexts at block 3542, scored above ninety percent, are presented prominently in the gallery at block 3550 and used at block 3552 as primary inputs for recommendations and predictions. These contexts are considered reliable enough to act upon. Medium confidence contexts at block 3544, scored between seventy and ninety percent, are presented at block 3560 with appropriate disclaimers such as “Possible match” or “Likely” and are used cautiously in recommendations. The system may seek additional confirmation before committing these to long-term storage or using them for important decisions at block 3562. Low confidence contexts at block 3546, scored below seventy percent, are stored at block 3570 for potential future reference but are not presented to users unless they specifically query for them at block 3572. These contexts might become relevant if additional information becomes available later to boost their confidence scores.

Real-Time vs. Batch Processing. The system may employ a hybrid processing architecture that combines real-time processing for time-critical operations with batch processing for computationally expensive analysis that does not require immediate results.

Real-time processing, which operates in real time or within seconds of context detection, handles the operations that users expect to see immediately. Object detection identifies items in the camera feed with minimal latency, enabling applications such as augmented reality overlays that appear synchronized with the user's view. Location lookup identifies the user's current position and nearby points of interest, supporting location-aware features that must respond instantly to user movement. Basic classification categorizes contexts into broad categories such as shopping, dining, entertainment, or information, enabling immediate filtering and organization of incoming contexts.

Batch processing, which operates on an hourly or daily schedule, handles analysis that may benefit from larger computational resources but does not require instant or immediate results. Deep context enrichment queries multiple databases and APIs to assemble comprehensive information about contexts, which may take several or more seconds per context and can be performed in the background without user awareness. Pattern analysis examines accumulated contexts to identify trends, preferences, and behavioral patterns that inform future context identification and recommendation. Machine learning model training updates the system's classification and prediction models based on accumulated data, improving accuracy over time.

User-initiated processing represents a third category that operates on-demand when users access the gallery. When a user opens the gallery to review their contexts, the system may trigger additional context assembly if needed to provide more current and complete information. This on-demand processing ensures that the gallery presents the appropriate or the best available information while avoiding unnecessary computation for contexts that may not be viewed soon, or ever.

The division of processing across these three categories optimizes the tradeoff between responsiveness, thoroughness, and resource efficiency. Users receive immediate feedback for time-critical operations, benefit from deep analysis performed in the background, and can trigger additional processing when they specifically request detailed information.

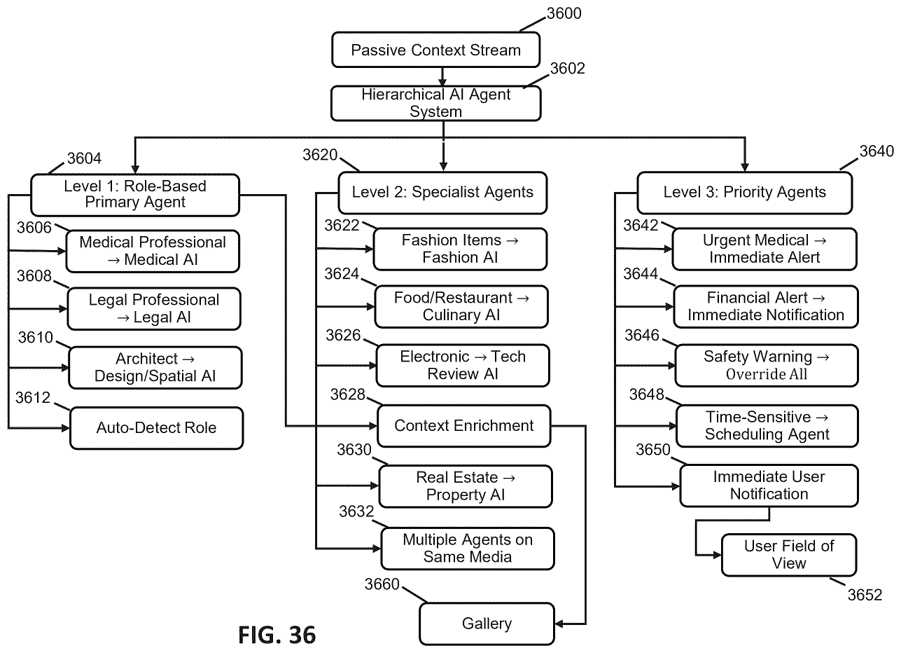

Integration with Hierarchical AI Agent System. With reference to FIG. 36, a passive context stream 3600 feeds into a hierarchical AI agent system 3602 described elsewhere in this patent application, creating an intelligent routing and enrichment framework that ensures contextual information reaches the appropriate specialist agents and is processed with domain-specific expertise.

Level 1: User Role-Based Primary Agent. This first level of the agent hierarchy selects at block 3604 a primary AI agent based on the user's professional role or primary area of expertise. This role-based routing ensures that contextual information is interpreted and enriched with appropriate domain knowledge.

For a medical professional, all health-related contexts are automatically routed to a medical specialist AI agent at block 3606. This agent understands medical terminology, can interpret clinical findings, knows which medical databases and literature sources are authoritative, and can provide clinically relevant contextual enrichment. A cardiologist using the system has their primary agent configured as a cardiology specialist, ensuring that cardiac-related contexts receive expert-level interpretation.

For a lawyer, all law-related contexts flow to a legal research AI agent at block 3608. This agent can identify relevant case law, understand legal citations, recognize jurisdictional variations in legal interpretation, and provide contextually appropriate legal research. A patent attorney receives enhanced context related to, for example, prior technology, patent databases, and intellectual property law.

For an architect, design and spatial contexts are directed to a design and spatial reasoning AI agent at block 3610. This agent can analyze architectural elements, understand building codes and regulations, recognize architectural styles and historical periods, and provide context related to design principles and construction methods.

The system learns the user's primary role over time if not explicitly set during initial configuration. By observing which types of contexts the user engages with most frequently, which professional databases they access, and which domain-specific terminology appears in their activities, the system can infer their role and configure the primary agent accordingly at block 3612. This automatic role detection ensures that the system provides appropriate expertise even for users who do not explicitly configure their professional role.

Level 2: Media/Action-Based Specialist Agents. The second level of the agent hierarchy at block 3620 routes contexts to specialist agents based on the type of media or the nature of the action being performed, regardless of the user's primary role. This ensures that domain-specific expertise is applied even when the context falls outside the user's primary area of expertise.

When a user places media in the gallery at block 3660 via drag-and-drop, or when the passive system identifies significant media contexts, the appropriate specialist agent is automatically engaged. Fashion items trigger the fashion AI agent at block 3622, which can identify brands, recognize styles and trends, suggest complementary items, and provide pricing information across retailers. Food and restaurant contexts activate the culinary AI agent at block 3624, which can identify cuisines, recommend dishes, assess nutrition information, and suggest wine pairings or similar restaurants. Electronics and technology products engage the tech review AI agent at block 3626, which can compare specifications, identify the latest models, assess value propositions, and provide expert reviews.

Real estate contexts, including buildings, apartments, or properties viewed during passive monitoring, activate the property analysis AI agent 3630. This agent can assess property values, identify neighborhood characteristics, compare similar properties, and provide information about schools, transportation, and local amenities.

Multiple specialist agents can operate concurrently on different aspects of the same media. For example, an image of a person wearing fashionable clothing in front of an architecturally significant building would trigger both the fashion agent to analyze the clothing and the architectural agent to analyze the building. Each agent enriches at block 3628 the context with its domain-specific expertise, and the results are integrated at block 3632 into a unified contextual record.

Level 3: Temporal Urgency-Based Priority Agents. The third level of the agent hierarchy at block 3640 handles time-sensitive contexts that require immediate attention, bypassing the normal routing and processing queues to ensure urgent information reaches the user without delay.

In medical contexts, urgent lab results showing critical values, medication interactions detected when a new prescription is added, or acute symptom patterns suggesting serious conditions are immediately routed to a priority medical alert agent at block 3642. An example describing a British medical agent receiving urgent drug interaction alerts, though the nationality designation is merely illustrative—any appropriate medical knowledge base can serve this function. A characteristic is that urgent medical information bypasses normal context queuing and appears immediately via block 3650 in the user's field of view at block 3652.

Financial contexts trigger priority routing when price alerts indicate that a stock or commodity has reached a user-specified threshold, fraud detection algorithms identify suspicious transactions requiring immediate user confirmation, or significant market movements affect holdings in the user's portfolio, at block 3644. These financial priority contexts appear as immediate notifications rather than waiting to be discovered during a routine gallery review at block 3660.

Safety contexts receive the highest priority when weather warnings indicate severe conditions in the user's current or planned locations, security alerts identify threats in the user's vicinity, or emergency notifications from government agencies require immediate attention, at block 3646. These safety-critical contexts override all other information presentation and demand immediate user attention.

Time-sensitive contexts such as appointment conflicts detected when a meeting invitation overlaps with an existing commitment, deadline reminders for time-critical tasks, or transportation alerts indicating delays that will affect planned travel are routed to a scheduling priority agent that ensures time-sensitive information is presented when it can still inform decisions, at block 3648.

The priority routing system uses sophisticated algorithms to determine what constitutes “urgent” for each user, learning from their responses to previous alerts. If a user consistently dismisses certain types of alerts or indicates they are not urgent, the system adjusts its urgency thresholds accordingly. Conversely, if a user reliably acts on certain types of alerts, the system becomes more aggressive about routing similar contexts through the priority channel.

Medical Professional Using Passive Context Stream. To illustrate the integration of passive context monitoring with the hierarchical AI agent system, consider the detailed example of Dr. Smith, a cardiologist, using the system during hospital rounds. This example demonstrates how all three levels of the agent hierarchy work together to provide comprehensive, expert-level contextual support.

Dr. Smith wears AR glasses equipped with the passive monitoring system as she makes her rounds. She walks into Patient Room 312, and the system detects this through Bluetooth beacon proximity, GPS location within the hospital, and visual recognition of the room number sign. The system cross-references this location with Dr. Smith's appointment schedule and identifies the patient as John Doe, scheduled for a 3:00 PM cardiology consultation.

As Dr. Smith examines the patient, passive data collection occurs continuously without any action on her part. She glances at the patient chart displayed on the computer screen, and the system uses eye tracking to detect this interaction. OCR technology extracts key information from the visible portions of the chart, including current medications (beta blocker and anticoagulant), previous diagnoses (myocardial infarction three years ago), and relevant family history (father had atrial fibrillation, mother had stroke). She observes the vital signs monitor showing an irregular heart rhythm, and the system captures this through visual analysis, specifically identifying the rhythm pattern as consistent with atrial fibrillation. The doctor and patient discuss symptoms, with the patient mentioning episodes of palpitations, shortness of breath during exercise, and occasional lightheadedness. With patient consent, the conversation is transcribed in real-time and natural language processing extracts the key symptoms and concerns.

The AI agent hierarchy activates immediately as this contextual information is gathered. At Level 1, Dr. Smith's role-based primary agent is the cardiologist AI. This agent receives all cardiac-related contexts immediately and filters out non-cardiac information from other patients she may have seen. The cardiologist AI prioritizes arrhythmia-related contexts based on Dr. Smith's specialty within cardiology, ensuring she receives the most relevant expert-level information.

At Level 2, the system detects the specific type of medical context—a cardiac rhythm abnormality—and activates the arrhythmia specialist sub-agent. This specialist agent performs detailed analysis, detecting the specific rhythm pattern from the monitor display, querying medical literature databases for similar presentations, identifying the three most likely diagnoses (atrial fibrillation, atrial flutter, and multifocal atrial tachycardia) with supporting evidence for each, and retrieving current treatment protocols for each potential diagnosis including recent updates to clinical guidelines.

At Level 3, the system recognizes that this constellation of findings represents a potentially urgent situation. The irregular rhythm combined with the patient's history of previous MI and family history of arrhythmia creates a high stroke risk. This triggers the urgent medical alert agent, which bypasses the normal context queuing and immediately surfaces critical information in Dr. Smith's field of view through her AR glasses: “Possible atrial fibrillation—patient at high stroke risk. Recommend: EKG, anticoagulation review, cardiology consult.” The alert also includes a link to recent medical literature, specifically a new study published the previous week about optimal anticoagulation strategies in post-MI atrial fibrillation patients.

Throughout this entire process, Dr. Smith has taken no photos, entered no data, and interacted with no computer systems. Her attention remains entirely focused on the patient—making eye contact, listening to symptoms, performing physical examination. The passive system and AI agent hierarchy work silently in the background, assembling comprehensive contextual information and surfacing the most critical findings at exactly the right moment.

After completing the examination and moving to the next patient, Dr. Smith continues her rounds without interruption. At the end of the day, she opens her gallery to review the patient visits. For Patient John Doe in Room 312, she finds a complete record that has been automatically assembled. The visit summary has been auto-generated, synthesizing all the information gathered during the encounter into a coherent clinical narrative. The contextual medical information includes the detected rhythm abnormality, relevant patient history, and symptom documentation. Recommended follow-ups have been automatically flagged by the AI agents, including ordering an EKG, reviewing anticoagulation therapy dosing, and scheduling a follow-up appointment. Relevant literature citations are provided with direct links, including the recent study about post-MI anticoagulation that the urgent alert agent surfaced during the visit. Draft clinical notes are ready for review and approval, formatted appropriately for entry into the electronic health record system.

This comprehensive medical documentation was assembled without Dr. Smith taking any explicit documentation actions during the appointment. She maintained focus on the patient throughout the encounter, providing attentive and compassionate care without the distraction of computer documentation. The passive system captured everything relevant, the hierarchical AI agent system routed information to appropriate specialists and flagged urgent findings, and a complete clinical record was assembled automatically for later review and finalization.

This example demonstrates the full power of integrating continuous passive context monitoring with a hierarchical AI agent system. The combination enables professionals to operate at the highest level of their expertise without being burdened by documentation tasks, while ensuring that no critical information is lost and that expert-level analysis is applied to all relevant contexts.

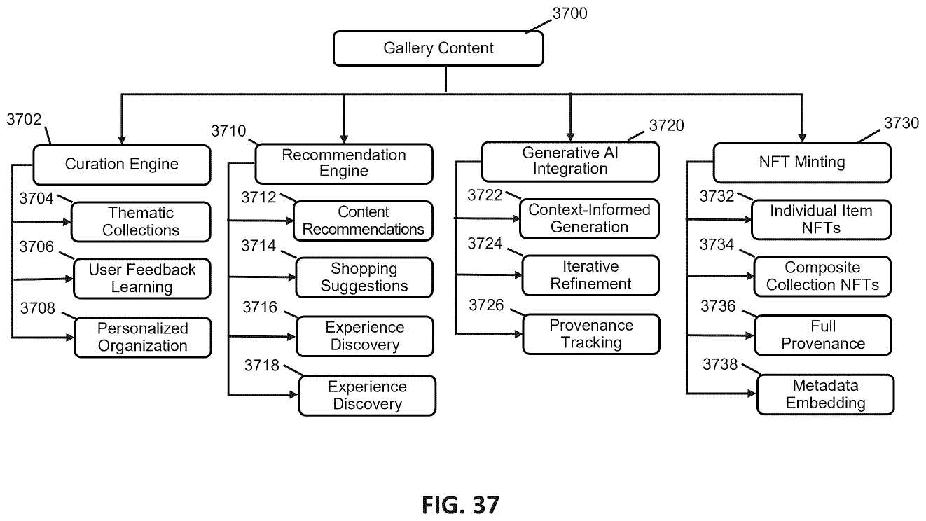

Gallery as Curation Engine. With reference to gallery content 3700 depicted in FIG. 37, beyond automatic composite creation, the gallery may actively suggest media combinations and curatorial themes based on passive context accumulation patterns. The system acts as an intelligent curator, identifying thematic collections that the user might not have consciously recognized.

Consider the example of “waffle curation.” Over a period of several months, a user accumulates various contexts related to breakfast and waffles through ordinary activities. They photograph breakfasts at different restaurants during travel and dining experiences, capture screenshots of waffle recipes while browsing cooking websites, accumulate browsing contexts from shopping for waffle irons while considering a kitchen equipment purchase, and generate location contexts from various brunch spots visited on weekends with friends.

None of these contexts were explicitly tagged or categorized by the user. They accumulated passively as byproducts of the user's normal activities. Nevertheless, the gallery's curation engine at block 3702 identifies the thematic connection through natural language processing that detects “waffle,” “breakfast,” and related terms across multiple contexts, visual similarity analysis that recognizes recurring food photography patterns, temporal patterns showing weekend breakfast-related activities, and contextual clustering of food, cooking, and dining-out contexts.

The gallery proactively proposes at block 3704 a “Breakfast Enthusiast Collection” as a suggested composite. This proposal appears in the gallery interface as a curatorial suggestion, showing representative items from the proposed collection along with a brief explanation of why these items were grouped together. The proposed curation includes all waffle-related items automatically grouped in an organized collection at block 3708, suggestions for adding other breakfast items the user encountered but perhaps didn't emphasize, information about local brunch events that align with the user's demonstrated interest, links to cooking equipment needed to make the recipes the user saved, and recommendations for breakfast-focused restaurants in the user's area that they haven't yet visited.

The user can accept the curation as-is, allowing the gallery to create the composite with all suggested inclusions. Alternatively, they can modify the curation by adding or removing items, changing the theme title, or adjusting the organizational structure. They can also reject the curation entirely if it doesn't resonate with their interests or if the thematic connection is not meaningful to them.

Importantly, the system learns from these curation acceptance or rejection decisions. If the user accepts the breakfast curation, the system learns at block 3706 that food-related thematic collections are valuable to this user and becomes more aggressive in proposing future food curations. It might later suggest collections for “Italian Cuisine Exploration” or “Coffee Culture” based on similarly accumulated contexts. Conversely, if the user rejects the breakfast curation, the system learns at block 3706 to wait for stronger signals before proposing food-related curations, requiring more explicit user engagement or a larger collection of related items before making suggestions.

This machine learning refinement ensures that the curation engine becomes increasingly personalized over time, learning each user's preferences for how they want their information organized and what types of thematic connections they find valuable. Some users might appreciate fine-grained topical curations, while others prefer broader categorical organization. The system adapts to individual preferences through observation and feedback at block 2706.

Gallery as Recommendation Engine. The gallery leverages its comprehensive knowledge of user interests, demonstrated through accumulated contexts, to provide recommendations across multiple domains via a recommendations engine at block 3710. These recommendations go far beyond simple “similar items” suggestions to encompass content at block 3712, shopping at block 3714, experiences at block 3716, and locations that align with the user's demonstrated interests and patterns at block 3718.

For content recommendations, the system analyzes the themes, topics, and domains represented in the user's gallery to suggest relevant media and information. A user whose gallery contains multiple architecture photos from various cities receives recommendations for architecture magazines covering contemporary design trends, documentary films about famous architects and their works, museum exhibitions featuring architectural drawings or models, and books about architectural history and theory. Similarly, a user who has accumulated contexts about sustainable living through browsing history, product purchases, and location visits receives recommendations for environmental blogs and podcasts, sustainability-focused documentaries, academic papers on environmental science, and local environmental organizations and events.

For shopping recommendations, the gallery identifies products and styles that align with the user's demonstrated preferences. A user whose gallery shows interest in minimalist design through saved images, visited stores, and browsed websites receives recommendations for minimalist furniture with clean lines and neutral colors, clothing brands that emphasize simple, timeless pieces, home goods that embody minimalist aesthetic principles, and design services that specialize in minimalist interiors. The system goes beyond simple product matching to understand aesthetic principles and lifestyle preferences, enabling recommendations that align with the user's values rather than just their past purchases.

For experience recommendations, the gallery suggests activities, events, and opportunities that match the user's interests. A user with contexts from multiple jazz clubs in their gallery receives recommendations for upcoming jazz festivals in their region and beyond, new jazz venues that have recently opened, educational content about jazz history and influential musicians, and opportunities to attend live jazz performances. A user who accumulates contexts about Japanese culture through restaurant visits, browsing history, and collected media receives recommendations for Japanese restaurants they haven't yet tried, cultural events such as tea ceremonies or film festivals, language learning resources for studying Japanese, and travel opportunities to Japan.

For location recommendations, the gallery suggests places to visit based on demonstrated interests and past behavior patterns. A user whose gallery shows contexts from fifteen different coffee shops across various neighborhoods receives recommendations for highly rated coffee shops they haven't yet visited, ranked by quality, atmosphere, and alignment with the user's preferences. The system might note that the user tends to prefer independent coffee shops over chains, or that they favor locations with outdoor seating, and weight recommendations accordingly. Similarly, a user with architectural contexts from a specific neighborhood receives recommendations for other neighborhoods in the city with similar architectural character, enabling discovery of new areas that match demonstrated preferences.

All of these recommendations are generated proactively based on gallery contents without requiring explicit user queries. The gallery interface might include a “Recommended for You” section that updates dynamically based on recently accumulated contexts and evolving interest patterns. Users can explore these recommendations at their leisure, treating the gallery as a personalized discovery engine that continuously finds relevant opportunities aligned with their interests.

Gallery as Generative AI Hub. The gallery serves as a rich source of context for generative AI applications via context-informed generation at block 3722, enabling users to leverage their accumulated contextual information to create new content, gain insights, and accomplish tasks that would be difficult or impossible with generic AI tools lacking personalized context.

Consider a scenario where a user is creating a marketing presentation for their business. Over the preceding weeks, their gallery has accumulated extensive contexts through passive monitoring of their professional activities at block 3722. They have browsed competitor websites while conducting market research, generating contexts about competitor products, pricing, positioning, and messaging. They have encountered industry reports through reading and research, generating contexts about market trends, growth forecasts, and industry dynamics. They have captured product photos from various sources including their own products and competitor products. They have received customer feedback through emails and messages, generating contexts about customer needs, pain points, and satisfaction levels.

The user requests generation by telling the gallery: “Create a competitive analysis presentation using my gallery.” The system responds by identifying all relevant gallery items based on semantic analysis of the request, selecting competitor contexts, market data, product information, and customer feedback. It sends this curated contextual information to a generative AI system such as GPT-4, Claude, or other large language models, along with metadata about the user's business and presentation purpose.

The generative AI, now informed by this rich contextual dataset, produces at block 3722 a comprehensive presentation package including a complete slide deck with professional formatting and layout, sections covering market overview, competitive positioning, product comparisons, and strategic recommendations. It creates charts comparing features and pricing across competitors, with data extracted from the gallery contexts. It provides a summary of market trends identified in the industry reports encountered by the user. It offers recommendations based on the competitive landscape, informed by both competitor analysis and customer feedback. Each element of the generated presentation is linked back to the source gallery contexts, maintaining provenance via provenance tracking at block 3726 and enabling verification. The user can click on any fact or chart in the presentation and see which specific gallery contexts informed that element.

The user can iterate on the generation at block 3724 by providing additional instructions such as “Focus more on pricing comparison” or “Add a section about market entry barriers.” The system regenerates relevant sections using pricing contexts from the gallery more prominently or searches for additional gallery contexts related to barriers to entry. The original gallery items remain unchanged—each generation creates a new version while preserving the source material.

This integration with generative AI at block 3720 transforms the gallery from a passive repository into an active intelligence platform. Users can treat their gallery as a personal knowledge base that AI systems can query and leverage to produce customized outputs informed by the user's unique experiences, research, and accumulated knowledge. The combination of comprehensive passive context accumulation with powerful generative AI creates capabilities that neither system could provide independently.

Gallery as NFT Embedding Tool. Any gallery item, whether an individual context or a composite collection, can be transformed at block 3730 into a non-fungible token (NFT) that embeds all accumulated contextual information in an immutable, verifiable, tradeable digital asset. This capability enables new forms of digital ownership, provenance tracking, and value creation.

Consider a photographer who uses the system during their daily work. The photographer wears camera-enabled glasses that capture their visual field throughout the day. During a professional photo shoot, they explicitly capture two hundred plus photos as they work. Simultaneously, the system passively captures one thousand plus scene contexts representing locations considered for shots, lighting conditions evaluated, subjects encountered but not photographed, and creative decisions made throughout the session. The system logs weather data, location data, and equipment settings for every photo. All of this information accumulates in the gallery without requiring any explicit action from the photographer beyond their normal shooting process.

When the photographer reviews their work in the gallery after the shoot, they see all two hundred photos with rich contextual metadata automatically attached to each. They also see the passively captured contexts representing scenes they considered but chose not to shoot, lighting setups they tested, and the creative evolution of the session. The photographer can review not just “what I captured” but “what I saw and considered,” providing insight into their creative decision-making process.

The photographer selects the best twenty photos for their NFT collection. For each photo, they create an NFT at block 3732 that includes not just the image itself but all contextual metadata accumulated during its creation. This includes technical details such as camera settings, lens used, lighting setup, and post-processing steps. It includes contextual information about location, time of day, weather conditions, and environmental factors. It links to the “contact sheet” of other photos from the same session, showing the creative evolution. It includes passive contexts showing the photographer's decision-making process, such as alternative angles considered or lighting setups tested. The blockchain records the complete provenance at bock 3736 from the moment of capture through any subsequent processing or transfers.

When a collector purchases one of these NFTs, they receive not just an image but the entire story and context behind its creation. The NFT provides authenticity through blockchain-verified provenance from camera to sale, demonstrating that this is the original digital capture by the photographer. It includes rich metadata embedded at block 3738 that increases the value for collectors who appreciate understanding the creative process and technical execution. It maintains provenance for future resales, with the complete history of ownership recorded on the blockchain. It enables fractionalization where multiple buyers can own pieces of particularly high-value image-plus-context packages, making significant works accessible to more collectors.

The gallery NFT value proposition extends beyond individual items to composite collections created at block 3734. A photographer might create an NFT representing an entire day's shoot or an entire project, with all photos and contexts packaged as a unified work. A traveler might create an NFT representing a complete trip with all locations visited, experiences had, and insights gained. These composite NFTs represent higher-order creative works that derive value from the curation and synthesis of individual elements rather than from any single element alone.

The gallery's transformation into a multi-function intelligence hub represents the culmination of the passive contextual monitoring system. By combining comprehensive automatic context accumulation with sophisticated processing, organization, and generation capabilities, the gallery becomes far more than a storage location. It serves as a personal intelligence platform that continuously learns about the user's interests, proactively organizes information, generates recommendations and insights, enables powerful generative AI applications, and creates valuable digital assets through NFT minting. This integrated functionality creates a system whose value grows exponentially with accumulated context, creating increasing utility and defensibility over time.

As for video frames, the user can drag and drop a video frame or an entire video into the platform. The contextual search engine automatically gathers the information for the user. For example, a user may be watching a television show or streaming video content and want to identify the product that a person is wearing or displaying and order the product or save the product later in their media gallery.

According to one embodiment, the user interface application displays digital data content authored by a first entity, such as an author or publisher, in the display space. The chatbot application according to this embodiment may search in one or more digital data sources for, and retrieve, contextual information authored by one or more entities other than the first entity, for example, a third-party retailer or other author or publisher, based on the displayed digital data content authored by the first entity. In such an embodiment, the chatbot application displays the portion of the retrieved contextual information authored by the one or more entities other than the first entity as related digital data content in the location within the field of view of the displayed digital data content authored by the first entity or the display space. Further in such embodiment, the chatbot application may receive user input, responsive to the displayed portion of the retrieved contextual information authored by one or more entities other than the first entity as related digital data content. This multi-entity contextual information display system enables passive contextual data aggregation across multiple sources, wherein the user remains in the original browsing context throughout discovery and purchase of items from multiple retailers without needing to navigate to any retailer's website. The system automatically generates actionable links to third-party sources for implicit references (not explicit hyperlinks) in the first entity's content, including but not limited to: academic citations, medical definitions, product alternatives, related services, and supplementary information. These links are displayed contextually adjacent to relevant content portions and update dynamically as the user scrolls or interacts with the content.

The following description considers many use cases for the above-described embodiments. In one case, the displayed digital data content identifies a first object purchasable from a first entity, and the displayed related digital data content identifies a second object purchasable from a second entity different than the first entity. In this case, the chatbot application displays the digital data content that identifies the first object and the related digital data content that identifies the second object in an online shopping cart. The system provides cross-platform shopping integration wherein both objects may be displayed in a unified shopping cart interface, and the checkout process may handle multi-retailer transactions, and without the user visiting either retailer's website. This unified checkout enables the user to purchase products from multiple retailers in a single transaction while maintaining contextual awareness of the original content that inspired the purchases.

According to another use case, the related digital data content is a digital image in which one or more objects appear. A digital image, for example, may be a frame from a video, an animated GIF, or a moving image, in addition to, for example, an image formatted in a. jpeg file. In this use case, the chatbot application displays the digital image in the location within the field of view of the displayed digital data content or the display space, and then receives user input, responsive to the displayed digital image, to search for information about the one or more objects that appear in the displayed digital image.

In yet another use case, the related digital data content is added to, or associated with, displayed digital data content in, a file, a repository, or a location in or at which the displayed digital data content is maintained. This may occur based in part on the detected one or more user interactions with the one or more of the user interface application, the displayed digital data content, or the display space. This functionality may be performed automatically without receiving user input to perform the adding or associating. In this use case, the displayed digital data content may be a digital image comprising a plurality of pixels. The related digital data content may be added to, or associated with, one or more of the plurality of pixels in the file in which the digital image is maintained. It is also contemplated that a Non-Fungible Token (NFT) engine adds an NFT layer to the digital image, thereby creating an NFT file comprising the digital image, based on the related digital data content added to or associated with the one or more of the plurality of pixels in the file in which the digital image is maintained. The NFT creation may be triggered automatically upon context embedding, user-initiated, upon first sale, or upon reaching a threshold of context richness. The NFT token comprises or cryptographically commits to both the media content and contextual information, ensuring token authenticity verifies both media and context integrity. The NFT includes within its structure one or more of: the image itself, all contextual metadata, ownership history, license terms, and smart contract functionality for automated royalty distribution and provenance tracking.

In another use case, adding the related digital data content to, or associating the related digital data content with, a file, a repository, or a location in or at which the displayed digital data content is maintained, involves adding the related digital data content to, or associating the related digital data content with, a location in a distributed digital ledger at which the displayed digital data content is maintained, or to a location chained to the location in the distributed digital ledger at which the displayed digital data content is maintained. The distributed digital ledger may comprise blockchain, hashgraph, directed acyclic graph (DAG), distributed ledger technology (DLT), or any technology providing cryptographically verified immutable distributed records. The ledger may be public, private, consortium, or hybrid, selected based on use case privacy and performance requirements. The storage technology provides cryptographic proof of data integrity, resistance to tampering, and ability for third parties to verify authenticity of stored contextual information, distinguishing from mutable centralized storage. Cryptographic methods employed may be upgraded to quantum-resistant algorithms or future cryptographic advances without altering the fundamental immutable distributed ledger architecture.

In this use case, the related digital data content may be a digital image in which one or more objects appear, in which case adding the related digital data content to, or associating the related digital data content with, the location in the distributed digital ledger at which the displayed digital data content is maintained, or to the location chained to the location in the distributed digital ledger at which the displayed digital data content is maintained, involves adding the digital image to, or associating the digital image with, the location in the distributed digital ledger at which the displayed digital data content is maintained, or to the location chained to the location in the distributed digital ledger at which the displayed digital data content is maintained. In this case, the chatbot application may receive user input, responsive to the displayed digital image, to search for information about the one or more objects that appear in the displayed digital image, and search the location in the distributed digital ledger at which the displayed digital data content is maintained, or to the location chained to the location in the distributed digital ledger at which the displayed digital data content is maintained, for information about the one or more objects added to or associated with the displayed digital content.

Alternatively, in this use case, the related digital data content may be a digital image in which one or more objects appear, in which case, adding the related digital data content to, or associating the related digital data content with, the location in the distributed digital ledger at which the displayed digital data content is maintained, or to the location chained to the location in the distributed digital ledger at which the displayed digital data content is maintained, involves adding the digital image to, or associating the digital image with, the location in the distributed digital ledger at which the displayed digital data content is maintained, or to the location chained to the location in the distributed digital ledger at which the displayed digital data content is maintained. A machine learning application may access the information about the one or more objects that appear in the related digital data content added to or associated with the location in the distributed digital ledger at which the displayed digital data content is maintained, or to the location chained to the location in the distributed digital ledger at which the displayed digital data content is maintained, and train on the information about the one or more objects.

### Detailed Description of Specific Embodiments

Embodiments of the invention operate on digital data content, or simply, content, displayed in a display space. For example, the content (e.g., a webpage, a video, a light field display projected in augmented reality (AR) glasses, a. jpeg image, a document, a spreadsheet, emails, etc.,) may be displayed in a particular space (e.g., a display screen, a display window, a browser window, a browser tab, or a light field display space). Relevant or contextual information is searched for and retrieved, obtained or extracted, from one or more digital data sources (e.g., hyperlinks, metadata, microdata, search results, advertising, product databases, etc.,) based on the displayed content. The contextual information is then displayed automatically as related digital data content in a location viewable in the display space. All of this happens without receiving user input to perform such functions. The display space may comprise any medium through which digital information is rendered perceivable to a user through any sensory modality, including but not limited to: traditional displays (screens, windows, browser windows, browser tabs), advanced display technologies (retinal projection displays, holographic displays, volumetric displays, e-ink displays, projected displays using surfaces as screens), spatial computing displays (light field displays in AR/VR/MR environments, 3D spatial coordinates), non-visual displays (haptic displays providing tactile information, audio-only displays for screen readers and voice interfaces), neural interfaces (brain-computer displays), and future display technologies. The digital data content may comprise any digital information in any format rendered through any interface, including but not limited to: traditional media (webpages, videos, images, documents, spreadsheets, emails), data streams (real-time sensor feeds, notification streams, communication threads), mixed reality content (virtual objects in physical space, spatial overlays), application interfaces (any app interface, operating system interfaces, home screens, settings), and future content modalities.

According to an embodiment, the extracted contextual information is filtered, for example, based on a user's interactions with a user interface, the displayed digital data content, or the display space, so a portion of the extracted contextual information is displayed as related digital data content in the display space. The related content may be displayed in an e-commerce shopping cart or an online checkout system or may overlay or be embedded within the displayed content. According to embodiments, the displayed contextual information is filtered or selected at least in part based on a user's interactions with the displayed content (e.g., scrolling to, stopping at, resizing or moving, or paging through, the content in the display space), or by tracking movement of the user, for example, tracking the user's eye movement or the user's gaze point within the display space.

According to one embodiment, the displayed content includes or identifies a first object or item purchasable from a first entity, and the related content includes or identifies a second object or item purchasable from a second entity The two objects or items may then be combined into a unified online checkout system or shopping cart, as further described below in one example use case.

The contextual information is searched for and retrieved, i.e., extracted, from a network of data storage devices (e.g., the internet or World Wide Web or cloud-based storage devices) that stores the contextual information and to which the user's local computing device is connected in communication. A local-or web-or cloud-based software widget can extract the contextual information during the displaying of the digital data content in the display space. A software widget is a relatively simple and easy-to-use software application or component made for one or more different software platforms. A desk accessory or applet is an example of a simple, stand-alone user interface, in contrast with a more complex application such as a spreadsheet or word processor. These widgets are typical examples of transient and auxiliary applications that don't monopolize or draw the user's attention. The software widget may be deployed as: an embedded web widget, browser extension, application plugin, operating system service, remote application accessed via network, or a combination thereof. The widget operates as a software component integrated with the user's content viewing interface through any deployment method. Processing may be divided between client device and remote servers, performed entirely on client device, or performed entirely on remote servers, based on device capabilities, network availability, and privacy preferences. The system can increase or decrease functionality gracefully, providing basic functionality when network is unavailable and enhanced functionality when remote services are accessible.

According to embodiments, the portion of the extracted contextual information that is added to, or associated with, the displayed digital data content as the displayed content is being displayed can also be saved to a file or a repository or a location in or at which the displayed content is maintained, based in part on the user's interaction with the user interface, the displayed content, or the display space. For example, the extracted contextual information added or associated as related content to the location at which the displayed content is maintained may be automatically added or associated as related content to the location in a distributed digital ledger (i.e., a blockchain) at which the displayed content is maintained, or to a location chained to the location in the distributed digital ledger at which the displayed content is maintained. One object of embodiments of the invention is to be able to later search for the contextual information stored in the blockchain.

According to some embodiments, the displayed content is an image comprising a plurality of pixels. According to the embodiments, automatically adding or associating the portion of the extracted contextual information as related content to or with the displayed content to the file or the repository or the location in or at which the displayed content is maintained, involves adding the portion of the extracted information as related content in one or more pixels of the image. According to the embodiments, the pixels of the image in which the portion of the extracted information is added as related content may be used by a non-fungible token minting engine to add an NFT layer to the image, thereby creating an NFT file comprising the image, as further described below. Embedding contextual information in pixels may be accomplished through one or more technical methods including but not limited to: steganographic embedding (data hidden in imperceptible alterations to pixel values using techniques providing robustness against compression, resizing, and format conversion); metadata field embedding (population of EXIF, IPTC, XMP standard fields); wrapper file embedding (file contains media plus context as separate streams); blockchain pointer embedding (hash or cryptographic pointer in file to blockchain record); sidecar file embedding (separate file with cryptographic link to main media); or NFT smart contract embedding (context embedded in contract code). The embedding ensures contextual information remains accessible even when a media file is transferred, copied, or moved to systems without network connectivity, distinguishing from external linking approaches dependent on network-accessible databases. Embedded contextual information includes cryptographic hash or digital signature enabling verification that context has not been altered since embedding.

Embodiments of the invention contemplate the use of a chatbot or the like. A chatbot, or chatterbot, is a software application used to conduct an on-line chat conversation via text, text-to-speech, or voice interactions, in lieu of providing direct contact with a live human agent. A chatbot is a type of software application that can help users (customers) by automating conversations and interacting with them through a messaging platform. The chatbot or similar software component is more broadly defined as an automated information assistant, conversational interface application, AI-powered information retrieval agent, intelligent contextual assistant, or automated query response system—a software application that automatically retrieves and presents contextual information, whether through conversational interface, direct information display without conversation, proactive notifications, ambient information presentation, or any combination thereof. The system presents contextual information through conversational exchange, direct information display without conversation, proactive notifications, or ambient information presentation. The application operates proactively to surface contextual information without requiring a user to formulate queries, distinguishing from reactive chatbot systems that respond only to explicit user questions or input. For example, a user may be scrolling through a webpage, a media file, or interacting in a mixed reality setting via augmented reality/virtual reality (AR/VR) glasses. According to the embodiments, a user does not have to leave his/her focus on a particular webpage to open another tab or window to search for relevant information or buy a product from a retailer through a hyperlink. Instead, contextually relevant information surfaces (i.e., is displayed) automatically, in response to a webpage's content or in response to the mixed reality setting. The chatbot software surfaces (i.e., displays) connected (i.e., related, relevant, contextual) information while the user discovers the page's content: e.g., a product is mentioned in an article, e.g., through a link, and is generated by the chatbot simultaneously in a cart. Alternatively, links can be automatically generated in response to references to related information within the webpage contents. For example, references to documents, journal articles, patents, books, etc., can be quickly linked and referenced with other related content within a chatbot window overlaid on the webpage or display device. For example, a definition for a medical term being referenced in a webpage can automatically be provided in a pop-up window or the cart with other items, such as articles and texts related to the webpage and/or the medical term. These items, whether fashion products or academic journals—when monetizable—can be checked out within a multi-retail unified checkout system, as further described below.

According to the embodiment described above with reference to FIGS. 21 and 22, the intent to “know more” is relevant for the chosen media or digital image: who is the owner or creator of the “media,” why is it relevant, where is it located, etc. The drag and drop of a digital image from the user interface application 2100 into a “search” or “chatbot like” window 2103 refers to the chatbot's contextual search method which uses the scraper to initially traverse a Document Object Model (DOM) tree and crawl hyperlinks on the given webpage. The filtered information is generated in the chatbot, based on various contextual categories, and further filtered as the user engages with the chatbot and the AI language processing. Computer vision may be used to further define the selected media. Finally, the media may have assigned saved information within a database (such as its content creator) that is weighed into the chatbot query answer.

The chatbot may search within the user's media gallery 2102. The user may type in a command and prompts to search through the media gallery, for example, by name, date, or description. The user may also describe the media, to which the chatbot responds with matches closely related to the media as described.

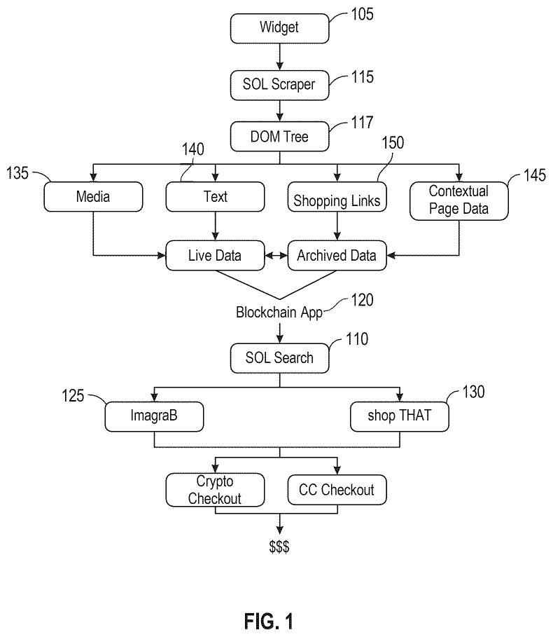

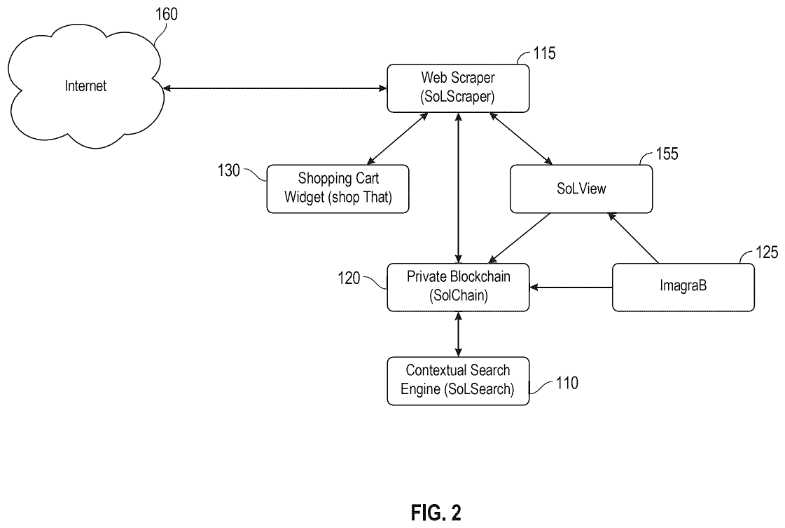

In this example, with reference to FIGS. 1 and 2, a chatbot, or a widget 105 associated with the chatbot, may be deployed during the loading of an author's or a publisher's webpage, and instantaneously scan the page for relevant contextual information, from keywords to metadata to links. Unlike a search engine, such as Google, which indexes uniform resource locators (URLs) prior to retrieving search results, a contextual search engine 110 (termed “search engine”, or simply, “SoLSearch”, as in, “Speed of Light Search”, herein) associated with the chatbot can work without any prior indexing of URLs (although archived URLs may be used if relevant). The contextual search engine SoLSearch 110 is frictionless, based on real-time interactions of the user and leverages the contextual ecosystem or environment of the web page as a jumping-off point for scraping and crawling, via a web scraper 115, the internet or world wide web 160 for related content.

The search engine SoLSearch 110 differs from prior art contextual, metadata, or general search engines. The prior art search engines are always activated by a user's query, i.e., in response to user input to perform a search. Other contextual search engines use spiders ahead of time to crawl through the contents of websites and may be able to parse a webpage's text, crawl a webpage's links, and retrieve and scrape additional links from a separate database. The search engine SoLSearch 110 according to embodiments of the invention is the antithesis of prior art general search engines in use today. The search engine SoLSearch 110 anticipates (and may even render moot) a user's query for contextual information based on the content in which the user is currently immersed before any user query is made. The webpage's contextual data, once extracted, can be further tailored to the user's interactions, e.g., the user's scrolling behavior or eye-gaze patterns, on that page. All the contextual data may be extracted, parsed, structured and displayed before the user has even engaged in a search query or automatically, without the user ever engaging a search query or taking or needing to take any affirmative steps to initiate the contextual search process. The search engine according to the disclosed embodiments operates in reverse causal direction compared to traditional search engines: content analysis determines information needs rather than user query determining search targets. The system generates comprehensive contextual information without ever receiving a user-formulated search query, distinguishing from search engines that optionally predict queries but still require query input. The system generates predicted search queries based on content analysis and user behavior patterns, wherein said predicted queries are used internally for information retrieval without being presented to user for confirmation or modification. Predicted information needs result in automatic retrieval of corresponding information, not merely presentation of suggested search queries that a user could optionally execute.

As the contextual search query (as opposed to a user's query) begins, data can be filtered, i.e., further narrowed down, for example, based on a user's query. The user's query, however, is not necessary to fill either a shopping cart 130 or to inform the contextual search input. Rather, a “smartcart” automatically extracts any related information, e.g., product information, on the page, and the chatbot anticipates topics of inquiry, from shopping to geo-locative interests, without any input from the user.

In this manner, the search engine SoLSearch 110 can be thought of as a “reverse” search engine on three fronts: 1) it apprehends, or perceives, or predicts a user's query based on contextual information obtained from the page rather than the user's browsing history, 2) the search engine does not need a user query at all since the digital data content is enough to generate areas of search, and 3) the search engine's input, a webpage or the digital data content displayed on the webpage, for instance, would be considered the “output” of traditional search engines. The search engine's output on the other hand, according to the disclosed embodiments, could be simplified into a sentence, an image or a product, similar to what is input in a typical search engine's search bar.

Although the search engine SoLSearch 110 may be more restricted in its reach than a prior art search engine which may rely on historic indexing, the definition of “context” according to embodiments of the invention is infinite: a webpage, a spatial setting (as seen through a car window, a heads-up display, or AR/VR eyeglasses), digital media 135 (bitmap objects such as videos, images, audio files), or text 140 (textual objects such as word processing documents, spreadsheets, emails, etc.). Context, rather than being defined by its medium, is defined herein by the user's real time engagement via a user interface, a web interface, field of view, eye movement, hand movement, voice and/or hearing, or an overlay or combination of one or more of each. It is the nature of the user's real time interaction or engagement that defines the hierarchy of the search query results, rather than the other way around.

One benefit of the search engine SoLSearch 110 is that it is not reliant on the user's data to return precise contextual answers. A user may choose to share their browsing data in the cart, for example, based on shopping incentives such as cryptocurrency credits.

However, the search engine SoLSearch's results are not dependent on the user's prior searches, nor their browsing history, nor any other digital information gathered about the user. In fact, when used on an author's or publisher's website, the search engine SoLSearch 110 may not have any data about a user visiting the author's or publisher's website for the first time, or successive times where the user may be a guest and not log in or provide account information. Most of the search output is “personalized” or temporal in the sense that it is based on the contextual information associated with the webpage and in response to the user's current behavior on or interactions with that page. For example, if the user browses through a display of a pair of women's sandals for a few seconds in the shopping cart 130, the search engine SoLSearch 110 may infer that the women's sandals may be contextually relevant with keywords such as “dresses” and the title of an article “what to wear this summer.” This contextual data yields highly personalized search results, without compromising a user's data privacy.

Moreover, unlike prior art search engines, the search engine SoLSearch 110 does not algorithmically weigh the order of its search results against advertising hits, such as with search keywords and Adwords. These algorithms have over time contaminated the page ranking and preciseness of search results.

The starting point of the contextual search, according to embodiments of the invention, is a visual medium or user interface, e.g., a video, a field of view in AR glasses, or a simple jpeg image. It is that visual context which initiates the search engine SoLSearch's searching efforts to capture related information. The related information may be displayed, for example, overlaid onto a video, embedded within an image or an extended range (XR) file, or simply embedded in an entire webpage. According to embodiments, the contextual information can be embedded in the file that contains the displayed information, for example, embedded in a media file that contains the displayed image. This embedding can be done over a period of time, both using “real-time” data sourcing relevant archived data, or even relevant APIs. The embedding of contextual information is accomplished through one or more technical approaches ensuring the context persistently travels with the media. Embedding methods include: steganographic embedding wherein data is hidden in imperceptible alterations to pixel values using techniques providing robustness against compression, resizing, and format conversion; metadata field embedding through population of standard fields (EXIF, IPTC, XMP); wrapper file embedding where the file contains media plus context as separate streams; blockchain pointer embedding with hash or cryptographic pointer in file to blockchain record; sidecar file embedding with separate file cryptographically linked to main media; and NFT smart contract embedding with context in contract code. The embedding ensures contextual information remains accessible even when media file is transferred, copied, or moved to systems without network connectivity, distinguishing from external linking approaches dependent on network-accessible databases. The system combines real-time context (current state of external data sources), archived context (historical data about same or similar media), and predictive context (anticipated future states based on trends) into a unified contextual presentation without temporal seams, with the system indicating freshness or staleness of different context elements.

For instance, related content, such as real-time geo-location and computer vision metadata, may be embedded in a media file that contains the image. As another example, an image could be extracted based on an article displayed on a webpage with surrounding contextual information, such as shopping links and valuable text. That information can then be encased, via a blockchain, such as the SoLChain blockchain 120 discussed below, for both spontaneous user interaction, if the user wants to “search” for products in the image, and for future use in machine learning (ML) training around products, etc.

According to embodiments, contextual information may be embedded in or on a media property each time it is published online and provide a contextual record of that media, related interactions and/or conversions. For example, one or more pixels of a media property may be used to store contextual information. This data has value, outside of an additional value proposition via ImagraB 125 (as discussed further below), for example, to convert and sell the media as a non-fungible token (NFT). The system maintains context versioning and evolution, so that when contextual information about media changes over time, the system maintains version history of context, enabling users to view “context as of [date]”. Examples include product price history, article revision tracking, and location changes over time. Blockchain storage may be used to ensure immutable context version history, and machine learning models may be trained on context evolution patterns to predict future context changes and identify trends.

Beyond creating a new media/NFT file and metadata standard, embodiments of the invention for interconnecting siloed data can also be used as a standalone browser, reversible from one search/recommendation engine to another, e.g., an embedded audio stream in a .jpeg file can both generate a recommendation for additional audio files and/or .jpeg files, based on overlapping metadata, data clusters, etc. As NFTs in Web 3.0 are exportable and live in a third-party wallet, this allows each NFT to become a contextual search engine/browser of its own.

There are three alternative economic models that may be derived from the search engine SoLSearch's 110 contextual search mechanisms, as described below. None of these business models affect the quality of the search results or the mechanism of the search itself.

shopTHAT: a cart 130 for extracted products with a virtual assistant to remove shopping friction, enhance contextual product search and simplify checkout, as discussed more fully below.

Astarte: an advertising retargeting platform for products browsed in the cart 130 (to replace third party cookies which are being phased out due to privacy laws). Browsed products can be retargeted on the same page or within the same publisher. This platform synchronizes into existing ad exchanges.

SoLView 155 and ImagraB 125: monetization of digital assets through SoLView, contextual data encasing, for example, in a blockchain, using SolChain 120, geo-locative information, shopping links and more. Any of these media assets can be transacted as NFTs via ImagraB 125.

FIGS. 1 and 2 illustrate functional block diagrams of embodiments of the invention which include a web scraper 115, termed SoL (Speed of Light) Scraper. Web scraping, web harvesting, or web data extraction is data scraping used for extracting data from websites. Web scraping software such as SoLScraper may directly access the World Wide Web using the HyperText Transfer Protocol (HTTP) or a web browser. Most prior art scrapers today are used to extract information which is stored (such as in a web index with keywords) or to monitor competitors. SoLScraper 115, in contrast, is used for real-time contextual information extraction, and then assigns the extracted contextual information to various databases: media 135, text 140, shopping links 150 and contextual page data 145, e.g., metadata. According to some embodiments, this contextual information is first structured into silos, and then remains available to create various data overlays, based on real time browsing and archived data. The SoLScraper operates with quantitatively defined real-time performance: an initial scrape can occur in less than 500 milliseconds from page load, a deep scrape may provide comprehensive context in less than 2 seconds, and continuous scraping can monitor page changes with less than 100 milliseconds detection latency. This real-time operation is characterized by latency between content display and contextual information availability being imperceptible to user, for example, less than 1 second for initial context and less than 5 seconds for comprehensive context. The scraper may operate on-demand for currently viewed content without requiring prior indexing, enabling contextual information retrieval for content never before encountered by system. The scraper may perform parallel retrieval operations for multiple related resources simultaneously (main page content, all hyperlinked pages through multiple simultaneous connections, API endpoints referenced in page, embedded resources with extractable metadata, and related pages from social media and review sites), reducing total latency through concurrent processing.

SoLScraper 115, according to embodiments, is fast enough to, for example, scan both a publisher page in real time, along with valuable hyperlinks (for information or shopping). The scraper can execute JavaScript, monitor DOM mutations, detect AJAX-loaded content, and extract contextual information from dynamically rendered elements not present in initial HTML source. The scraper can operate on-demand for arbitrary content not limited to pre-indexed or cached sources, enabling contextual information retrieval for newly published content, user-generated content, and long-tail content not previously encountered.

According to one embodiment, SoLScraper 115 extracts products for a shopping cart 130, termed herein shopTHAT, as described below.

As illustrated in FIG. 1, SoLScraper 115 fetches web page content and parses it into a document object model (DOM) placed in a DOM tree 117. This allows simple cascading stylesheet (CSS) selectors to be used to find related content for extraction. SoLScraper 115 has numerous rules defined to extract data from different web pages, e.g., to get a product title from a ‘span’ tag with id ‘product-name’. Optionally, rules may apply to specific websites. After which a scoring approach may be used to score confidence of matches. This rule-based approach has the advantages of being fast and lightweight but involves manually tuning rules to websites and maintaining the rules.

After applying the rule-based approach, SoLScraper 115 can use natural language processing (NLP) techniques. Embodiments of the invention contemplate using off-the-shelf methods, for example, available from Natural.js, on the web page content. Content is then tokenized and transformed. Then techniques are applied to extract data, such as nearest neighbor analysis and sentiment analysis.

According to embodiments, a Conditional Random Field (CRF) model is trained on the tokenized document content. The CRF approach can be integrated and implemented within SoLScraper 115 as an alternative or backup to the NLP and rule-based approaches, with the goal being to use the fastest extraction approaches first.

The blockchain protocol was first introduced in 1982 in David Chaum's dissertation “Computer Systems Established, Maintained, and Trusted by Mutually Suspicious Group.” Blockchain became popularized through the white paper published by Satoshi Nakamoto in 2008 called “Bitcoin: A Peer-to-Peer Electronic Cash System.” In 2009, Bitcoin became the first cryptocurrency using blockchain technology. Since then, blockchain technology has grown by leaps and bounds. There are at least 1000 blockchains that exist today—most known, some are not known. A blockchain is a distributed decentralized digital ledger of transactions. The database is managed autonomously through peer-to-peer distributed time-stamping networks. Each transaction that is verified by the blockchain network is timestamped and embedded to a block of transactions. Each block is cryptographically secured by a hash process that links to and incorporates a hash of the previous block, and then it is joined in a chain in chronological order. In order for each block to be created, time-stamping schemes such as proof-of-work or proof-of-stake is incorporated to the system to ensure that no single node serializes the changes. If data in the block was tampered with, the blockchain breaks and can be easily identified. This characteristic is not found in traditional databases where information is constantly being modified and deleted with ease. This is the traditional structure of a blockchain and its use. The distributed ledger technology employed may comprise blockchain, hashgraph, directed acyclic graph (DAG), distributed ledger technology (DLT), or any technology providing cryptographically verified immutable distributed records. The distributed ledger may be public, private, consortium, or hybrid, selected based on use case privacy and performance requirements. The storage technology provides cryptographic proof of data integrity, resistance to tampering, and ability for third parties to verify authenticity of stored contextual information, distinguishing from mutable centralized storage that lacks verifiable integrity. Cryptographic methods employed may be upgraded to quantum-resistant algorithms or future cryptographic advances without altering fundamental immutable distributed ledger architecture.

Blockchain's immutability and decentralization provides integrity of its data. This brings an unprecedented level of trust to the data, proving to users that the information presented has not been tampered with, while transforming audit processes into an efficient, sensible, and cost-effective procedure. Blockchain's benefits means that there is complete data integrity, simplified auditing, increased efficiency, and proof of fault. Thus, blockchain technology is ideal for embodiments of the invention.

A description of the cart 130 termed herein as ShopThat, mentioned above as one of three alternative economic models that may be derived from the search engine SoLSearch's 110 contextual search mechanisms, follows.

Platform Overview. According to embodiments of the invention, the shopTHAT cart 130 fundamentally changes the backend of e-commerce for content creators. Integrating content (article, videos, podcasts etc.) with Product Catalog APIs-the industry standard-is a slow, manual, and retroactive process to populate a shopping cart. As mentioned above, according to embodiments, real time contextual information can dictate and automate a shopping cart, instead of a content creator having to match their content to available products in a marketplace.

Today most publishers revert to affiliate marketplaces or product catalogs to populate a static shopping cart. The availability of products in affiliate marketplaces and product catalogs dictates the very content that journalists produce. Content creators should be able to publish content on the fly and, simultaneously, link any website's product page relevant to that content. Over time if that product becomes out of stock or expired, the shopTHAT cart 130 replaces it with a related product based on its contextual search algorithms. Placing a product link in an article should be the extent of any publisher's ecommerce backend foray. There is no marketplace and no product catalog a content creator needs to integrate with using the shopTHAT cart.

Content, for example, an article, is the context by which the shopTHAT cart 130 is activated. While individual retailers APIs may be used for checkout purposes, according to other embodiments, e-commerce platforms (demandware, woocommerce etc.) can broaden checkouts from individual retail platforms to platform wide checkouts such as Shopify. Alternatively, retailers are also integrated with third party wallets such as Google Pay and Apple Pay, in which extracted product information can be rerouted to via SoLScraper's 115 real time scraper mechanism, discussed above.

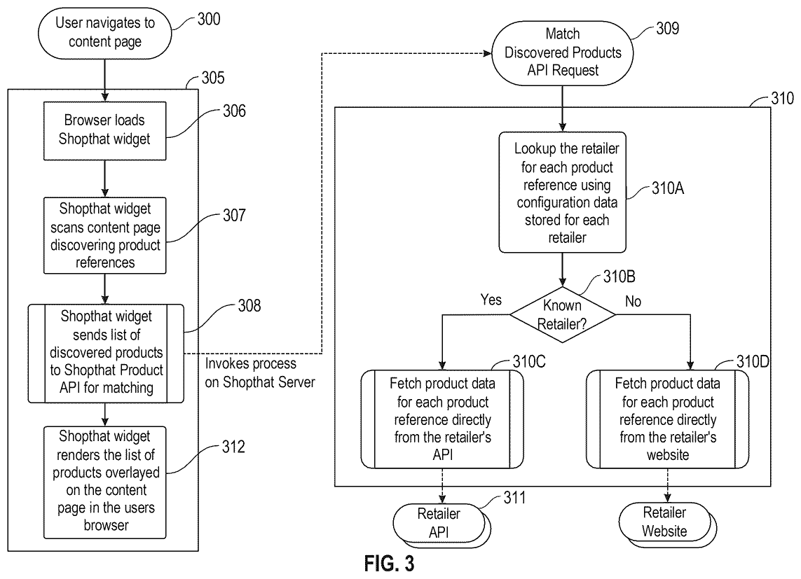

Checkout (or not) may be a multiple step integration over time. Embodiments may not check out products but still feature them in the cart and use them as part of the contextual search engine SoLSearch 110. With reference to FIGS. 3-7, the shopTHAT cart 130 has three components, each of which is described more fully below. These components are described structurally but the system achieves functional objectives through any architectural approach, whether using two components, five components, monolithic architecture, or distributed microservices. The essential functions comprise: a component for detecting product references in displayed content; a component for retrieving detailed product information; and a component for facilitating multi-retailer purchases. The software component may be integrated with a user's content viewing interface through any deployment method including embedded widget, browser extension, application plugin, operating system service, remote application accessed via network, or combinations thereof. Processing may be divided between client device and remote servers, performed entirely on client device, or performed entirely on remote servers, based on device capabilities, network availability, and privacy preferences, with the system increasing or decreasing functionality gracefully, for example, to provide basic functionality when network unavailable and enhanced functionality when remote services accessible:
ShopThat Widget 305—An embeddable web widget which, among other functionality it provides, deploys SoLScraper 115 and triggers the SoLSearch contextual search engine 110;
ShopThat Product extraction API 310—A real-time retail product extraction via retailer API or SoLScaper 115 scraping;
ShopThat Order API 415—A directly integrated multi-retailer product checkout system, via retail API, retail platform API or third-party wallet.

The ShopThat Widget 305 is a small Javascript web application which resides on ShopThat servers, and embedded into partnered content websites via hyperlinking, according to embodiments of the invention. The ShopThat Widget provides all interaction with general consumers, rendering the ShopThat user interface on top of the content website. The ShopThat Widget performs the collection of possible product URLs from the content website and all communications with the ShopThat APIs. The ShopThat Widget provides the following signifcant areas of functionality:
Product URL discovery;
Displaying shopping cart based on matched products;
Displaying checkout experience based on products selected in the cart;
Displaying additional products which are related to the products in the shopping cart;
Displaying reviews for products available in the shopping cart and related products; and
Displaying product searching capabilities.

With reference to the embodiment described above with reference to FIGS. 21 and 22, the intent to buy is predominant over the rest of the information associated with selected digital images and the shopping cart should yield shopping information either embedded in the media via an internal product link database, through hyperlinks and other contextual information (field of view, web pages, etc.) or other external databases.

The user can drag a digital image from the media gallery into a shopping cart, such as the shopTHAT shopping cart 130 described herein. Relevant information from the blockchain then automatically populates the shopTHAT shopping cart (e.g., image (thumbnail of media type), name, quantity, amount, SKU, description, etc.) The cart in turn automatically updates the pricing subtotal/total. The user may also adjust the quantity in the shopping cart. If a specific product is not identified via hyperlink, an embodiment may assign a contextually relevant product to the digital image. The user may remove a digital image and drag the digital image back to the media gallery for later purchase. This, in turn, reverts the cart information and removes the subtotal/total.

For “image licensing” or “NFT” purposes a user may buy the “image” as a collectible, buy the rights to the images or buy a fraction of the image, all via a blockchain database.

The media gallery interacts with the shopTHAT shopping cart 130 in the following manner, according to an embodiment. Javascript code or the like is placed into a client website (i.e., art gallery website, shopping site, fashion websites, etc.) to activate the shopTHAT shopping cart. This layer sits on top of the web page as its own interactive layer. The Javascript code allows the client site to communicate with the shopTHAT shopping cart server, private blockchain server, shopTHAT chatbot server, and payment processing system. This encrypted communication allows for frictionless transaction(s) for the user.

The shopping cart may also have an extended feature/functionality that allows users to drag any media from the client's webpage into the user's media gallery 2102 as discussed above. The media gallery allows users to save their favorite media for possible future purchase through the shopTHAT shopping cart checkout system.

The media gallery can have live up-to-date information. If an item that is in the media gallery 2102 is purchased by another user, the user with that media may be notified via various forms of communication, and the media is grayed out in the user's media gallery. If there are multiple copies of the media or items available for sale, the user's media gallery may also notify the user that there is a limited amount left (e.g., three remaining items). This allows users to make an informed decision to purchase the item or not.

The ShopThat Product extraction API 310 is a HTTP REST API which is hosted on ShopThat servers, according to embodiments of the invention. This API is invoked and used by the ShopThat Widget 305 to get information about products. This API is responsible for:
Providing product data matched to discovered products;
Interacting with directly integrated partner retailer's product APIs;
Interacting with SoLScraper 115 functions which can extract product data from web pages in real-time;
Collecting and storing metadata about discovered product URL relationships, for the purpose of recommending related products;
Providing product data for products which are related to given product URLs; and
Providing product review data for product reviews related to a given product URL.

The ShopThat Order API 415 is a HTTP REST API which is hosted on the ShopThat servers, according to embodiments of the invention. This API is invoked and used by the ShopThat Widget 305 to transact the purchase of products across multiple retailers. This API is responsible for:
Taking initial and complete order requests;
Interacting directly with partner retailer's order systems; and
Allowing a consumer to purchase one product from a single retailer or multiple products from multiple retailers.

FIG. 3 is a flowchart of a product discovery process according to embodiments of the invention. The consumer accesses the ShopThat platform by opening (navigating) to a digital data content page hosted on a partnered Content Creator's website at block 300. When the consumer navigates to a content page in their browser the ShopThat widget 305 which has been integrated into the content page by the Content Creator is loaded and starts executing within the consumer's browser at block 306.

Once the ShopThat widget 305 is executing, it first starts trying to discover any product references on the content page within the browser at block 307, without receiving any user input to perform such discovery. All code and processes here are executed within the browser's Javascript runtime environment, according to an embodiment. The ShopThat widget scans the browsers internal in-memory representation of the content page by traversing the Document Object Model (DOM). The DOM is traversed and prefiltered into an intermediate data structure.

Next, as part of block 307, the ShopThat widget loads a pre-trained Machine Learning (ML) statistical model and uses this to classify and extract product references that exist within the content page. These product references mainly consist of Uniform Resource Locators (URLs) which hyperlink to the product on a retailer website. The product references also include information about the position in the DOM and on the screen of the product, as well as any additional metadata that the ML model has been able to extract and classify.

The ShopThat widget next calls at block 309 the ShopThat Product extraction API service 310 which is part of the ShopThat platform 130 hosted on ShopThat's server infrastructure. The widget passes at block 308 the list of discovered product references to this API. The ShopThat Product extraction API 310 attempts to match each discovered product reference to a product from a partnered retailer according to the steps described in blocks 310A-310D.

Firstly, an attempt is made to match the discovered product reference to a retailer at block 310A using configuration data and pattern matching that the ShopThat platform 130 stored about each partnered retailer. This translates the discovered product reference into a retailer from which the product can be purchased. If a partner retailer is found at block 310A, a decision is made at block 310B for the ShopThat Product API 310 to directly call at block 310C the retailer's integration API 311 to retrieve the detailed information for the discovered product reference. If a partner retailer is not found at block 310A, a decision is made at block 310B for the ShopThat Product API to use a website scraper to connect to the product URL and attempt to extract machine readable product data in real time from the product web page at block 310D.

This results in data about the product being associated with the discovered product reference and is returned to the ShopThat widget 305. The ShopThat widget now has all information about the products referenced by the content page to be able to display such related information as it wishes at block 312. Though the ShopThat cart 130 may have all the product information within milliseconds of the page loading, the products are only generated in the cart when they have been discovered by the user, whether it is a product link or a product reference in the text, in audio, or in display glasses, etc.

The ShopThat widget 305 according to an embodiment uses this data to render a typical shopping basket cart graphical user interface. According to embodiments, the consumer can remove and set the quantity of products in the cart. The widget, according to other embodiments, can render differing user interfaces, for example rendering product purchase options on the page where products are referenced in the content. The data returned from the Product API is used to build the user interface of the product and this is injected into the browser DOM to be displayed to the consumer. Contextual information may be presented through various user interface paradigms including but not limited to: shopping cart, list view, card view, timeline view, spatial view, conversational view, map view, or any combination thereof. The system automatically selects presentation paradigm based on content type, user preferences, device capabilities, and contextual appropriateness. The function of presenting automatically retrieved contextual information concurrently with the user's content viewing is achieved regardless of specific user interface implementation, preventing circumvention through alternative UI designs.

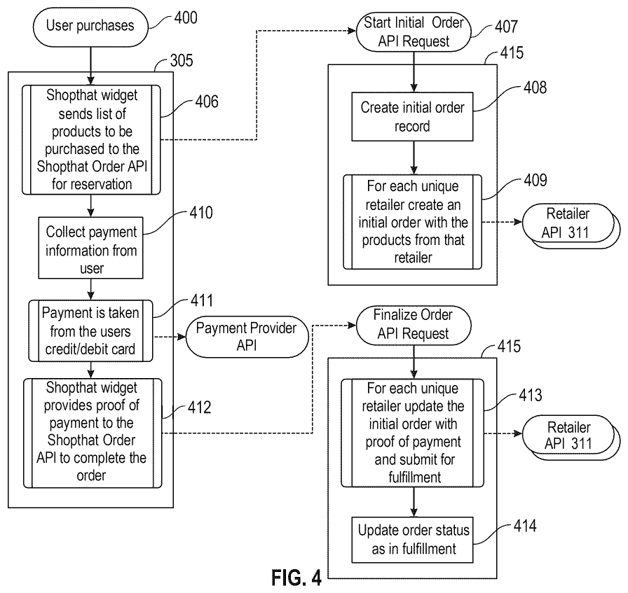

FIG. 4 is a flowchart of a product order process according to embodiments of the invention. When a consumer, via user input, opts at block 400 to purchase the products that they have added to their ShopThat cart 130, the ShopThat widget 305 contacts the ShopThat Order API 415—a part of the ShopThat platform 130 hosted on ShopThat's server infrastructure. The ShopThat widget 305 provides at block 406 the ShopThat Order API 415 with a list of products that the consumer wants to purchase and creates an initial order. For each unique retailer within the initial order, the ShopThat Order API 415 directly calls at block 407 the retailer's integration API to create a corresponding initial order at block 408. This has the purpose of checking and reserving stock with the retailer for a period of time. The ShopThat Order API records the state of each retailer's initial order into its own order database at block 409.

Next, at block 410, the ShopThat widget 305 collects payment information from the consumer and calls a payment provider API to perform the card payment at block 411. When the card payment is taken successfully, the ShopThat widget 305 invokes the ShopThat Order API with the payment authorization data to finalize the order at block 412. This causes the ShopThat Order API 415 to update each corresponding retailer's initial order with the payment authorization to transition the initial order into an order ready for fulfillment, updating the records kept in the ShopThat order database at block 413. At this point the transaction with the consumer is complete and each retailer fulfills the order in the normal course of their business practices at block 414.

It is possible for the ShopThat platform 130 to have discovered products which cannot be purchased via the platform and the direct multi-retailer integration APIs. This is especially true for products the platform may not initially be authorized to sell. In this situation, users are presented with the ability to purchase the item via referral to the retailer's website, whereby the user follows a hyperlink to the retailer's own website and checkout systems.

The growth and integration of payment buttons (such as Apple Pay and Google Pay) offers another route and opportunity for the ShopThat platform 130 to be able to integrate with retailers for checkout purposes. The ShopThat platform may make use of these payment mechanisms and underlying APIs to allow direct purchase of products upon referral. In this situation, the ShopThat platform 130 could act as the source of the payment and shipping data, acting as a bridge between the user, payment processor and retailer.

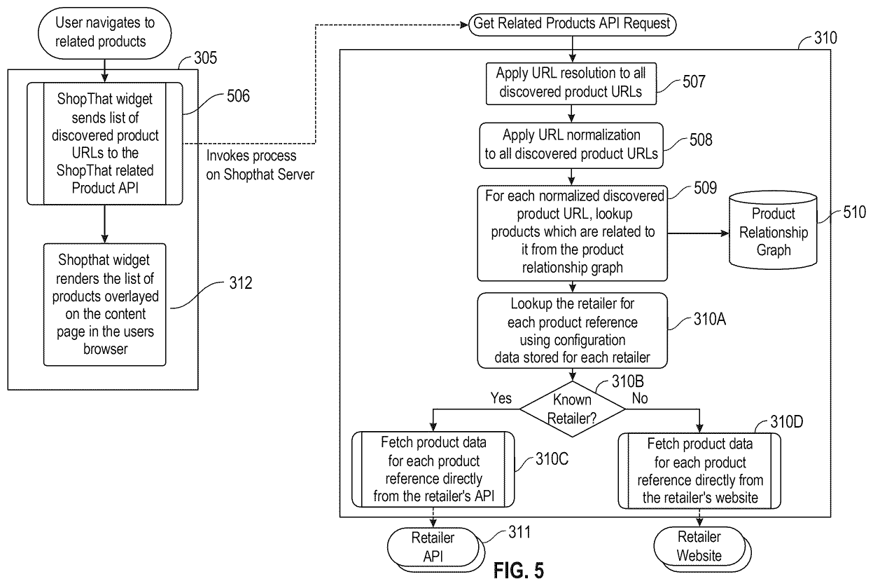

FIG. 5 is a flowchart of a related products process according to embodiments of the invention. The ShopThat platform 130 builds information about which products are related to other products at block 506. This information is then used to provide cross-selling experiences in the ShopThat Widget 305. The relationships between products are learned from a number of different data sources, which are collected from different parts of the ShopThat platform:
Products which are linked to from the same content page, collected by the ShopThat Product extraction API 310;
Products which are brought together, collected by the ShopThat checkout API 415; and
Products which are categorized together, collected by the ShopThat product search system, SoLSearch 110.

The product relationship data from the various sources is collected, aggregated and analysed by the ShopThat platform 130 to build a graph of product relationships 510, which is, in turn, used to suggest related products upon request. The ShopThat platform only stores product metadata such as URLs and the relationship between them, according to one embodiment. In such an embodiment, the ShopThat platform does not store any product data, nor is any normalized product data used in the product relationship building process.

An aspect of the product relationship graph is ensuring that there is a normalized view of a product URL, as this allows for products to be consistently identified despite the differing ways that website may refer to those products. The following steps are applied to all URLs used within the product relationship graph:
URL resolution at block 507—this ensures that a URL is resolved to its intended target, rather than a URL redirection service; and
URL normalization at block 508—this ensures that a URL is a consistent reference for a product.

URL resolution aims to get around problems introduced by often used URL redirection services. In this situation, the URL needs to be translated to the actual target rather than the intermediary redirection service. Embodiments perform this in two ways, firstly by applying a rule set of known common URL redirection services. Secondly by connecting to the URL redirection service and following the result, learning redirection rules when it can.

URL normalization aims to ensure that a product URL is always consistently formed. URLs can have a number of inconsistencies which need to be removed:
Query parameters in inconsistent order;
Additional tracking parameters appended; and
Differing domain names used.

The URL normalization process 508 applies a series of rules to simplify and consistently form a URL for the purpose of storing it within a product relationship graph 510.

It is possible that a product name may be referred to without a link, in which case embodiments may also be able to create a link to a retailer website based on its archived retail web index, for example, generating the URL based on natural language processing (NLP) techniques.

When the ShopThat widget 305 wishes to display related products, it performs an API request against the related products endpoint of the ShopThat Product extraction API 310. The widget transmits the full list of discovered product URLs to which related products will be matched at block 506. The ShopThat server applies the URL resolution and normalization processes (at respective blocks 507 and 508) to each discovered product URL. Each of these normalized URLs is then looked up in the product relationship graph 510 and the related products for any known discovered products are returned at block 509. The product relationship graph only returns a URL for the related product, no product data is stored or returned at this stage.

The ShopThat platform 130 next, in real time, fetches the product data for every product URL of a related product, in the same manner as described above with reference to blocks 310A-310D in FIG. 3. As such the ShopThat platform performs similar processes as used during the product matching process to get the data for each product. Doing so involves directly calling the third party partnered retail's APIs 311. In some cases, a web page scraping function may be invoked to extract product data directly from reference product web pages.

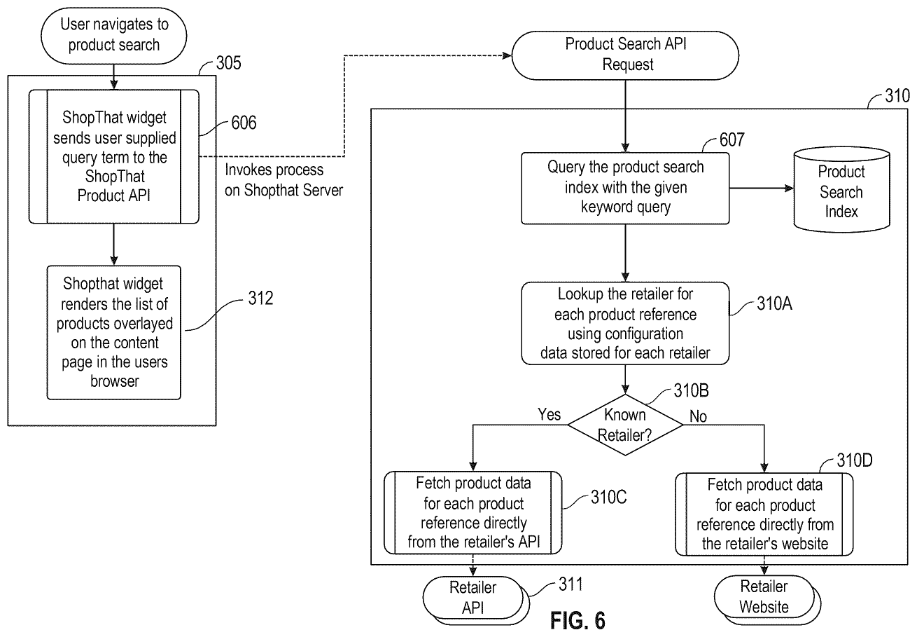

FIG. 6 is a flowchart for a product search process according to embodiments of the invention. The ShopThat platform 130 provides the capability to search for products based upon:
Keywords of product name and description (full text search);
Retailer supplied product tags; and
Product classification and categorization.

The Shopthat platform 130 does this without holding any normalized product data, instead only indexing keywords to product URL metadata. The platform then reuses similar processes to that used to match discovered products to get the product data for each index hit. A product search index is populated with data from multiple sources:
Products retrieved from partnered retailer's catalogue systems;
Products discovered by the product matching process; and
Product classification and categorization made via Machine Learning processes.

This data is primarily collected passively by the ShopThat Product extraction API 310 and stored into the index mapping keyword to product URL. The lookup process is as follows. When the ShopThat widget 305 wishes to search for products, it performs an API request against the product search endpoint of the ShopThat Product extraction API. The widget transmits a query of words to search for at block 606. This query may also specify how those words are to be combined with Boolean AND and OR operators. The given query is used to search the keyword index which has been built at block 607. The index returns a set of product URLs which have been matched to the given query. The ShopThat platform 130 next, in real time, fetches the product data for every product URL of a product search. As such, the ShopThat platform performs similar processes described above with reference to blocks 310A-310D in FIG. 3 and as used during the product matching and related product processes to get the data for each product. This involves directly calling the third party partnered retail's APIs 311. In some cases, a web page scraping function may be invoked to extract product data directly from reference product web pages.

The above-described embodiments of the ShopThat Widget 305 provide a very traditional shopping experience with the typical shopping cart pattern. Yet the unique position of the ShopThat Widget being embedded directly into content websites presents a range of alternative embodiments for user interfaces. One such embodiment is to provide contextual product information overlays and ordering capabilities. The ShopThat widget in such an embodiment uses the related information about products to augment the content on a web page, displaying information about products contextually where the product is mentioned within the web page. This additionally enables purchasing of the product from this contextual user interface.

Another embodiment provides for product price optimization. The ShopThat platform's capabilities to perform multi-retailer product purchasing also facilitates the possibility of selecting the best price for a given product. In such an embodiment, the Shopthat platform 130 matches up products across different retailers and then orders the given ‘unified’ product from the retailer offering the best price/service at the time of purchase for a consumer.

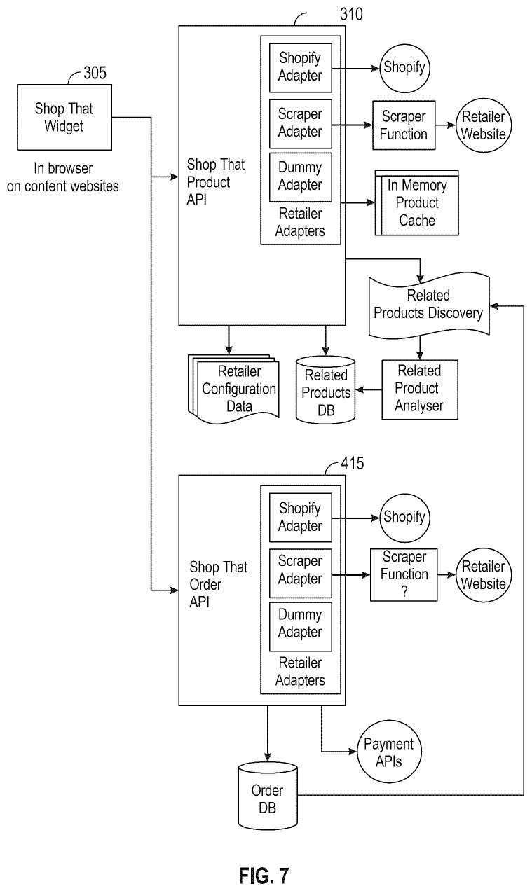

FIG. 7 is a functional block diagram of the ShopThat platform 130 architecture, according to an embodiment.

A description of SoLView 155, another one of the three economic models referred to above that make use of the search engine SoLSearch's contextual search mechanisms, follows.

Metadata is embedded in all types of media: images, videos, audio, documents, etc. The metadata is used to provide, for example, descriptive information, structural information, administrative information, reference information, statistical information, and legal information about the media. A new class of metadata is being proposed that consists of all the aforementioned types of information and includes seven new interactive layers of information. These layers are purchasable (shopping) links, contextual information of the media, all related media link information, geo-location/URL use-tracking, pixel tracking/watermarking, and non-fungible tokens (NFTs). Each layer can operate independently of each other and can work together. The metadata may be organized into multiple distinct layers each serving different contextual purposes, enabling selective access, selective sharing, and independent updates to different types of contextual information. The layered structure enables differential privacy controls, allowing a user to share certain contextual layers while maintaining privacy of other layers. Layers may have cryptographic or logical interdependencies, such that modification of one layer invalidates or updates dependent layers. The system uses at least two distinct layers selected from: purchasable links layer, contextual information layer, related media layer, tracking layer, and authentication layer, though additional layers may be included, according to the disclosed embodiments.

Additionally, metadata is very close to its counterpart “microdata” for web pages. Microdata is a Web Hypertext Application Technology Working Group (WHATWG) Hypertext Markup Language (HTML) specification used to nest metadata within existing content on web pages. Search engines, web crawlers, and browsers can extract and process microdata from a web page and use it to provide a richer browsing experience for users. This microdata is often used for Search Engine Optimization (SEO) purposes in search engines. Embodiments can use the same foundational technology to embed information into a whole web page and use it for contextual search purposes.

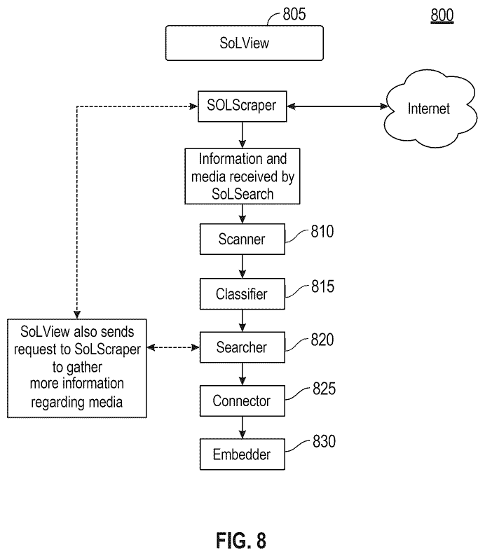

As depicted in FIG. 8, embodiments of the invention 800 include a layered information metadata automation engine 805 termed herein as the SoLView engine, or simply SoLView. SoLView uses machine learning, deep learning, and artificial intelligence to automatically scan, identify, classify, and embed critical metadata information into a media file. SoLView works in conjunction with the ImagraB NFT minting engine as described, for example, in U.S. patent application Ser. No. 17/666,788, filed Feb. 8, 2022, entitled “BLOCKCHAIN BRIDGE SYSTEMS, METHODS, AND STORAGE MEDIA FOR TRADING NON-FUNGIBLE TOKEN” the disclosure of which is incorporated by reference herein in its entirety, to automatically generate and add an NFT layer inside a media file. By automating this process, all media passing through the platform has the proper information embedded within the preexisting file types.

The SoLView engine supports, but is not limited to, the following file formats and automatically scans (block 810), classifies (block 815), and embeds (block 830) metadata information inside the following file formats:
Image File Formats: JPEG, PNG, SVG, GIF;
Video File Formats: WEBM, MPG, MP2, MPEG, MPE, MPV, OGG, MP4, M4P, M4V, AVI, WMV, MOV, QT, FAV, SWF, AVCHD;
Audio File Formats: MP3, M4A, AAC, GGA, FLAC, AIFF, WMA, ASF, WAV, VQF, MP2, APE, RA, MINI;
Document File Formats: DOC, PDF, TXT, RTF;
Webpage: HTML (automate SEO).
The system is media-agnostic and future-proofed to support any media type including but not limited to: images, video, audio, text, 3D models, haptic data, olfactory data, spatial/volumetric data, neural interface data, and any future sensory modalities, with the contextual principles applying regardless of sensory modality.

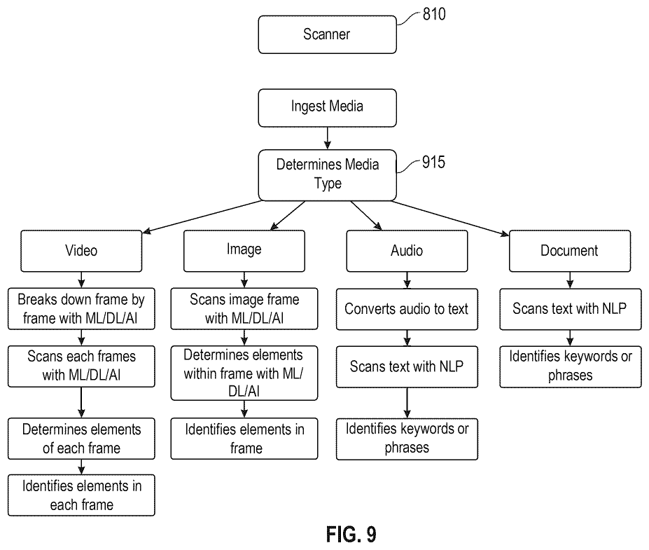

As illustrated in FIGS. 8 and 9, the SoLView engine 805 applies Machine Learning (ML), Deep Learning (DL), and Artificial Intelligence (AI). An ML/DL/AI engine scans media to detect elements in the media. The SoLView engine uses ML/DL/AI and comprises a scanner 810, identifier 915, classifier 815, searcher 820, connector 825, and embedder 830, each of which is described below.

Scanner 810 (FIG. 9): The ML/DL/AI scanner analyzes every pixel in the media and detects objects within the media.

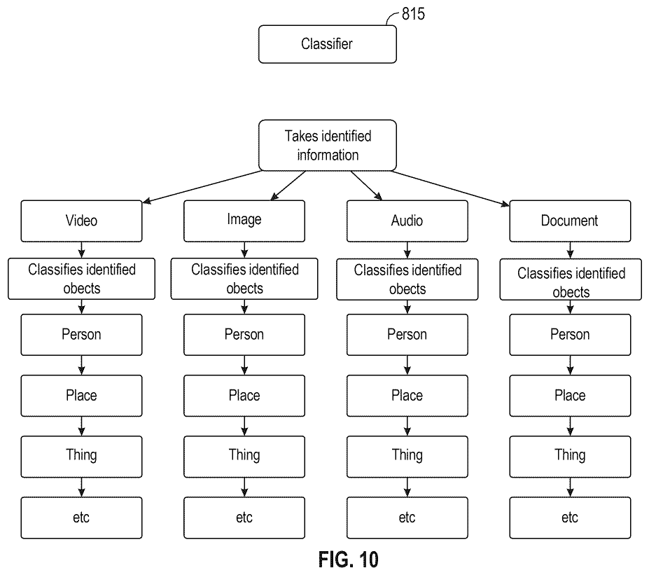

Classifier 815 (FIG. 10): The ML/DL/AI classifier takes the identified scanned objects and classifies each object.

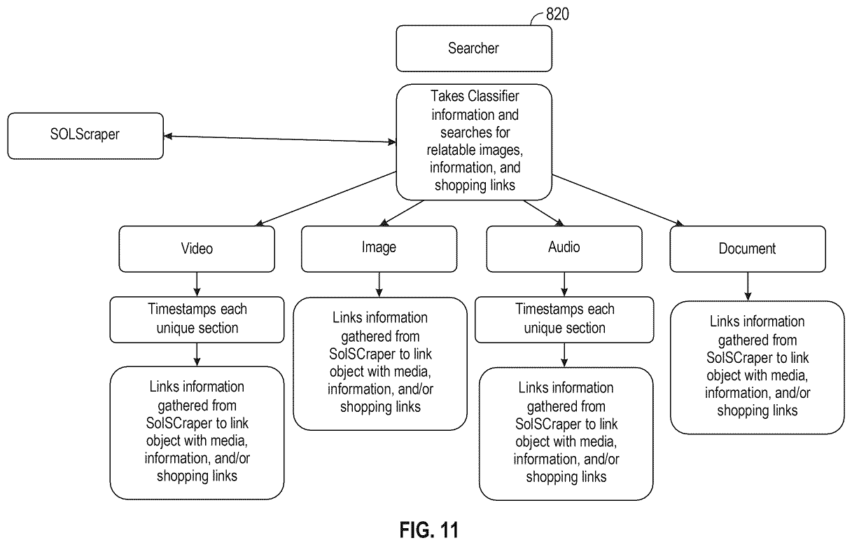

Searcher 820 (FIG. 11): The ML/DL/AI searcher crawls for reference materials pertaining to each object.

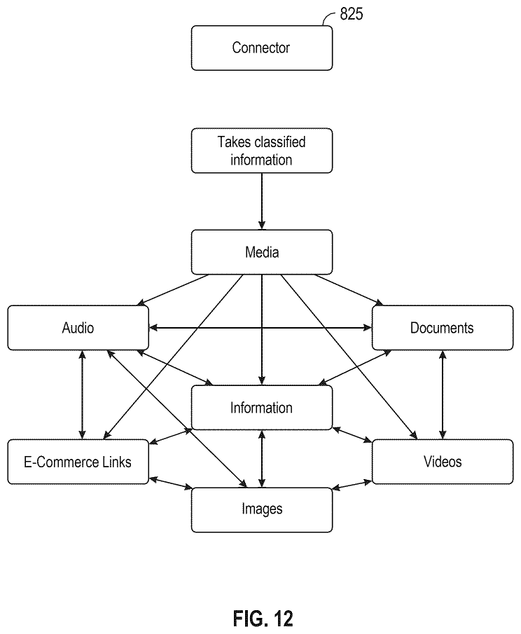

Connector 825 (FIG. 12): The ML/DL/AI connector connects and references all the objects along with the information gathered and links everything together.

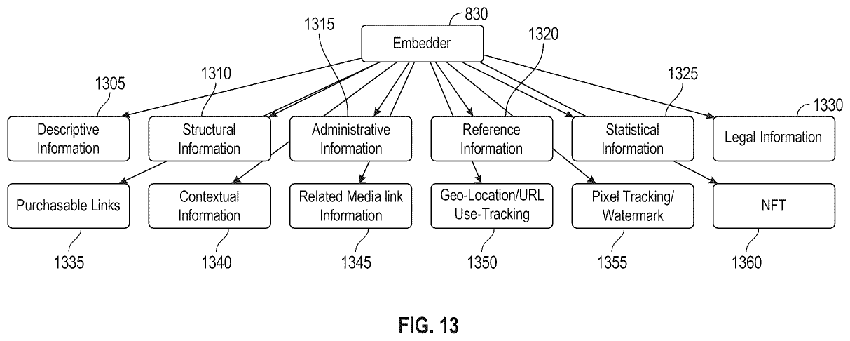

Embedder 830 (FIG. 13): The ML/DL/AI embedder takes all the information from the classifier 815, searcher 820, and connector 825 and embeds the information inside of the media file. The information is embedded within the media by adding metadata in layers, according to embodiments. The layers include:
Descriptive Information 1305—This layer provides a short and long description of the contents within the media file encompassing bits of all the information below.
Structural Information 1310—This layer provides structural information about the file such as format, the codec, compression, and pixel dimensions.
Administrative Information 1315—This layer provides dates and specific EXIF (exchangeable image file) data of the media (usually found in photos).
Reference Information 1320—This layer provides information that supports external media used in this media file.
Statistical Information 1325—This layer facilitates sharing, querying, and understanding of statistical data over the lifetime of the data.
Legal Information 1330—This layer includes copyright data, legal use terms, and referenced to any special conditions.
Purchasable (shopping) Links 1335—This layer provides a central link to all available purchases the media has to offer.
Contextual Information of the Media 1340—This layer provides a central link to all available information within this media such as location, people, objects, music etc.
All Related Media Link Information 1345—This layer provides more contextual information of related external media that this media is connected to.
Geo-Location/URL Use-Tracking 1350—This layer holds geo-location data and tracking data to query location and use.
Pixel Tracking/Watermark 1355—This layer tracks user behavior, site conversions, web traffic, and other metrics.
Non-fungible token (NFT) 1360—This layer is an embedded NFT that shows proof that this media is authentic and not a clone. This layer is tamper-proof and cannot be modified.
Modifying this layer voids its authenticity.

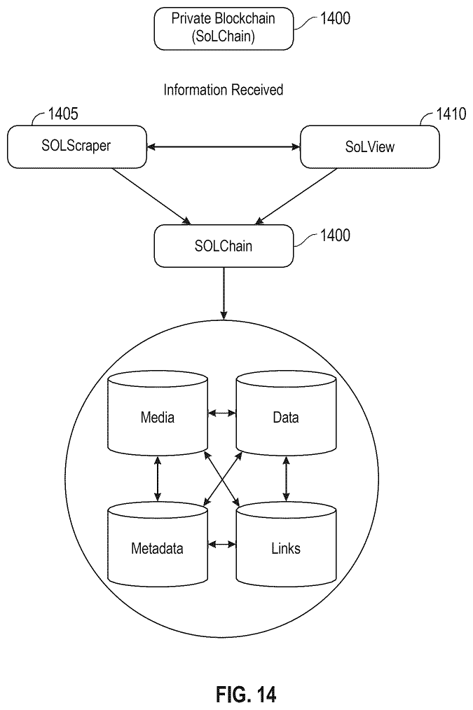

FIG. 14 is a functional block diagram of a private data-store blockchain 1400, termed SoLChain 120, according to embodiments of the invention. SoLChain is the underlying blockchain technology that holds all the generated data produced by the SoLScraper 1405, SoLView engine 1410, and the ImagraB NFT generator, according to embodiments. SoLChain is a private multi-tiered-blockchain unlike any other blockchain. Most blockchains today only holds transaction interactions between two accounts and account information for each owner/wallet. SoLChain holds layered information for each piece of data generated by the SoLScraper, SoLView engine, and the ImagraB NFT generator and automatically links all the information together.

SoLChain 120 is a private multi-tied distributed blockchain that uses a two-factor proof-of-authority and proof-of-identity to ensure that the information is authentic, validated, immutable, and properly linked. This type of blockchain does not require as many energy resources as other blockchains using proof-of-work or proof-of-stake. By having a two-factor proofing system, it not only creates a check and balance for data to be written to the blockchain, but it ensures that those that are able to write to the blockchain do not corrupt the blockchain with false data.

Embodiments use this particular blockchain because there is currently no similar blockchain technology in use. Prior art blockchains only focus on account information and transaction information, while the focus of the blockchain according to embodiments of the invention is on links and contextual information linked to a particular object. The purpose of the blockchain is to create and catalog every type of media with contextual information, building a universal library of immutable information and linking all information and media together like never before.

According to some embodiments, SoLChain 1400 has an API component that allows third party users to develop their own application to write to the blockchain. The blockchain records third party activities and their contribution to the blockchain.

SoLChain 120 has its own cryptocurrency for internal utility use. Users of the platform can earn SoLCoins by using the platform.

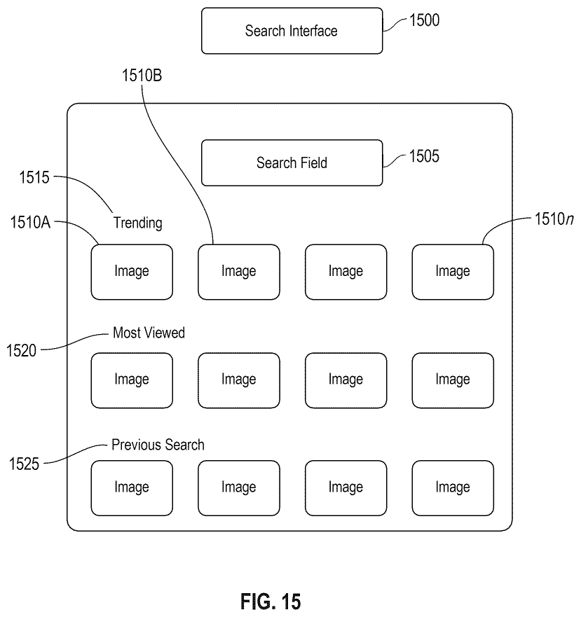

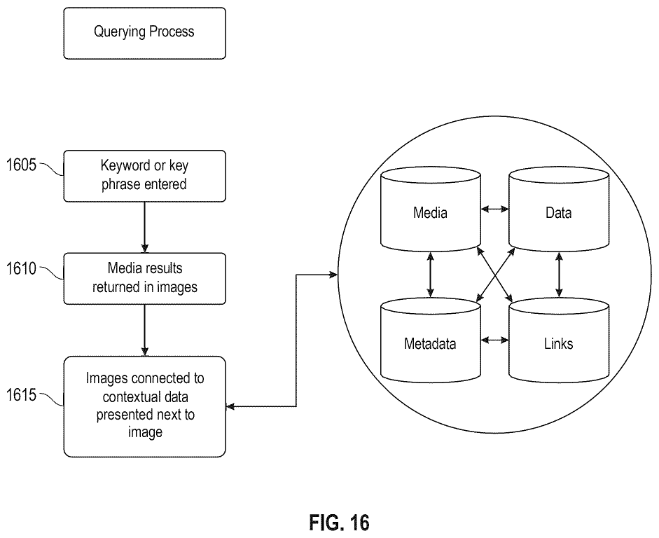

As previously mentioned, SoLView 155 makes use of the contextual search engine SoLSearch 110. The search engine SoLSearch scans “a context” in real time using SoLScraper 115. For the purposes of SoLView and the use of metadata encased media, SoLSearch can also be a media-based contextual search engine. It is based on all the aforementioned technologies. It allows users to search the blockchain for media of every type with the use of keywords or key phrases. The results of the search are displayed in a series of images that match best with the user's input. With reference to FIGS. 15 and 16, an interface 1500 for the search engine SoLSearch is depicted and works as follows in this embodiment. A user first types in keywords or key phrases at block 1605 into a search field 1505. Results returned at block 1610 show a series of images 1510A, 1510B, . . . 1510n that best matches the keywords or phrases. These results may be categorized or sorted based on various factors, such as trending images 1515, most viewed images 1520, or previously search images 1525. Note these images also represent other types of media such as video, audio, or document files. The user may then select an image that appeals or matches most to their search. An exploratory view then appears that shows the media and all the primary contextual information pertaining to that media at block 1615. Users may drill down to see secondary, tertiary, quaternary, etc., information.

Users can click on the media to either investigate it further or click on the contextual information or other associated media next to the main media to further explore more information. If the media is a video or an audio file, as the media is playing, the contextual information that is associated to that media changes as the timeline of the media changes because every visual “scene” or “portion” of that media that is being displayed has new types of information associated, therefore, updating the contextual information, associated media, and links.

Users can explore the contextual information further by clicking on the active links to provide more contextual information of other media that may be linked to that contextual data. This works in the same manner with document type files. Users can preview the document as displayed and as users scroll through the document, new contextual information or media is displayed next to the document relating to the document.

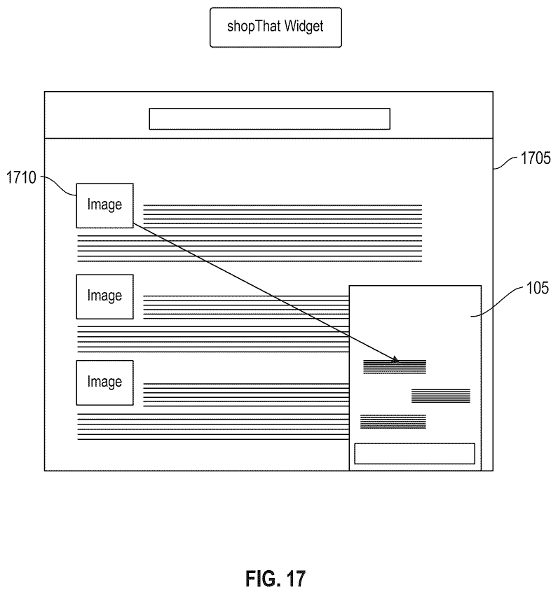

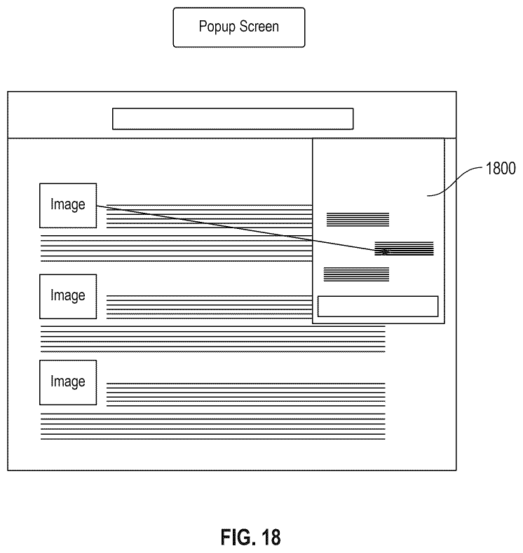

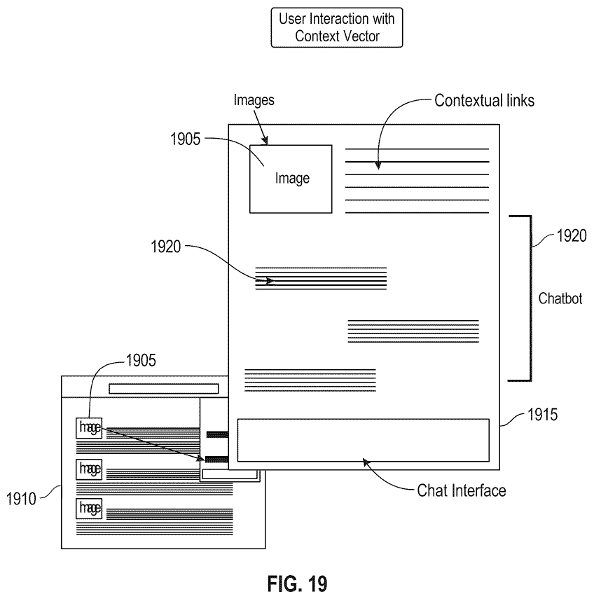

FIG. 17 illustrates an example of contextual searching on a website 1705, using the widget 105 associated with the SoLChat chatbot, according to embodiments of the invention. This embodiment contemplates users having the ability to drag media, e.g., an image 1710, from the webpage 1705 into the widget 105, and the contextual search engine automatically provides information related to that particular media. This includes any image whose contextual information the search engine SoLSearch 110 can scan, not just an image embedded with SoLView 155. FIG. 18 illustrates a similar example 1800 of contextual searching on websites using a popup display 1800. FIG. 19 illustrates another example of contextual searching on websites in which users can drag media, e.g., an image 1905, from the webpage 1910 into the widget 1915 associated with the SoLChat chatbot and the contextual search engine automatically provides related information 1920 related to that particular media.

Thus, the disclosed embodiments involve a user interface application that displays, in the user interface application, an image, or the portion thereof, in a display space. While the user interface application continues to display the image, or portion thereof, a messaging platform application searches in one or more digital data sources for, and retrieves, contextual information based on the displayed image, or portion thereof, without receiving user input to request searching in the one or more digital data sources for contextual information based on the displayed image, or portion thereof. The messaging platform application detects, one or more user interactions with one or more of the user interface application, the display space, or the image or the portion thereof, and displays a portion of the retrieved contextual information as related digital data content in a location within a field of view of the display space, based in part on the detected one or more user interactions.

The disclosed embodiments operate on a fundamentally different paradigm than traditional media capture and analysis systems by maintaining a continuous stream of contextual data gathering that operates passively and perpetually. The user may never actually take a photo, screenshot, or any discrete media capture action, yet the system assembles comprehensive contextual information through extended duration visual analysis, location-only context assembly, browsing history integration, or composite context across multiple passive data streams. The disclosed embodiments implement a passive widget that operates continuously in the background of any application, extracting and storing contextual metadata rather than raw sensory data, assembling information about what the user encountered without capturing what the user saw. A gallery component serves as a multi-function contextual intelligence hub providing media saving, automated curation, intelligent recommendations, generative AI integration, and NFT minting capabilities, with dynamic context reorientation when users switch between individual items and composites. A hierarchical AI agent system routes contextual information based on user role (primary agents), subject matter (specialist agents), and urgency (priority agents), operating automatically without user designation. The disclosed embodiments are media-agnostic, display-agnostic, input-agnostic, and platform-agnostic, ensuring operation across any media type, display technology, input method, or deployment platform, including future technologies not yet invented. Contextual information is embedded using multiple methods including steganographic embedding, metadata fields, blockchain pointers, and NFT smart contracts, ensuring context travels with media across systems. The disclosed embodiments implement a reverse search engine that anticipates user information needs based on content analysis rather than requiring user queries, and operates in real-time with quantitatively defined performance specifications. Privacy-preserving context extraction discards raw sensor data while maintaining contextual metadata, enabling retrospective understanding of user activity without surveillance. The disclosed embodiment fundamentally differs from existing technologies by providing continuous passive contextual intelligence gathering without requiring discrete user-initiated capture events.

The disclosed embodiments include a Multi-Entity Contextual Information Display System wherein a computing system comprises:
a display space;
one or more processors; and
a memory to store computer-executable instructions that, when executed by the one or more processors, cause the one or more processors to perform operations comprising:
displaying, by a user interface application, digital data content authored by a first entity in the display space;
searching, by a chatbot application, in one or more digital data sources for, and retrieving, contextual information authored by one or more entities other than the first entity, based on the displayed digital data content authored by the first entity, without receiving user input to perform the searching;
displaying, by the chatbot application, a portion of the retrieved contextual information authored by the one or more entities other than the first entity as related digital data content in a location within a field of view of the displayed digital data content authored by the first entity or the display space, without navigating away from the first entity's content; and
wherein the system automatically generates actionable links to third-party sources for implicit references in the first entity's content, including at least one of: academic citations, medical definitions, product alternatives, related services, or supplementary information, wherein said links are displayed contextually adjacent to relevant content portions and update dynamically as a user scrolls or interacts with the content.

The disclosed embodiments include a Cross-Platform Shopping Integration System, wherein the displayed digital data content authored by the first entity identifies a first object purchasable from the first entity;
the displayed related digital data content identifies a second object purchasable from a second entity different than the first entity;
the chatbot application displays the digital data content that identifies the first object and the related digital data content that identifies the second object in a unified online shopping cart interface; and
a checkout process handles multi-retailer transactions without the user visiting either the first entity's website or the second entity's website, wherein the user remains in an original browsing context throughout discovery and purchase of items from multiple retailers.

The disclosed embodiments include a Continuous Passive Data Stream Processing System wherein a computing system comprises:
one or more processors; and
a memory to store computer-executable instructions that, when executed by the one or more processors, cause the one or more processors to perform operations comprising:
continuously monitoring at least one of: a visual field of view, a geographic location, or digital content interaction, without requiring user initiation of a capture event;
extracting contextual information from said monitoring in real-time;
storing said contextual information in temporal association with said monitoring, wherein stored contextual information comprises lightweight metadata and not raw sensory data;
enabling retrospective access to said contextual information wherein said access occurs at a time period after said monitoring and without requiring creation of a media artifact during said monitoring; and
wherein the system operates in a passive mode characterized by continuous monitoring of user context without requiring user initiation, automatic extraction of significant contextual elements without user designation of significance, and assembly of contextual information into accessible format without user organization.

The disclosed embodiments provide for an Extended Duration Passive Visual Analysis that processes a continuous visual data stream spanning at least one hour of duration without requiring user to mark specific moments;
automatically identifies objects, people, locations, text, products, and activities throughout the stream;
indexes all identified elements with temporal markers;
assembles contextual information for everything encountered; and
enables retrospective querying of contextual information without the user having captured discrete media artifacts of queried subjects.

The disclosed embodiments include a Location-Only Context Assembly System wherein a computing system comprises:
one or more processors; and
a memory to store computer-executable instructions that, when executed by the one or more processors, cause the one or more processors to perform operations comprising:
receiving location data indicating a user's geographic position over a time period from at least one of: GPS, Wi-Fi positioning, Bluetooth beacons, or cell tower triangulation;
querying contextual databases for information associated with said geographic position, including at least one of: businesses at location, events at location, historical significance, weather conditions, or traffic patterns;
determining significance of locations based on user's dwell time at each location;
assembling said contextual information into a user-accessible collection; and
wherein said method does not require creation of visual media artifacts at said geographic position and wherein said contextual information includes information about objects, establishments, or activities at or near said geographic position, enabling the user to review location-based contextual history without having captured any photos.

The disclosed embodiments include a Browsing History Context Integration System wherein the computing system further performs operations comprising:
monitoring browsing history, application usage, and document access with user permission;
assembling contextual information about all visited websites, viewed content, and searched terms;
wherein no screenshots are required and URL and timing information are sufficient for context retrieval; and
wherein the system enables answering natural language queries about previously viewed content without the user having saved any artifacts of said content.

The disclosed embodiments provide for Composite Context Across Multiple Passive Streams wherein the system integrates multiple passive data streams simultaneously, including at least two of: location data, browsing history, calendar events, and communication metadata, and wherein the system synthesizes signals from said multiple passive data streams to proactively surface contextual information without any user action to trigger said contextual assembly.

The disclosed embodiments provide for a Gallery as Multi-Function Contextual Intelligence Hub wherein a computing system comprises:
one or more processors; and
a memory to store computer-executable instructions that, when executed by the one or more processors, cause the one or more processors to perform operations comprising:
providing a gallery interface configured to receive both explicitly user-selected media items and passively accumulated contextual data;
identifying relationships among said media items and contextual data;
displaying said media items and contextual data in at least one of: individual view, composite view, timeline view, or recommendation view;
wherein selection of a composite causes contextual information to be reorganized with said composite as primary object and individual constituent elements as secondary objects; and
wherein the gallery functions as a multi-function contextual intelligence hub providing at least two of: media saving and storage, automated curation of media collections, intelligent recommendation generation, generative AI integration for content creation and analysis, or NFT minting capabilities with embedded contextual metadata.

The disclosed embodiments include a Dynamic Context Reorientation System wherein a computing system performs further operations comprising:
displaying a first digital object with associated first contextual information;
receiving user input to combine said first digital object with a second digital object to create a composite object;
automatically generating second contextual information associated with said composite object, wherein said second contextual information differs from and is not merely a summation of said first contextual information and contextual information associated with said second digital object;
displaying said composite object with said second contextual information;
wherein switching from composite view to individual item view causes contextual information to reorganize with individual item context as primary and composite context as subordinate; and
wherein a context hierarchy is maintained in a metadata structure enabling dynamic reorientation based on user selection.

The disclosed embodiments include an Automated Curation and Recommendation System wherein a computing system performs further operations comprising:
analyzing passively accumulated contextual data to identify thematic relationships;
automatically suggesting media combinations based on said identified thematic relationships;
presenting suggested curations to the user for acceptance, modification, or rejection;
refining future curation suggestions based on user feedback through machine learning; and
generating recommendations for at least one of: related content, shopping items, experiences, or locations based on gallery contents comprising both explicitly saved media and passively accumulated contextual data.

The disclosed embodiments include a Hierarchical AI Agent Context Routing System wherein a computing system comprises:
one or more processors; and
a memory to store computer-executable instructions that, when executed by the one or more processors, cause the one or more processors to perform operations comprising:
providing a plurality of AI agents organized in a hierarchy;
generating contextual information from user activity through a context extraction component;
determining a user role and selecting a primary AI agent from said plurality based on said user role;
analyzing said contextual information to determine subject matter and selecting a specialist AI agent from said plurality based on said subject matter;
evaluating said contextual information for urgency indicators and routing urgent contextual information to a priority AI agent, bypassing normal routing when urgency is detected; and
wherein said determining, selecting, analyzing, and routing occur automatically without user designation of which AI agent should receive said contextual information.

The disclosed embodiments provide for Role-Based AI Agent Selection wherein:
the user role comprises at least one of: medical professional with specified specialty, legal professional with specified practice area, architect, financial analyst, educator with specified subject area, or researcher with specified domain;
the primary AI agent is selected based on expertise requirements of the user role;
the system learns the user's primary role over time if not explicitly set by the user; and
information filtering and prioritization are adjusted based on the selected primary AI agent corresponding to the user role.

The disclosed embodiments provide for Action-Based Specialist AI Agent Selection wherein:
when a user places media in a gallery via drag-and-drop or when passively collected context reaches the gallery, the system analyzes media type and content;
the system selects appropriate specialist AI agent(s) from a group including at least: fashion AI for clothing items, automotive AI for vehicles, real estate AI for properties, culinary AI for food items, technology AI for electronics, medical AI for health-related content, or legal AI for legal documents;
multiple agents can operate concurrently on different aspects of same media; and
agent selection is transparent to user but results are tagged by source agent for traceability.

The disclosed embodiments provide for Temporal Urgency-Based Priority Routing wherein:
the system evaluates contextual information for time-sensitivity indicators;
urgent information comprising at least one of: breaking news, price drops, appointment conflicts, security alerts, medical alerts, or financial alerts is routed to a priority agent;
non-urgent contextual information is queued for background processing; and
user notification settings control urgency thresholds for different categories of contextual information.

The disclosed embodiments provide for Multi-Agent Consensus and Conflict Resolution wherein when multiple AI agents provide conflicting contextual information:
the system presents consensus information where agents agree;
the system highlights conflicts and presents multiple perspectives with attribution to source agents;
user role determines which agent's analysis is given priority in display ranking; and
the system learns from user selections to refine future agent weighting through machine learning algorithms.

The disclosed embodiments include a Privacy-Preserving Context Extraction System wherein a computing system comprises:
one or more processors; and
a memory to store computer-executable instructions that, when executed by the one or more processors, cause the one or more processors to perform operations comprising:
receiving raw sensor data from at least one sensor;
extracting contextual metadata from said raw sensor data through on-device processing;
storing said contextual metadata;
discarding said raw sensor data after extraction of said contextual metadata;
wherein said contextual metadata enables retrospective understanding of user activity while said discarding of raw sensor data preserves user privacy by not maintaining original sensory recordings; and
wherein stored metadata comprises descriptive labels and not reproducible representations of original sensory input.

The disclosed embodiments provide for On-Device Context Processing with Selective Cloud Sync wherein:
sensitive context extraction is performed locally on user device;
only anonymized queries are sent to external services when additional context is needed;
full contextual information never leaves device unless user explicitly authorizes cloud synchronization;
user controls which contexts sync to cloud on a per-context or per-category basis; and
the system operates in a HIPAA/GDPR/CCPA compliance mode when handling regulated data types.

The disclosed embodiments provide for Federated Learning for Context Improvement wherein:
multiple users' context patterns are aggregated without sharing individual user data;
a global machine learning model improves contextual relevance for all users based on federated learning;
individual user data remains private on respective user devices;
differential privacy techniques prevent identification of individual users from aggregate data; and
user can opt out of federated learning without loss of core system functionality.

The disclosed embodiments include a Context Versioning and Evolution System wherein a computing system comprises:
one or more processors; and
a memory to store computer-executable instructions that, when executed by the one or more processors, cause the one or more processors to perform operations comprising:
maintaining version history of contextual information associated with media as said contextual information changes over time;
enabling users to view contextual information as it existed at any specified date;
tracking changes including at least one of: product price history, article revision tracking, location changes, availability changes, or relationship changes;
storing said version history on a distributed digital ledger to ensure immutable record; and
training machine learning models on context evolution patterns to predict future context changes and identify trends.

The disclosed embodiments include a Temporal Context Fusion System, wherein the system combines:
real-time context comprising current state of external data sources;
archived context comprising historical data about same or similar media;
predictive context comprising anticipated future states based on trend analysis;
wherein the user sees unified contextual presentation without temporal seams; and
wherein the system indicates freshness or staleness of different context elements through visual indicators or metadata tags.

The disclosed embodiments include a Media-Agnostic Platform System wherein a computing system is configured to operate on any media type including but not limited to: images, video, audio, text, 3D models, haptic data, olfactory data, spatial/volumetric data, neural interface data, and future sensory modalities;
wherein contextual principles apply regardless of sensory modality;
wherein the system automatically adapts context extraction techniques based on detected media type;
wherein the system supports extensible framework for future media types not yet invented; and
wherein non-visual media triggers same context retrieval as visual media, including audio descriptions, haptic patterns, or olfactory signatures.

The disclosed embodiments include a Display-Agnostic Implementation System wherein a computing system is configured to operate on display technologies including but not limited to: smartphones, tablets, computers, AR/VR/MR headsets, projection displays, holographic displays, volumetric displays, e-ink displays, retinal projection displays, haptic displays, audio-only displays, neural interfaces, and future display technologies;
wherein display technology-independent contextual retrieval enables same context to be accessible across different display devices for same user;
wherein context synchronizes across devices via cloud backend or peer-to-peer connection; and
wherein presentation format automatically adapts to capabilities and constraints of current display device.

The disclosed embodiments include an Input-Agnostic Interaction System wherein a computing system is configured to accept user interaction through input modalities including but not limited to: touch, gesture, voice, gaze, brain-computer interface, haptic input, motion sensing, proximity sensing, and future input technologies;
wherein the system adapts to available input modalities on current device;
wherein passive mode works without any active input modality being engaged;
wherein future input technologies are automatically supported through extensible input abstraction layer; and
wherein multimodal input combines multiple simultaneous input sources to determine user intent with higher confidence.

The disclosed embodiments include a Platform-Agnostic Deployment System wherein a computing system is deployable as at least one of: web widget, native application, browser extension, operating system-level integration, API service, or cloud-based service;
wherein the system can be embedded in third-party applications via SDK;
wherein processing can be cloud-based, edge-based, or hybrid based on performance and privacy requirements;
wherein the system is not dependent on specific operating system or hardware platform; and
wherein the same contextual intelligence features are available regardless of deployment method.

The disclosed embodiments include a Real-Time Scraping Performance System wherein a computing system comprises a web scraping component that:
performs initial scrape in less than 500 milliseconds from page load;
provides comprehensive deep scrape in less than 2 seconds;
monitors page changes with less than 100 milliseconds detection latency;
operates on-demand for currently-viewed content without requiring prior indexing;
performs parallel retrieval operations for multiple related resources simultaneously;
executes JavaScript and monitors DOM mutations to extract dynamically-rendered content; and
operates on arbitrary content not limited to pre-indexed or cached sources, enabling contextual information retrieval for newly-published content, user-generated content, and long-tail content.

The disclosed embodiments include a Reverse Search Engine System wherein a computing system implementing a reverse search engine that:
operates in reverse causal direction compared to traditional search engines, wherein content analysis determines information needs rather than user query determining search targets;
generates comprehensive contextual information without ever receiving user-formulated search query;
generates predicted search queries based on content analysis and user behavior patterns, wherein said predicted queries are used internally for information retrieval without being presented to user for confirmation or modification;
executes predicted information needs resulting in automatic retrieval of corresponding information, not merely presentation of suggested search queries user could optionally execute; and
anticipates user's query for contextual information based on content in which user is currently immersed before any user query is made.

The disclosed embodiments include a Metadata Layer Architecture System wherein a computing system that organizes metadata into multiple distinct layers each serving different contextual purposes comprises:
at least two distinct layers selected from: purchasable links layer, contextual information layer, related media layer, tracking layer, and authentication layer;
wherein the layered structure enables selective access, selective sharing, and independent updates to different types of contextual information;
wherein the layered structure enables differential privacy controls, allowing user to share certain contextual layers while maintaining privacy of other layers;
wherein layers have cryptographic or logical interdependencies, such that modification of one layer invalidates or updates dependent layers; and
wherein each layer can operate independently or in combination with other layers.

The disclosed embodiments include a Multi-Embedding Method System wherein a computing system embeds contextual information using at least one method selected from:
steganographic embedding wherein data is hidden in imperceptible alterations to pixel values using techniques providing robustness against compression, resizing, and format conversion;
metadata field embedding through population of standard fields including EXIF, IPTC, or XMP;
wrapper file embedding where file contains media plus context as separate streams;
blockchain pointer embedding with hash or cryptographic pointer in file to blockchain record;
sidecar file embedding with separate file cryptographically linked to main media;
NFT smart contract embedding with context in contract code;
wherein the embedding ensures contextual information remains accessible even when media file is transferred, copied, or moved to systems without network connectivity; and
wherein embedded contextual information includes cryptographic hash or digital signature enabling verification that context has not been altered since embedding.

The disclosed embodiments include a Screenshot-Equivalent Context Capture System wherein a computing system comprises:
one or more processors; and
a memory to store computer-executable instructions that, when executed by the one or more processors, cause the one or more processors to perform operations comprising:
receiving user input equivalent to screenshot input through at least one of: button combination, gesture, or voice command;
analyzing DOM or screen content in real-time without creating image file;
extracting contextual information from analyzed content;
displaying extracted contextual information without creating image artifact; and
maintaining original application or content in foreground without interruption;
wherein the system provides all benefits of screenshot-based context capture without storage burden or privacy concerns of maintaining image files.

The disclosed embodiments provide for Automatic Link Generation for Implicit References wherein a computing system comprises:
one or more processors; and
a memory to store computer-executable instructions that, when executed by the one or more processors, cause the one or more processors to perform operations comprising:
analyzing content from a first entity for implicit references not represented by explicit hyperlinks;
automatically generating actionable links to third-party sources based on said implicit references;
wherein generated links include at least one of: academic citations, medical definitions, product alternatives, related services, legal references, or supplementary information;
displaying said generated links contextually adjacent to relevant content portions;
updating said links dynamically as user scrolls or interacts with content; and
wherein link generation occurs without requiring user to manually search for or identify related resources.

The disclosed embodiments include a Contextual Information Persistence and Retrieval System wherein a computing system comprises:
one or more processors; and
a memory to store computer-executable instructions that, when executed by the one or more processors, cause the one or more processors to perform operations comprising:
adding contextual information to distributed digital ledger at location associated with displayed digital content;
maintaining contextual information persistently such that it remains accessible across sessions, devices, and time periods;
enabling search of contextual information stored in distributed digital ledger independent of original content;
providing provenance chain showing when contextual information was added, by whom, and based on what source data;
enabling third-party verification of contextual information authenticity through cryptographic proofs; and
wherein contextual information becomes first-class searchable entity independent of media with which it was originally associated.

The disclosed embodiments include a Composite Media with Emergent Context System wherein a computing system comprises:
one or more processors; and
a memory to store computer-executable instructions that, when executed by the one or more processors, cause the one or more processors to perform operations comprising:
receiving multiple individual media items, each associated with individual item contexts;
aggregating said multiple individual media items into a composite;
automatically generating composite context that differs from and is not merely a summation of individual item contexts;
identifying emergent themes from composite that do not exist in individual items;
generating recommendations based on composite context that differ from recommendations based on individual item contexts;
wherein composite context unlocks higher-order relationships and insights not apparent from individual items; and
wherein user can explicitly set composite theme to override system interpretation while system continues to identify emergent patterns. Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computing system, comprising:
a display space;
one or more processors; and
a memory to store computer-executable instructions, comprising a user interface application and a messaging platform application that, when executed by the one or more processors, cause the one or more processors to perform operations comprising:
displaying, in the user interface application, an image, or the portion thereof, in a display space; and
while the user interface application continues to display the image, or portion thereof, searching in one or more digital data sources for, and retrieving, by the messaging platform application, contextual information based on the displayed image, or portion thereof, without receiving user input to request searching in the one or more digital data sources for contextual information based on the displayed image, or portion thereof;
detecting, by the messaging platform application, one or more user interactions with one or more of the user interface application, the display space, or the image or the portion thereof;
displaying, by the messaging platform application, a portion of the retrieved contextual information as related digital data content in a location within a field of view of the display space, based in part on the detected one or more user interactions with the one or more of the user interface application, the display space, or the image or portion thereof, without receiving user input to display the portion of the retrieved contextual information as related digital data content; and
receiving, by the messaging platform application, user input, responsive to the displaying of the portion of the retrieved contextual information as related digital data content.

2. The computing system of claim 1, wherein the platform messaging application is selected from a group consisting of: an automated information assistant, a conversational interface application, an AI-powered information retrieval agent, an intelligent contextual assistant, and an automated query response system that automatically retrieves and presents contextual information through at least one of a conversational interface, a direct information display, proactive notifications, and an ambient information presentation.

3. The computing system of claim 1, wherein the display space comprises any medium through which the image is rendered perceivable to a user through any sensory modality, including but not limited to: a display screen, a browser window, a browser tab, a retinal projection display, a holographic display, a volumetric display, a haptic display, an audio-only display, a neural interface, and a spatial computing display in an augmented reality, a virtual reality, or a mixed reality environment.

4. The computing system of claim 1, further comprising:
displaying, by the user interface application, a series of digital images in the display space;
receiving, via the user interface application, user input to select one of the series of digital images, or a portion thereof appearing in the selected one of the series of digital images; and
wherein displaying, in the user interface application, the image, or the portion thereof, in the display space, comprises displaying the user-selected digital image, or the portion thereof in a location within a field of view of the displayed series of digital images or the display space.

5. The computing system of claim 4, wherein receiving user input to select one of the series of digital images comprises receiving user input through at least one of: a touch gesture, a computer mouse action, a keyboard action, a voice command, a user eye gaze-based input, a neural input, a haptic input, a user motion input, a proximity input, or a combination thereof concurrently processed.

6. The computing system of claim 1, wherein detecting, by the messaging platform application, one or more user interactions with one or more of the user interface application, the display space, or the image or the portion thereof, comprises detecting at least one of: a user scrolling behavior, a user stopping pattern, a user viewing duration, a resizing action, a moving action, a paging action, an eye movement, a gaze point, a hand gesture pattern, a voice tone analysis, a biometric response, a context switching frequency, an application dwelling time, and a cursor movement pattern.

7. The computing system of claim 1, wherein displaying, by the messaging platform application, the portion of the retrieved contextual information as related digital data content in the location within the field of view of the display space comprises displaying, by the messaging platform application, the portion of the retrieved contextual information as related digital data content in: a shopping cart interface, a list view, a card view, a timeline view, a spatial view, a conversational view, a map view, or any combination thereof, wherein the computing system automatically selects where to display, by the messaging platform application, the portion of the retrieved contextual information based on content type, user preferences, device capabilities, and context.

8. The computing system of claim 4, further comprising:
receiving, via the user interface application, user input to transfer the displayed user-selected digital image or the portion thereof in the location within the field of view of the displayed series of digital images or the display space to an online shopping cart; and
retrieving into the online shopping cart the related digital data content added to or associated with, the file, the repository, or the storage location in or at which the displayed user-selected digital image, or the portion thereof, is maintained.

9. The computing system of claim 8, wherein the online shopping cart provides cross-platform shopping integration wherein objects from multiple different retailers are displayed in a unified shopping cart interface, and wherein a checkout process handles multi-retailer transactions without the user visiting any retailer's website.

10. The computing system of claim 4, wherein receiving, via the user interface application, the user input to select one of the series of digital images, or the portion thereof, consists of receiving one or more of the following user inputs: a voice command, a gesture command, a photo, a video, or a screenshot.

11. The computing system of claim 4,
wherein the related digital data content is a digital image in which one or more objects appear;
wherein displaying, by the messaging platform application, the portion of the retrieved contextual information as related digital data content in the location within the field of view of the displayed series of digital images or the display space, comprises displaying, by the chatbot application, the digital image in the location within the field of view of the displayed series of digital images or the display space; and
wherein the computer executable instructions cause the one or more processors to perform further operations, comprising receiving, by the messaging platform application, user input, responsive to the displayed digital image, to search for information about the one or more objects that appear in the displayed digital image.

12. The computing system of claim 4, wherein the computer executable instructions cause the one or more processors to perform further operations, comprising adding the related digital data content to, or associating the related digital content with a file, a repository, or a storage location in or at which the displayed series of digital images and/or the displayed user-selected digital image or portion thereof, is maintained, based in part on the detected one or more user interactions with the one or more of the user interface application, the displayed series of digital images, the display space, the location within the field of view of the displayed series of digital images or the display space, or the user-selected digital image or the portion thereof, without receiving user input to perform the adding or associating.

13. The computing system of claim 12, wherein adding or associating the related digital data content with the file, the repository, or the storage location comprises adding or associating the related digital data content with the file, the repository, or the storage location via at least one of: steganographic embedding, metadata field embedding, wrapper file embedding, blockchain pointer embedding, sidecar file embedding, and NFT smart contract embedding, wherein the embedding ensures contextual information remains accessible even when the file, the repository, or the storage location is transferred, copied, or moved to a system without network connectivity.

14. The computing system of claim 13, wherein
adding the related digital data content to, or associating the related digital content with, the file in which the displayed series of digital images is maintained, comprises adding the related digital data content to, or associating the related digital content with, the file in which the digital image is maintained.

15. The computing system of claim 14, wherein the computer executable instructions cause the one or more processors to perform further operations, comprising adding, by a Non-Fungible Token (NFT) engine, an NFT layer to the digital image, thereby creating an NFT file comprising the digital image, based on the related digital data content added to or associated with the file in which the digital image is maintained.

16. The computing system of claim 15, wherein the NFT creation is triggered by at least one of: automatically upon context embedding, user initiation, upon first sale, or upon reaching a threshold of context richness, and wherein the NFT token comprises or cryptographically commits to both the media content and contextual information, ensuring token authenticity verifies both media and context integrity.

17. The computing system of claim 15, wherein the NFT includes: the image, contextual metadata, ownership history, license terms, and smart contract functionality for automated royalty distribution and provenance tracking.

18. The computing system of claim 13, wherein adding the related digital data content to, or associating the related digital content with, a file, a repository, or a location in or at which the displayed series of digital images is maintained, comprises adding the related digital data content to, or associating the related digital content with, a location in an distributed digital ledger at which the displayed series of digital data images is maintained, or to a location chained to the location in the distributed digital ledger at which the displayed series of digital images is maintained.

19. The computing system of claim 18, wherein the distributed digital ledger comprises at least one of: a blockchain, a hashgraph, a directed acyclic graph (DAG), and a distributed ledger technology (DLT) providing cryptographically-verified immutable distributed records, and wherein the ledger is one of: a public ledger, a private ledger, a consortium ledger, and a hybrid ledger, selected based on use case privacy and performance requirements.

20. The computing system of claim 19, wherein the distributed digital ledger provides cryptographic proof of data integrity, resistance to tampering, and ability for third parties to verify authenticity of stored contextual information.

21. The computing system of claim 19, wherein cryptographic methods comprise quantum-resistant algorithms or cryptographic algorithms that do not alter immutable distributed ledger architecture.
